(19) United States
(12) Patent Application Publication
(10) Pub. No.: US 2008/0040240 A1
(43) Pub. Date: Feb. 14, 2008

(54) INTERACTIVE IN-STORE/IN-MALL AND ON-LINE SHOPPING SYSTEM AND METHOD

(76) Inventors: Robert D. Covington, Indianapolis, IN (US); Melanie A. Al-Shabkhoun, Indianapolis, IN (US); Andrew D. Carlson, Chicago, IL (US); Sandeep Chugani, Livingston, NJ (US); Drew Conrad, Centreville, VA (US); Paul M. D'Alessandro, Deerfield, IL (US); John E. Kalil, Hermosa Beach, CA (US); Jason Kunesh, Chicago, IL (US); Charles Brent Lohrmann, Ada, MI (US); James C. Spira, Shaker Heights, OH (US); John Sviokla, Newton, MA (US); Darren S. Yaphe, Chicago, IL (US); Lorraine McGlone, Indianapolis, IN (US)

Correspondence Address: BINGHAM MCHALE LLP, 2700 MARKET TOWER, 10 WEST MARKET STREET, INDIANAPOLIS, IN, 46204-4900, US

(21) Appl. No.: 11/842,582

(22) Filed: Aug. 21, 2007

Related U.S. Application Data
(63) Continuation of application No. 10/026,247, filed on Dec. 19, 2001, now abandoned.
Application No. 10/026,247 is a continuation-in-part of application No. 09/705,252, filed on Nov. 2, 2000, now abandoned.
(60) Provisional application No. 60/163,904, filed on Nov. 5, 1999.

(51) Int. Cl. G06Q 30/00; G06F 17/30; G06F 17/40

(52) U.S. Cl. 705/27; 705/1; 705/26

(57) ABSTRACT

An interactive system and method for shopping is disclosed that separates the shopping process from the buying process. In one embodiment, the system includes an in-store/in-mall computer system and a plurality of handheld scanners configured to scan product information and upload that information to a central database. The system further includes an interactive Web site that is in communication with the database. The system allows a user to scan items for a wish list at participating stores before or after creating an account with the system. The system also allows buyers to easily shop for others by searching for a user's wish list and personal preferences at the system Web site. Furthermore, the system allows the user to select one or more buyers from an address book and notify the selected buyers of a specific wish list via e-mail.

### CROSS REFERENCE TO RELATED APPLICATIONS

This application is a continuation of U.S. application Ser. No. 10/026,247, filed Dec. 21, 2001, which is a continuation-in-part (CIP) of U.S. application Ser. No. 09/705,252, filed Nov. 2, 2000, which claims priority to and the benefit of U.S. Provisional Application Ser. No. 60/163,904, filed Nov. 5, 1999. The applicants are claiming priority to and the benefit of both of these applications, making the effective filing date of all common subject matter in this application Nov. 5, 1999. Each of the above-related applications is assigned to the assignee of the present application.

### FIELD

The present invention relates to the field of electronic shopping. More specifically, the invention relates to a system and method that separates the shopping process from the buying process through an electronic shopping system that is coupled through the Internet (or some other wide area network) to an on-line shopping and buying Web site portal.

### BACKGROUND

Traditionally, most shopping and subsequent buying was done on the premises of a physical store. Over time, shopping centers and malls were developed to bring together various types of stores, including specialty shops, in close geographical proximity to each other. The convenience offered by malls and shopping centers has long been appreciated by consumers for they had previously spent a great deal of time traveling from store to store.

In addition to shopping in physical locations, various companies have offered their products or services by mail order. Mail order typically works by the delivery of a product catalog to a potential customer. If the potential customer was interested in making a purchase, they simply picked up the telephone and ordered the items seen in the catalog, or placed an order by mail. Those ordered items were then delivered to the purchaser's specified address by mail.

The availability of cable television has provided yet another method for shopping. In addition to just the casual advertisement on the local channels, dedicated cable networks, such as the Home Shopping Network and QVC, are available which advertise products or services. Typically, a consumer watches the television and picks up the phone to place an order for an item just “seen” on television.

Most recently, electronic commerce (“e-commerce”) has had a major impact on the “shopping experience.” Specifically, an individual is now able to shop on the Internet. Internet shopping is usually accomplished by the individual seeking out particular Web sites having the types of items of interest, such as Amazon.com for books, CDnow.com for music CDs, etc., browsing that Web site for particular items, and then placing orders. However, many people do not actually place orders over the Internet, but rather return to a physical store or place a mail order for the particular products they've selected. The reluctance of consumers to place an order over the Internet has been, in part, due to the general population's concern with the security of using credit card numbers over the Internet, the inability of the consumer to talk with a sales representative about the product, and/or the inability of the consumer to evaluate the item in something other than virtual reality.

There are still significant advantages to actually seeing merchandise in a physical location rather than simply viewing the item in a two-dimensional perspective as on the Internet, on television, or in a catalog. The two-dimensional view of an item does not provide information as to the item's texture, and may also be very deceptive as to the actual appearance or color, as color is very much determined by the particular settings on a computer monitor, the settings and reception of a television, and the quality of print in a catalog.

Further, in Internet, television and mail order shopping it is difficult to bring together many types of items in close proximity to each other. Television and catalog shoppers are limited to the specific items presented on television or in the catalog. In the Internet world, it is not uncommon for a Web site to be dedicated to a particular manufacturer's products. While cyber-malls (virtual malls on the Internet) exist, they are usually limited to the particular manufacturers that have signed up with the cyber-mall owner. Thus, while Internet technology presents the possibility of improved “space” navigation through various choices that are available to the shopper, it provides a disjointed shopping experience.

These prior art systems do not provide any linkage between the “space” and “place” aspects of shopping. In this regard, “space” refers to the navigability (or degree of availability) of information presented (e.g., over the Internet), and “place” refers to the physical location of the merchandise. Such an integration of space and place would provide a more cohesive shopping experience.

In the past, gift registries for wedding showers and/or weddings have provided a limited ability to separate the general shopping process from the buying process. However, these registries are usually limited to the physical place. For example, an engaged couple may go to a particular store and select various items that they are interested in receiving as wedding gifts. Sometimes, the couple may be able to enter their information electronically, such as on a gift registry Web site or through a computer-operated kiosk; however, their selections are typically limited to the particular virtual store in which they are shopping (if through a Web site), or are limited to a particular mall in which one or more merchants may be participating in the gift registry (if through an in-mall kiosk).

Thus, there remains a general need in this field for a system and method of electronic shopping that separates the shopping process from the buying process while at the same time providing for the integration of “space” and “place,” without necessarily being bound to the merchandise available in any physical place from a multitude of retailers.

### SUMMARY

An interactive system and method are provided for in-store/in-mall and on-line shopping in which the shopping process is separated from the buying process. The system preferably includes an in-store or in-mall computer coupled to a central database and a plurality of handheld data entry units. The system also includes an interactive shopping Web site coupled to the database. The data entry units are configured to scan product information and upload that information to the central database. The system allows a user to scan items for a wish list at participating stores before or after creating an account with the system. The system also allows buyers to easily shop for others by searching for a user's wish list and personal preferences at the system Web site. Furthermore, the system allows the user to select one or more buyers from an address book and notify the selected buyers of a specific wish list via e-mail.

Using this interactive shopping system, a user (or shopper) shops for and selects desired products at physical retailers by scanning product information associated with the desired products. The selected products are then uploaded and stored in the central database as an unassigned list. Having selected products from a physical store or mall, the user thereafter logs into the system Web site using, for example, a personal computer and generates one or more wish lists that include one or more products from the unassigned list. Each wish list can be associated with an event or occasion, such as a birthday, an anniversary, Christmas, etc. The user may then add more products to the wish list from a physical retailer or an e-tailer.

The user then selects an access mechanism for notifying buyers about each wish list. Access mechanisms include providing password protection, providing an access control list (ACL), providing a Share List, making a wish list Public, and/or making a wish list Private. The user can generate an e-mail notification that provides selected buyers with access information to one or more wish lists. The buyers can then access the system Web site where the appropriate list(s) may be displayed. From the Web site, the buyer may: (1) print out the list(s) and go to the physical store where the products are located to make a purchase, (2) purchase one or more of the products on-line and have them delivered, (3) purchase one or more of the products on-line and pick-up the products at a physical store, or (4) notify an in-store/in-mall concierge service to go to a physical store, buy the products on behalf of the buyer, and ship the products to the buyer or to the user.

The present invention provides a shopping system in which the shopping process, i.e., the act of browsing a store (either physical or e-commerce) and selecting a particular product or set of products, is separated from the buying process, i.e., purchasing a particular product that has been previously selected through the shopping process. Moreover, the present invention provides a shopping system in which the shopping process is not necessarily constrained by any physical place, or, indeed, any particular vendor of products.

According to another aspect of the invention, a system and method are provided for integrating the space and place in an interactive shopping system, as previously described. To accomplish this objective, this aspect of the present invention includes a central database for retaining product and related data from a myriad of retailers at a plurality of physical malls or shopping centers. Handheld data entry units, such as barcode scanners, personal digital assistants (PDAs), wireless telephones (cellular, PCS, GSM), or any other portable data entry unit, communicate with the central database by means known in the art (such as via the Internet, a direct link, a network, an infrared, RF link, or other communication means). The user scans product information about desired products using a data entry unit. Each data entry unit is coupled to the central database via a computer terminal located at an interactive kiosk in a store or mall. The computer terminal is coupled through a network, such as the Internet, to the central database.

According to one method of the invention, a shopper can survey the “place,” i.e., the physical store to select desired items. Those items are scanned and stored, for example, in the handheld device and then sent, for example, directly from the handheld device to the central computer, from the handheld device to an interactive kiosk to the central computer, from the handheld device to the central computer via the Internet, or from the handheld device to the central computer via any such similar communication means. The items are stored in the central database as an unassigned list of items. After the user completes the selection process, the user can assign items to one or more wish lists. Then, the user can identify who has access to the wish lists (i.e., everyone or only specific buyers). This method results in a unique cross-channel cross-retail interactive shopping experience. Also, the list of desired items that the user creates by this method is no longer limited to the particular type of event (such as a wedding) as is true in the prior art. Thus, the system has the effect of creating a cross-event shopping experience in addition to one that is cross-channel and cross-retail.

Those who have been given access to a wish list can retrieve the product information via, for example, the Internet. These buyers can then purchase any of these products based on this retrieved information. Such purchases could be transacted over the Internet, by mail order, by shopping directly at the store where the user selected the item, or by a store similar to where the user selected the item (such as a chain store in a different geographical location). The buyer may wish to shop at a physical store to ascertain features or characteristics of a selected item, such as, for example, the color, size, or texture, which are not discernable via electronic or printed media. In one embodiment, the system allows the user to select product parameters (such as color and size) through a pull-down menu (if that information is not already contained in the SKU information displayed for each product). This information is displayed to buyers via the system Web site.

As will be appreciated, the invention is capable of other and different embodiments than those discussed above and described in more detail below, and its several details are capable of modifications in various respects, all without departing from the spirit of the invention. Accordingly, the drawings and description of the embodiments set forth below are to be regarded as illustrative in nature and not restrictive.

### BRIEF DESCRIPTION OF THE DRAWINGS

The present invention satisfies the general need noted above and provides many advantages, as will become apparent from the following description when read in conjunction with the accompanying drawings, wherein:

FIG. 1 is a diagram of an in-store/in-mall and on-line interactive shopping system according to a one embodiment of the present invention.

FIG. 2 is a flow chart showing how a user (or shopper) interacts with the system shown in FIG. 1.

FIG. 3 is a flow chart showing one embodiment of how a buyer interacts with the system shown in FIG. 1.

FIG. 4 illustrates the components of one embodiment of the present invention.

FIG. 5 illustrates how a wish list creator (user) and/or a wish list buyer interact with components of the system of FIG. 1.

FIG. 6 illustrates how an aggregated shopper interacts with components of the system of FIG. 1.

FIGS. 7a-b are detailed flow charts illustrating how a user registers and accesses the system of FIG. 1.

FIG. 8 is a detailed flow chart illustrating how the system allows a user to access system functions that require registration, according to one embodiment of the invention.

FIG. 9 is a detailed flow chart illustrating how the user searches for products and creates and/or modifies a wish list.

FIG. 10 is a detailed flow chart illustrating how the user modifies a general wish list contains all the items selected while shopping on-line.

FIG. 11 is a detailed flow chart illustrating how the user adds items to a shopping cart database.

FIG. 12 is a detailed flow chart illustrating how the user modifies a wish list.

FIG. 13 is a detailed flow chart illustrating how the user creates a specific wish list.

FIGS. 14a-b are detailed flow charts illustrating how the system allows the user to transfer items from a wish list to a shopping cart for purchase.

FIG. 15 is a detailed flow chart illustrating how the system allows the user to transfer items from a general wish list to a specific wish list.

FIG. 16 is a detailed flow chart illustrating how the system allows the user to delete items from a wish list.

FIG. 17 is a detailed flow chart illustrating how the user selects a certain number of items from his/her wish list to be added to the user's shopping cart.

FIGS. 18a-b are detailed flow charts illustrating how the user selects items to purchase on-line and how the user reviews his/her shopping cart on-line.

FIGS. 19a-b are detailed flow charts illustrating how the user adds an item to a wish list from an e-tailer Web site.

FIGS. 20a-b are detailed flow charts illustrating how a buyer buys an item from an e-tailer Web site.

FIG. 21a is a detailed flow chart illustrating the system shopping cart checkout module, according to one embodiment of the invention.

FIG. 21b-c are detailed flow charts illustrating how the system fulfills an order.

FIGS. 22a-b are detailed flow charts illustrating how the user creates an access mechanism that allows specified buyers to be notified about, and have access to, one or more of the user's wish lists.

FIGS. 23a-b are detailed flow charts illustrating how the user adds a buyer to his/her access mechanism.

FIGS. 24a-b are detailed flow charts illustrating how the buyer views a wish list at a store/mall or on-line.

FIG. 25 is a detailed flow chart illustrating how the user, aggregated shopper and/or buyer interact with components of the system of FIG. 1.

FIGS. 26a-b are detailed flow charts illustrating how the buyer at an in-store/in-mall kiosk interacts with the system of FIG. 1.

FIG. 27a is a detailed flow chart illustrating how the buyer purchases items on a wish list at a store or mall.

FIG. 27b is a detailed flow chart illustrating how the kiosk agent synchronizes the data in the PDA scanner with retailer data from an external database.

FIG. 28 is detailed flow chart illustrating how the kiosk agent identifies an in-store/in-mall user to the system.

FIGS. 29a-b are detailed flow charts illustrating how the user adds items to a wish list at a physical store or mall.

FIGS. 30a-b are detailed flow charts illustrating how the system handles errors when an item is scanned.

FIGS. 31a-b are detailed flow charts illustrating how the kiosk agent synchronizes the new PDA scanner data with existing data on an external database.

FIGS. 32a-b are detailed flow charts illustrating how the user can add, delete and/or buy items on a wish list at a physical store or mall.

FIG. 32c is a detailed flow chart illustrating how the user can purchase items in his/her electronic shopping cart while at a physical store or mall.

FIG. 33 is a diagram of an in-store/in-mall and on-line interactive shopping system according to another embodiment of the present invention.

FIG. 34a is a flow chart illustrating how a user scans products using the system of FIG. 33.

FIG. 34b is a flow chart illustrating how a user assigns products to a specific wish list using the system of FIG. 33.

FIG. 35 is a flow chart illustrating how a user registers with the system of FIG. 33.

FIG. 36 is a flow chart illustrating how a user sets personal preferences according to the system of FIG. 33.

FIG. 37 is a flow chart illustrating how a user adds and deletes member card numbers according to the system of FIG. 33.

FIG. 38a is a flow chart illustrating how a user creates wish lists according to the system of FIG. 33.

FIG. 38b is a flow chart illustrating how a user edits wish lists according to the system of FIG. 33.

FIGS. 39a-39b are a flow chart illustrating how a user creates and edits address book entries according to the system of FIG. 33.

FIG. 40 is a flow chart illustrating how a user creates a share list according to the system of FIG. 33.

### DESCRIPTION

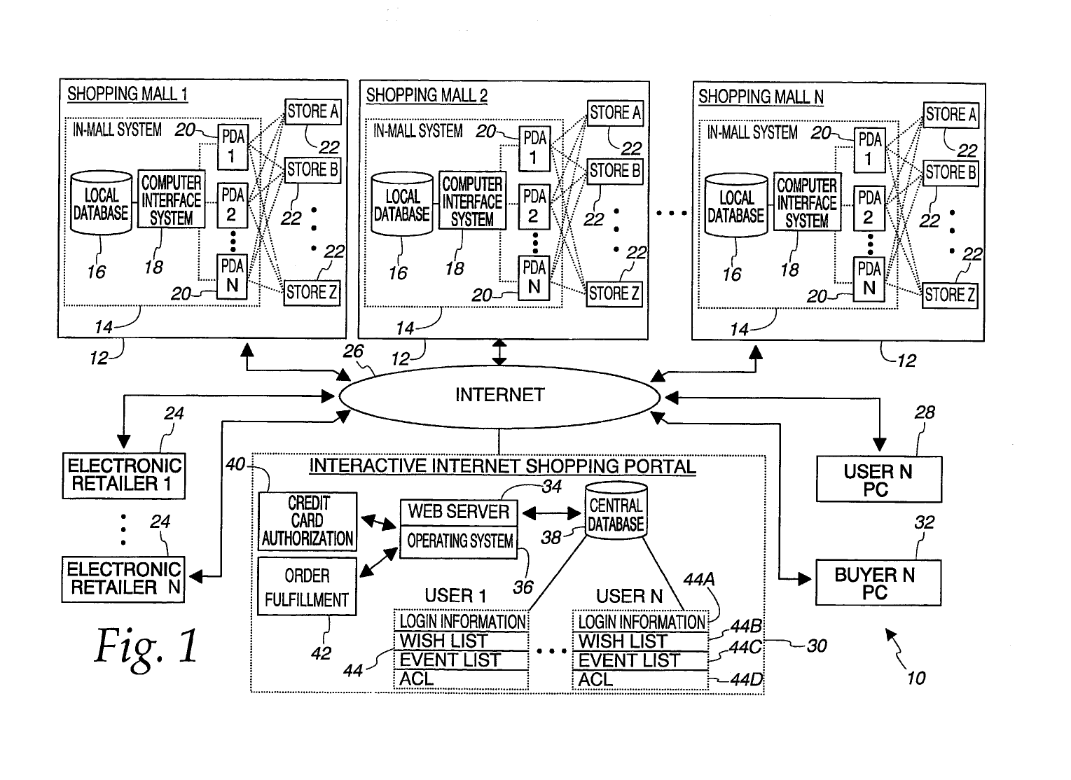

Turning now to the drawings, FIG. 1 is a diagram of an in-store/in-mall and on-line interactive shopping system 10 according to one embodiment of the present invention. This system 10 includes Electronic Shopping Systems 14 located within a plurality of physical stores or malls 12. Located within each mall are a plurality of physical stores 22 (Store A-Store Z). These stores (all or some of them) may be active participants in the interactive shopping system 10, although not necessarily to the same degree. The system also includes an Interactive Internet Shopping Web Site Portal 30, a plurality of Electronic Retailer Web Sites 24, and a plurality of user and buyer personal computers (PCs) 28, 32. All of these various systems 14, 30, 24, 28 and 32 are coupled together via a wide-area communications network 26, such as the Internet. Note, however, that network 26 could also be a cable TV network, a satellite network, a wireless data network, or any other type of communications network.

In the Internet embodiment, the communication network 26 is defined by the TCP/IP protocol. The various connections between the in-store/in-mall systems 14, the Interactive Internet Portal 30, the Electronic Retailer Web Sites 24, and the user and buyer PCs via the Internet may be any type of connection, such as a circuit-switched telephone line connection (using a data modem), a T-1 or T-3 dedicated telephone connection, a fiber-optic line, an xDSL connection, a CATV modem connection, a wireless connection, a satellite link connection, or any other type of connection that is capable of transporting data.

In one embodiment, the in-store/in-mall systems 14 include a computer interface system 18, which could be a PC, a workstation, or any other type of computer system, a local database 16 coupled to the computer interface system 18, which could be integral to the computer interface system 18, or could be separate and apart from it, or could be coupled to the computer interface system 18 via a network, as shown in FIG. 1. The computer interface system 18 is coupled to a plurality of scanners 20, which communicate with the computer interface system 18, for example, through an interface cradle that holds the scanner 20 and provides an electrical data connection between the scanner 20 and the computer interface system 18 so that data from the scanner 20 can be uploaded to or downloaded from the computer interface system 18. As used herein, PDA scanners that connect to the interface system 18 via an interface cradle are considered “batch processing” PDA scanners. Alternatively, the PDA scanners 20 may be coupled to the computer interface system 18 via a wireless data connection that allows data to be uploaded or download periodically or continuously without having to be physically connected to an interface device.

In one embodiment, the Interactive Internet Shopping Web Site Portal 30 includes a Web server 34 (which hosts one or more Web sites comprising a plurality of Web pages coded using standard languages and protocols, such as HTML, XML, Java, JavaScript, ActiveX, SHTML, etc.), an underlying electronic commerce shopping operating system (SOS) 36, a credit card authorization module 40, an order fulfillment module 42, and a central database 38, as shown in FIG. 1. As used herein, the term “database” refers to any collection of data organized especially for rapid search and retrieval, whether that data reside on one or more physical storage devices (e.g., a distributed database system), or whether the data is accessed via an index, a directory, a table, etc. Therefore, although different names are given to some of the databases herein, this is for ease of understanding and should not limit the appended claims.

In one embodiment, the Web server 34 hosts the Web site 30 which allows a user to store and generate “wish lists” of products selected either through the in-store/in-mall systems 14 and/or from the Electronic Retailers 24, and create various “events” that include one or more products from the wish lists. The Web site 30 also provides a buyer interface for enabling purchase of products associated with a particular event. In one embodiment, the Web site 30 is referred to and accessed using the domain name “fastfrog.com.” In addition to the electronic shopping and purchasing features noted herein, the Web site 30 may also include many other functional attributes that are particular to the target audience, e.g., adults, teenagers.

In the embodiment of FIG. 1, users (or shoppers) of the system 10 enter login information 44A to register with the system 10. After the user has selected one or more products though the in-store/in-mall systems 14 and/or through the Electronic Retailers 24, a wish list 44B of products is created and stored in the central database

The wish list 44B contains all of the products (either located in the physical stores 22 or at the Electronic Retailers 24) that the user has shopped for and selected so that someone else (e.g., a buyer) can purchase one or more of those selected products as a gift (or for any other reason) for the user. Having generated a wish list 44B, the user can then use the Web site 30 to create one or more “events” including one or more “event lists.” An event is an occasion, special date, or other categorization associated with the particular user that includes one or more of the items on that user's wish list.

For example, a user may have 30-40 products listed on his/her wish list, and may have several “events” up-coming, such as a ski trip, Christmas and a birthday. Using the event feature of the present invention, the user can create a “Ski Trip Event”, a “Birthday Event”, and a “Christmas Event”, and then select certain of the items from the wish list 44B for one or more “event lists” 44C that are linked to one of the created events. So, for example, the user may select a new jacket and pair of skis to add to the Ski Trip Event, and may select a digital camera and a tripod to add to the Birthday Event. In this manner, users can create a series of “events” in their life and then associate certain wish list items with those events.

For each event, users also select an access mechanism such as, for example, an access control list (“ACL”) that only allows members of the ACL to access selected event list(s), password protection which only grants buyers having the required password access to specified event list(s), public access which allows any interested buyer to access selected event list(s), or private access which only allows the creator-user to access selected event list(s). Although the access control list (ACL) embodiment is illustrated herein, any access mechanism that allows one or more buyers access to a scan list, wish list, and/or event list is within the scope of the claimed invention. In FIG. 1, ACL 44D includes a list of authorized buyers that may gain access to the product information associated with a particular event.

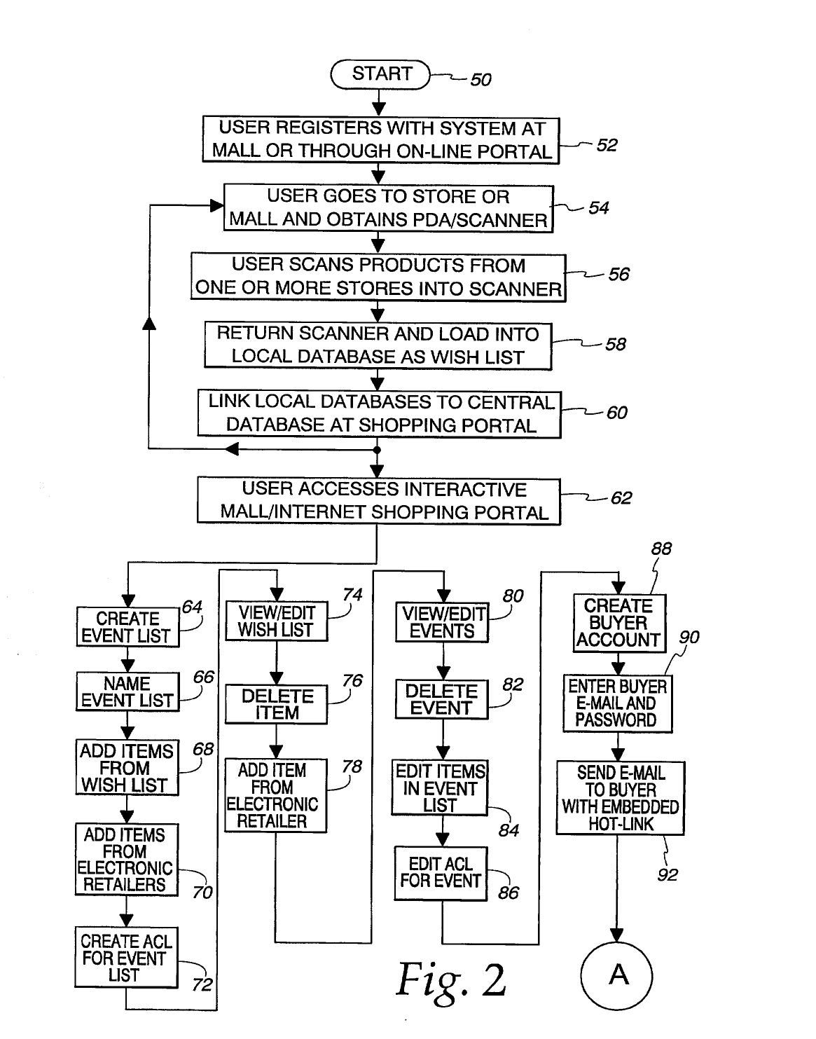

FIG. 2 is a flow chart showing one embodiment of the invention depicting how the user (or shopper) interacts with the system 10 shown in FIG. 1. The system first proceeds from block 50 to block 52 where the user registers with the system 10 either at one of the in-store/in-mall systems 14, or through the Interactive Internet Shopping Web Site Portal 30. The registration process requests identifying information about the user, including, for example, his/her home address, telephone number and e-mail address, and asks the user to select a username that will uniquely identify the user to the system 10 and a password. Other registration information may also be collected from the user. If the user registers at a particular in-store/in-mall system 14, then this registration information will be stored in the local database 16 associated with that particular in-store/in-mall system 14, and will thereafter be communicated to the central database 38, via the Internet.

In block 54, the user goes to a physical store or mall 12 and checks-out a PDA scanner 20. Using the scanner 20 (block 56), the user may then browse through one or more of the participating physical stores 22, and select certain products to add to his/her wish list by, for example, scanning a UPC barcode located on the particular product. Alternatively, the user (or a store clerk) may enter information about a desired product manually into the PDA scanner 20. Other means of data input may also be employed to get identification information on a particular product into the scanner 20. The user may then continue to visit stores 22 and scan (or enter data regarding) products into the scanner 20. In this manner, users can “shop” for certain products that they want a buyer to purchase for them, but the users do not actually purchase any of the products, although, of course, there is nothing in the system design of the present invention that would prevent the users from purchasing any of the products on their wish list.

Having selected (or shopped) for particular products at the various stores 22, the user, in block 58, returns the scanner 20 to the in-store/in-mall system 14. In one embodiment, the scanner 20 is placed into a cradle that physically holds the scanner and puts the scanner 20 to communicate with the computer interface system 18. Alternatively, the scanner 20 may be in continuous (or periodic) communication with the computer interface system 18 through a wireless data connection. Regardless of the method of communication, when the scanner 20 is coupled to the computer interface system 18, the system 18 sends a command to the scanner 20 to download product information to the local database 16. Here, the product information is saved as a “wish list” of items that this particular user wants a buyer(s) to purchase for him/her. Periodically, in block 60, the wish list information in the local database 16 is replicated to the central database 38 associated with the Web site portal 30.

After block 60, the user can leave the store or mall 12 and later return to this store or mall (or some other store or mall) and continue to select products and add them to his/her wish list by returning to block 54, or the user can proceed to block 62 to begin the event generation process.

The user, in block 62, has left the physical store or mall 12, and is now most likely at his/her home (or somewhere with access to the Internet) where he/she has a PC 28, which is coupled to the Internet by, for example, a dial-up modem connection through an Internet Service Provider, a cable-modem connection over a local cable TV system, etc. The user, operating standard Web-browser software such as Microsoft's Internet Explorer or Netscape's Communicator, then connects to the Internet by establishing a TCP/IP connection and navigates the Web browser to the Interactive Internet Shopping Web Site Portal 30 by entering the Uniform Resource Locator (“URL”) of the Web site associated with the Web site portal 30. As previously indicated, in one embodiment the URL for a Web site associated with teenage users is “www.fastfrog.com,” although, of course, any other URL could be used. This particular URL is only listed herein because some of the Figures refer to the “fastfrog” Web site.

At the Web site portal 30, the user is prompted to enter his/her login information (username/password), and if there is a match to the entered login information stored in the central database 38, then the user can gain access to any wish list 44B, event list 44C and ACL 44D information associated with this particular user. Having entered the proper login information (block 62), the user may: (1) create an event list (block 64); (2) view/edit a wish list (block 74); (3) view/edit events (block 80); and (4) create a buyer account (block 88). Note that these are only four of the basic functions provided by the system, and many other functions and features of the Web site portal 30, not specifically described with reference to FIG. 2, are evident from the other Figures which describe in more detail the full capabilities of the system 10, as described below.

In block 64, the user can create an event and a corresponding event list. In block 66, the user selects a name for an even, such as “Birthday”, “Ski Trip”, “Christmas” or any other event name that the user desires. Then, in block 68, the user selects one or more products that he/she previously added to his/her wish list through, for example, the PDA scanner 20 and the in-store/in-mall system 14, and/or from the plurality of Electronic Retailers 24, and adds the selected product(s) to the event list. In block 70, the user can add additional items from the Electronic Retailers 24. Finally, in block 72, the user selects an access mechanism for the particular event, which identifies which buyers, if any, are permitted access to the particular event list. In one embodiment, the access mechanism is an ACL that includes buyers who are authorized to access the particular event.

In block 74, the user can view and/or edit his/her stored wish list. The user can delete an item from the wish list (block 76), or add an item to the wish list from an Electronic Retailer 24 (block 78).

In block 80, the user can view and/or edit the events the user created. The user can delete a certain event from the system (block 82), the user can select a particular event and edit items, in block 84, on the event list (by, for example, deleting items, providing or changing a description of an item or certain particulars regarding an item), or the user may edit the ACL (by, for example, deleting certain buyers from the ACL, or adding a new buyer) for a particular event (block 86).

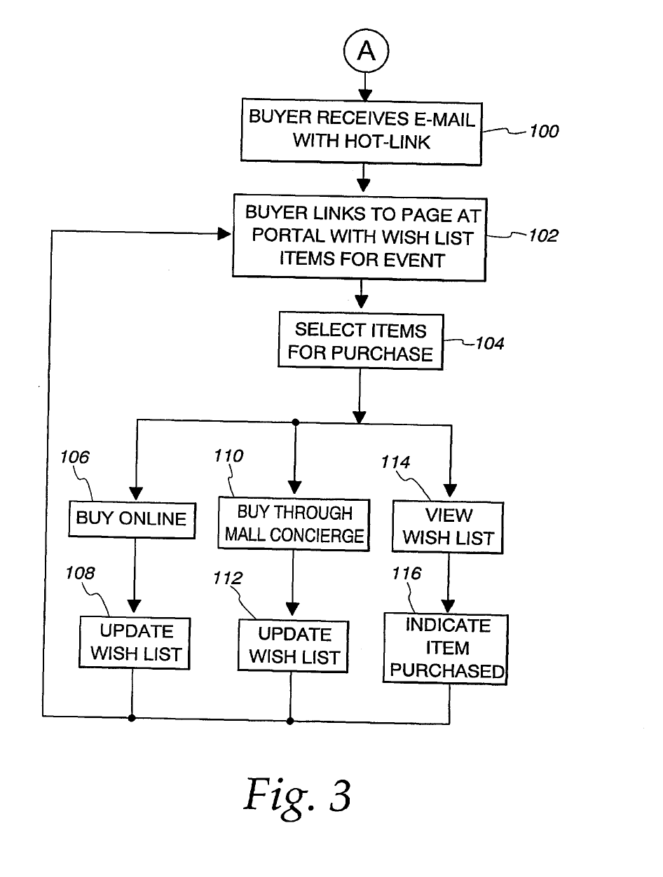

In block 88, the user can create buyer accounts. Buyer accounts are needed so that certain buyers (which are given access to various events via an access mechanism) can gain access to the Interactive Internet Shopping Web Site Portal 30 so that they can then access a particular event list. In block 90, the user enters identifying information regarding the new buyer, such as the buyer's name, e-mail address, and password. This information is then used to generate an e-mail message that is electronically transmitted to the buyer (block 92) to inform him/her that he/she has been designated as a potential buyer for a specified user. The message also describes how the buyer can gain access to the particular event list for which the user has designated the buyer. In one embodiment, the e-mail may contain an embedded HTTP hot-link (hyperlink) that, when selected by the buyer, will navigate the buyer's Web browser directly to the Web page where the particular event list is displayed. The Web page will then request the buyer's password information in order to allow the buyer access to the particular event list. From this point, the system proceeds to FIG. 3.

FIG. 3 is a flow chart showing one embodiment of how a buyer interacts with the system 10 shown in FIG. 1. In block 100, the buyer receives an e-mail with an embedded hyperlink, as described with reference to block 92. The buyer activates the hyperlink (block 102) which links the buyer's Web browser to the shopping portal Web site 30. Specifically, the hyperlink will direct the buyer's Web browser to the Web page where the particular event list is located. In one embodiment, the user's ACL grants the buyer access to the event list. In another embodiment, the user's event list is password protected and the e-mail to the buyer includes this password so that the buyer can access the event list. For example, the user may have created a “Birthday” event, and granted his/her brother access to the user's Birthday event list. The brother is then sent an e-mail informing him that his sibling has created a wish list for an upcoming birthday, and directing the brother to the appropriate Web page in order to view the wish list.

In block 104, the buyer may browse the event list of products, and select a particular product for purchase. In block 106, the buyer, depending on the product, may be able to immediately purchase the product on-line, in which case, in block 108, the wish list will be automatically updated to reflect that a particular product has been purchased. On-line purchasing (block 106) can be done using many well-known methods of carrying out e-commerce transactions through secure Web pages and protocols.

Alternatively, in block 110, the buyer can select to buy the product through an in-store/in-mall concierge service (e.g., yoursherpa.com). This service may be available for certain products that can only be purchased at the physical stores 22, and not on-line, and is useful where the buyer does not want to actually visit a physical store or mall 12. In block 112, the buyer updates the wish list.

Alternatively, in block 114, the buyer may simply view a list of the items on the event list (e.g., by displaying the list on a PDA or printing out a copy of the list), and then go to a physical store or mall where the buyer would shop in a conventional manner. In the event that the buyer elects to go to a physical store to buy a product on the event list, then, in block 116, a means is provided for the buyer to return to the event list Web page and indicate that a particular product on the event list has been purchased. Thus, the buyer can update the current status of the event list. At the end of each of these alternatives, the buyer can loop back to block 102 where the buyer is linked to the shopping Web site portal 30 so that the buyer can view another event list or quit.

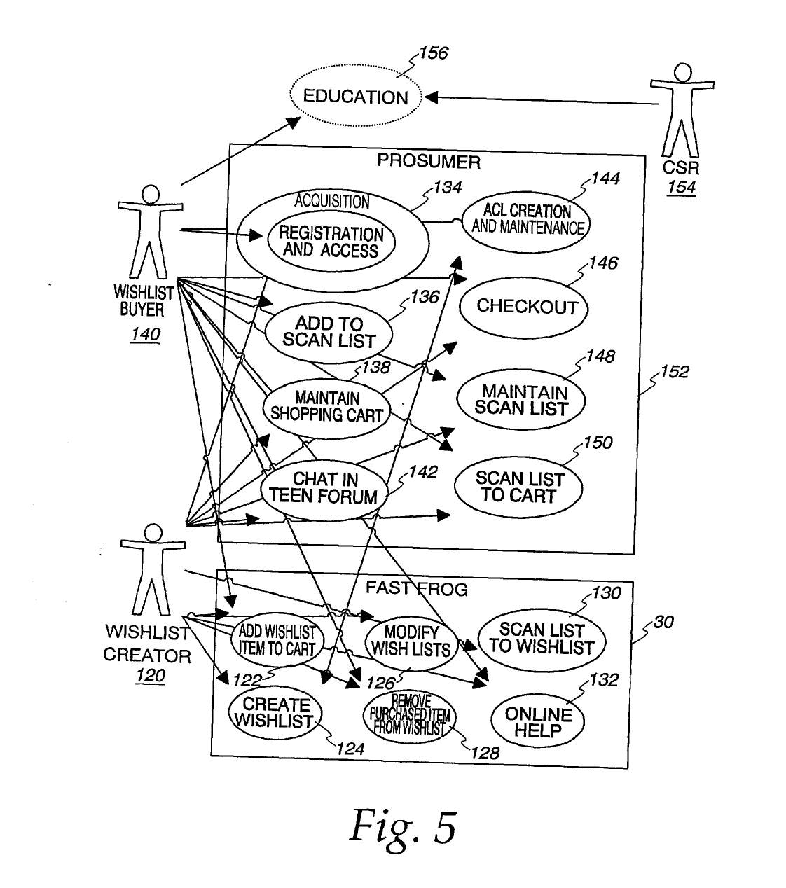

The following Figures represent various flow charts that are carried out using the system of the present invention. These flow charts illustrate: (1) how the in-store/in-mall and on-line shopper (user) interacts with the system (FIGS. 5-24); and (2) how the user uses the PDA scanner 20 in a physical store or mall 12 (FIGS. 25-32).

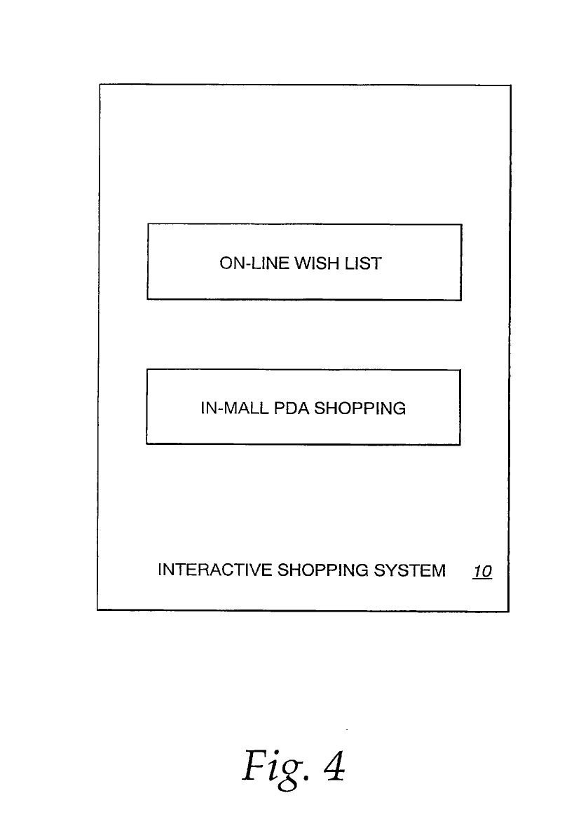

In one embodiment, the interactive shopping system 10 includes two components (1) an on-line wish list component, and (2) an in-store/in-mall PDA shopping component, as illustrated in FIG. 4. These components will be described in detail below.

With respect to the on-line wish list component, FIGS. 5-24 show detailed flow charts illustrating one embodiment of how the in-store/in-mall and on-line shopper (user) interacts with the shopping system 10 shown in FIG. 1. FIG. 5 shows one embodiment illustrating how a wish list creator 120 (a user who creates a wish list) and/or a wish list buyer 140 interact with the Web site portal 30 (identified in this embodiment as fastfrog.com) in order to, for example, add a wish list item to an electronic shopping cart (block 122); create a wish list (block 124); modify a wish list (block 126); remove purchased items from a wish list (block 128); move the list of scanned items to a wish list (block 130); and obtain on-line help (block 132). Similarly, the wish list creator (user) 120 and/or the wish list buyer 140 interact with a prosumer 152 (a platform where common functionalities of various applications, such as the user's wish list and personal profile, reside) in order to, for example, access the prosumer 152. The prosumer 152 may comprise a remote server that allows the user and/or buyer to: register with the Web site provider to gain access to the system (block 134); add an item to a list of scanned items (block 136); maintain an electronic shopping cart (block 138); chat in an on-line forum such as a teen forum (block 142); create and maintain an ACL (block 144); checkout by purchasing items in the shopping cart or exiting the Web site (block 146); maintain the list of scanned items (block 148); and move the list of scanned items to a shopping cart (block 150). In addition, a customer service representative (CSR) 154 is available to educate the wish list user/creator or wish list buyer about the shopping system and its functionality (block 156).

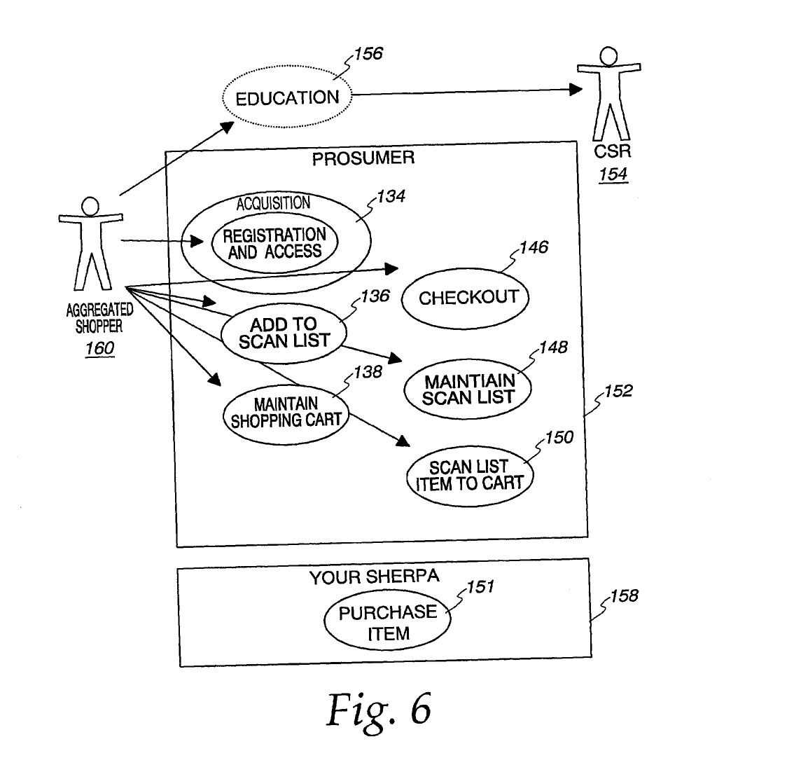

FIG. 6 shows an aggregated shopper 160 that interacts with the prosumer 152 in order to assist a user or buyer to, for example, register with the Web site provider (e.g., fastfrog.com) to gain access to the system Web site (block 134); add an item to a list of scanned items (block 136); maintain an electronic shopping cart (block 138); check-out by purchasing items in the shopping cart or exiting the Web site (block 146); maintain a list of scanned items (block 148); and move one or more of the scanned items to the shopping cart (block 150). In one embodiment, the aggregated shopper 160 represents a store or mall kiosk agent that, in addition to helping the user or buyer perform the above tasks, supervises the kiosk, authorizes user's to check out PDA's, and synchronizes the data in the PDA's with the data residing in the local database 16. In another embodiment, the aggregated shopper 160 is also known as YourSherpa which is a concierge service that buys selected items for a user from physical stores. The CSR 154 is available to educate the aggregated shopper 160 about the shopping system and its functionality (block 156).

A user (not shown) can interact with a Web site 158 (identified in this embodiment as yoursherpa.com) in order to, for example, create a buy list; modify a buy list; remove purchased items from a buy list; add a buy list item to an electronic shopping cart; and purchase items through an in-store/in-mall concierge service (block 151) (e.g., YourSherpa).

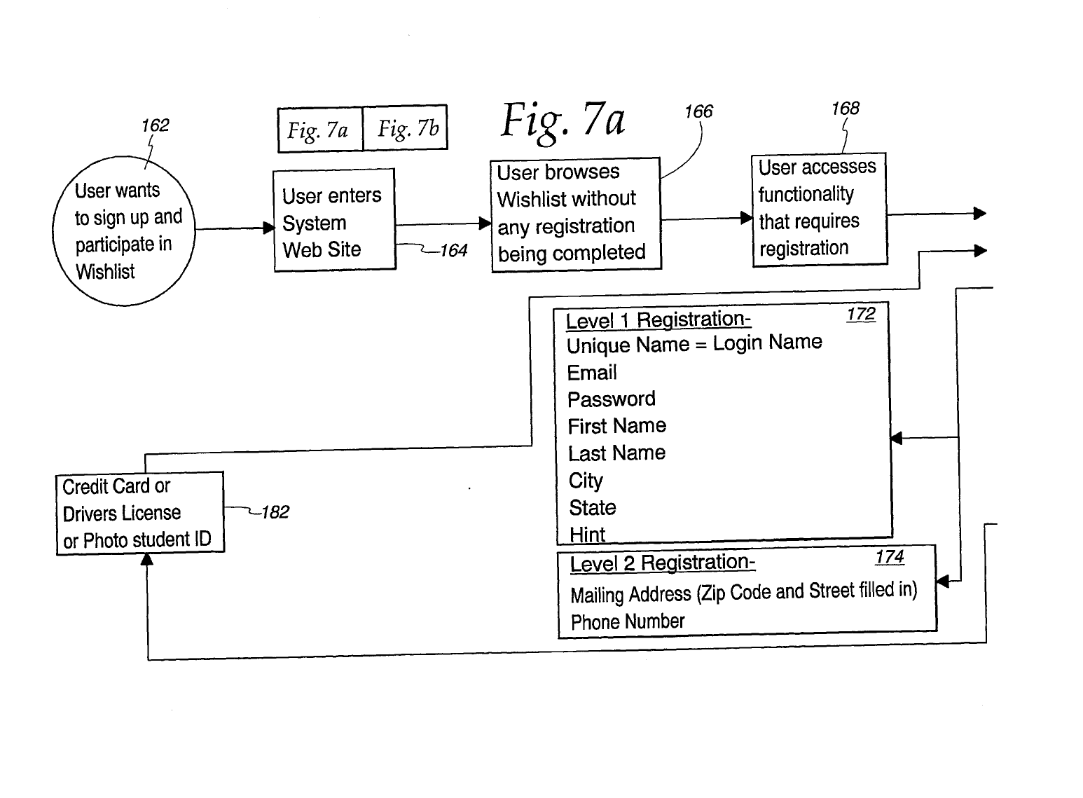

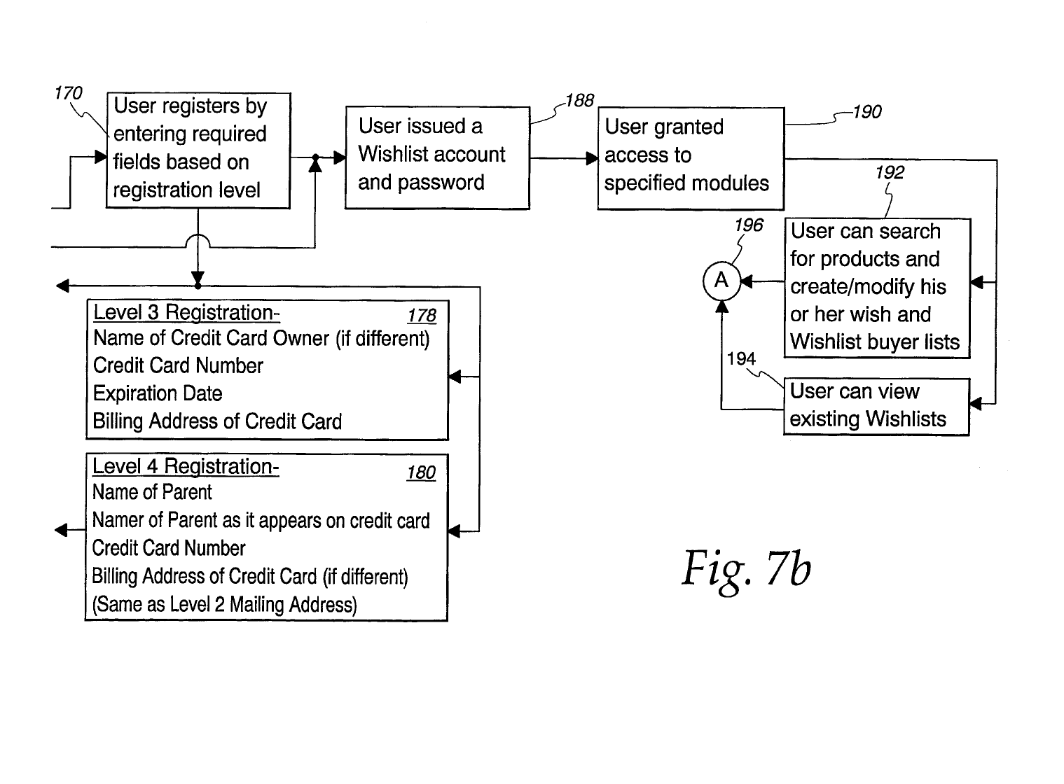

FIGS. 7a-b illustrate a flow chart showing in more detail block 134 of FIG. 5, the acquisition (registration and access) procedure. In the illustrated embodiment, a user (e.g., a teen) wishes to sign up and participate in the wish list Web site 30, as shown in block 162. The user enters the wish list Web site 30 by entering an appropriate URL on the user's Web browser, as shown in block 164. The URL may be, for example, wishlist.com, fastfrog.com, yoursherpa.com, or alphatribe.com. Then, the user browses the Web site without completing the registration process (block 166). If the user accesses functionality requiring registration (block 168), then the user is required to register by entering the requested information in the registration fields provided (block 170). The user enters the information requested, which depends on the registration level required by the user to proceed. For example, a Level 1 Registration, as shown in block 172, requires the user to enter: a login name, e-mail address, password, first and last name, city, state, and a password hint (in case the user forgets his/her password). In this embodiment, Level 1 Registration is required to build a wish list and/or to participate in a chat room.

In this embodiment, as shown in block 174, Level 2 Registration requires the user to provide, in addition to the Level 1 information, a mailing address, including zip code and street address, and a phone number. In the illustrated embodiment, Level 2 Registration is required to notify others of a wish list created by the user. If a user wants to check-out a scanner 20 at a store or mall to build a wish list, the user must provide Level 2 Registration information in addition to credit card information including, for example, a credit card number, expiration date, and credit card billing address.

In this embodiment, Level 3 Registration requires the user to provide, in addition to the Level 1 and 2 information, the name of a credit card owner (if different than the user's name), a credit card number, expiration date, and credit card billing address (block 178). In one embodiment, Level 3 Registration is required to buy items on a wish list. In this embodiment, Level 4 Registration requires the user to provide, in addition to the Level 1-3 information, the name of a parent, the parent's name as it appears on a credit card, a credit card number, and credit card billing address (if different than mailing address entered at Level 2) (block 180). In one embodiment, Level 4 Registration is required to provide collateral to check out a PDA scanner 20. In addition, as shown in block 182, the user's credit card, drivers license or photo identification is taken by a kiosk agent in the store or mall before allowing the PDA scanner 20 to be checked-out. This collateral is, for example, photocopied and immediately returned to the user or returned when the user returns the scanner 20.

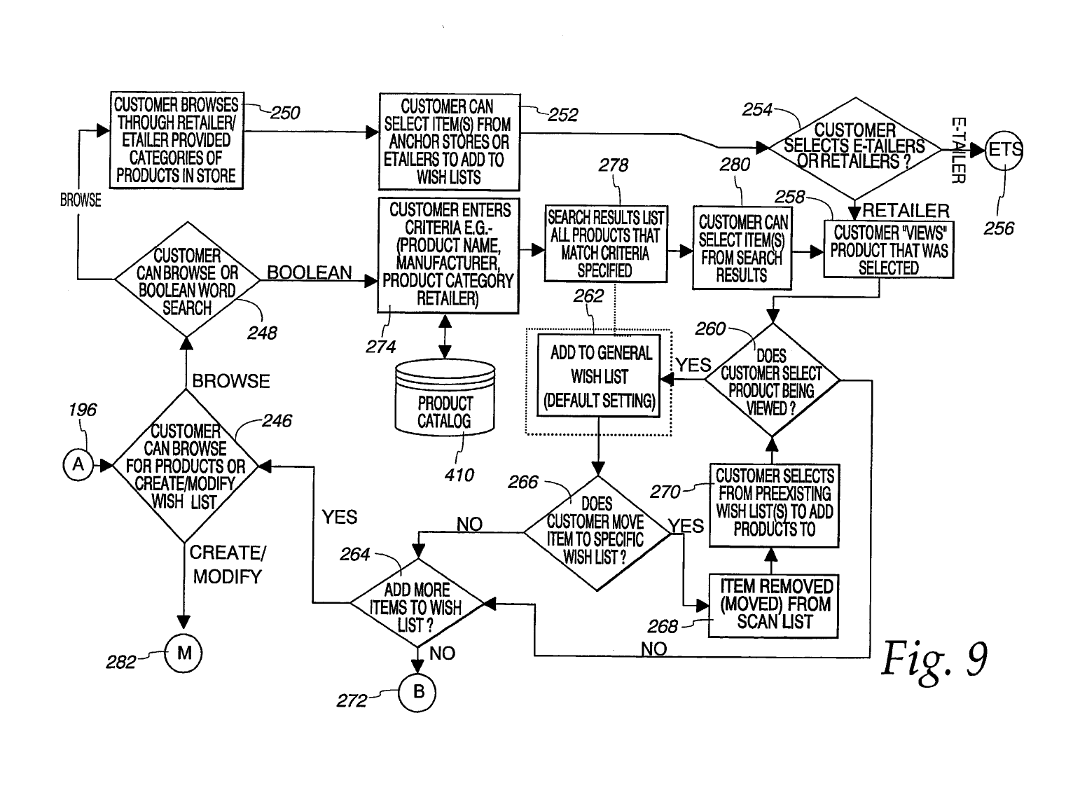

In block 188 of FIG. 7b, the system issues the user a wish list account and password. The user is then granted access to specified modules or functionality corresponding to the user's registration level (block 190). The user can, for example, search for products and create and/or modify a wish list and/or an access control list (ACL) (or any other access mechanism listing authorized buyers), as shown in block 192; view existing wish lists, block 194. From blocks 192 or 194, the user proceeds to block 196, described below with reference to FIG. 9.

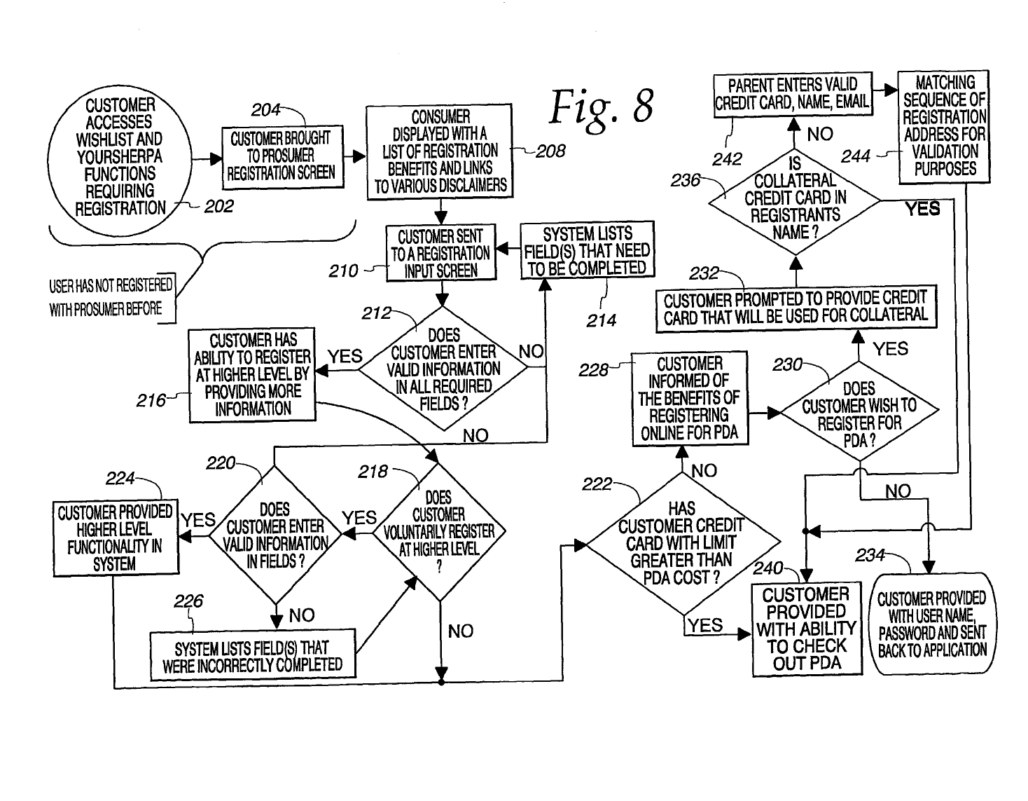

In FIG. 8, the system allows the user to access functions that require registration, such as accessing a wish list and/or using a concierge service (e.g., YourSherpa), as shown in block 202. If the user has not registered with the system and desires to access or perform functions that require registration, the user is linked to the prosumer registration screen (block 204). In one embodiment, the system then displays a list of registration benefits and provides links to various disclaimers (block 208). In block 210, the system displays a registration screen that allows the user to input registration information. The system then determines whether the customer entered valid information in all the required fields, as shown in block 212. If not, the system lists the field(s) that need to be completed (block 214). Otherwise, the system proceeds to block 216 where the user may obtain a higher registration level by entering more information.

In block 218, the system determines whether the user wants to register at a higher level. If not, the system proceeds to block 222. Otherwise, the system proceeds to block 220 where the system determines whether the user entered valid information in all the additional input fields. If all the fields do not contain valid information, the system proceeds to block 226 where the system lists the fields that were incorrectly completed. Otherwise, the system proceeds to block 224 where the user is provided a higher registration level depending on how much additional information the user provided. In block 222, the system determines whether the user has a credit card with a credit limit greater than the cost of a PDA. If the user has such a card, the user is thereafter authorized to check out a PDA at a participating store or mall (block 240). Otherwise, in block 228, the user is informed of the benefits of registering on-line for a PDA.

Next, the system determines whether the user wishes to register for a PDA (block 230). If not, the user is provided with a user name and password and is sent back to the main Web page (block 234). Otherwise, in block 232, the user is prompted to provide a credit card for collateral. The system then determines whether the credit card is in the name of the user (block 236). If so, the user is thereafter authorized to check out a PDA (block 240). Otherwise, the user enters a valid credit card number, the name of the card holder (e.g., the parent's name), and an e-mail address (block 242). In block 244, the system verifies that the credit card belongs to the card holder by, for example, verifying that the registration address entered by the user matches the mailing address for the credit card. If it does, the user is thereafter authorized to check out a PDA (block 240).

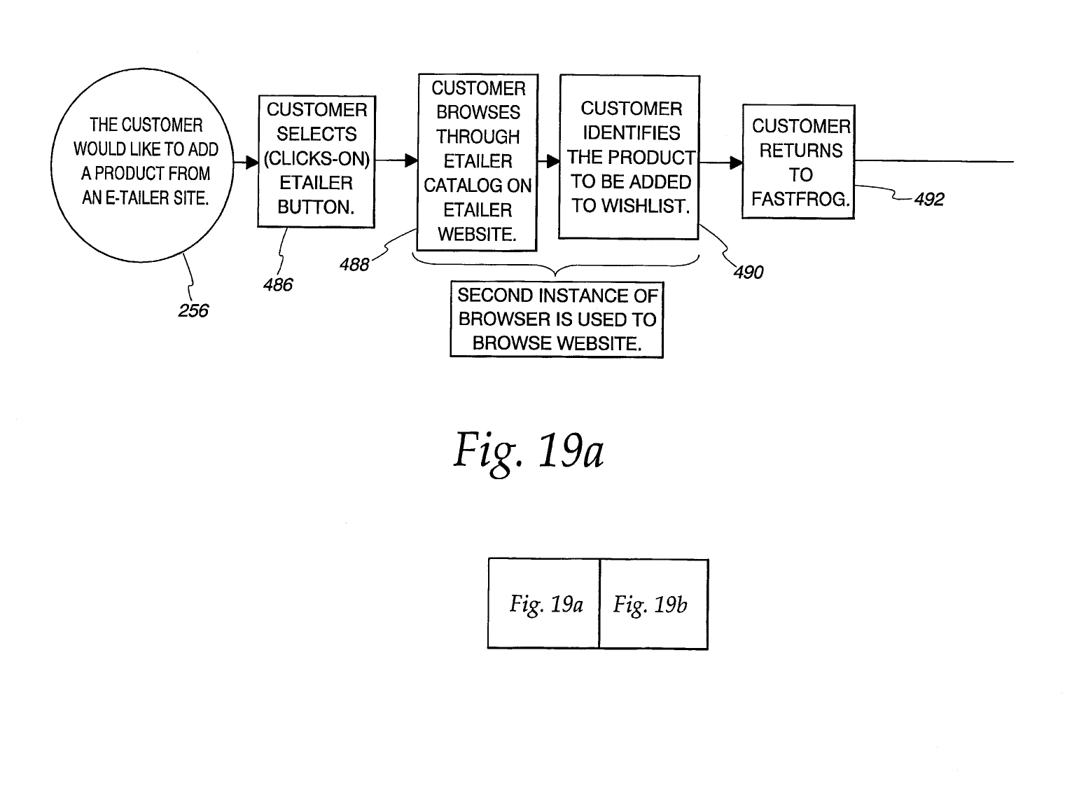

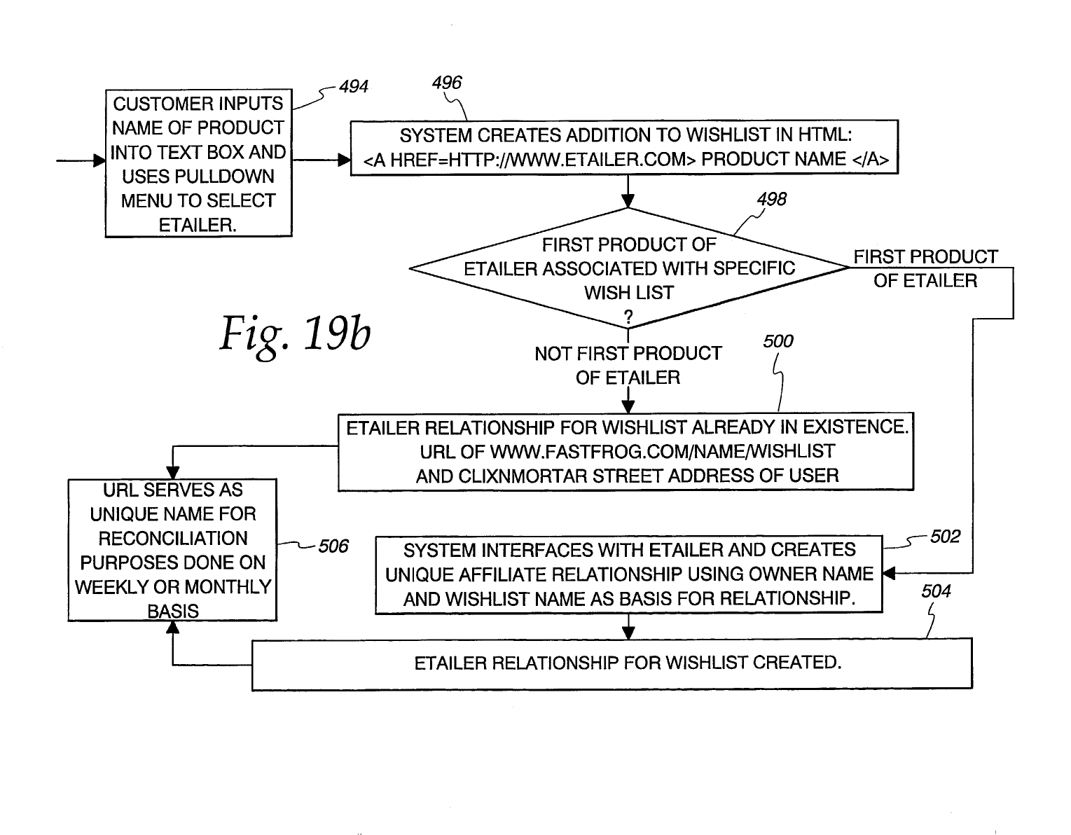

In FIG. 9, the system proceeds from block 196 to block 246 where the system determines whether the user wants to search for products (browse), or create and/or modify his/her wish list (create/modify). To create and/or modify a wish list, the system proceeds to block 282 (described below with reference to FIG. 12). Otherwise, the user can browse products from a list of retailers or perform a Boolean key word search (block 248). To do the former, the user browses through categories of products provided by registered retailers and/or e-tailers (such as Abercrombie & Fitch, Camelot Music, etoys, etc.) (block 250). Then, the system advises the user that he/she may select items from either retailers or e-tailers (block 252). The system then determines whether the user wants to shop at e-tailers or retailers (block 254). To shop e-tailers, the system proceeds to block 256 (described below with reference to FIGS. 19a-b). Otherwise, the system proceeds to block 258.

If the user chose (in block 248) to perform a Boolean key word search to find a particular item, the system proceeds to block 274 where the customer is prompted to enter search criteria (in Boolean search form) such as the name of a particular product, manufacturer, product category, retailer, etc. The system then searches database 410 which contains product data. The search results are then returned to the user. The results include a list of products that match the search criteria specified by the user (block 278). The user can then select the desired item(s) from the search results (block 280).

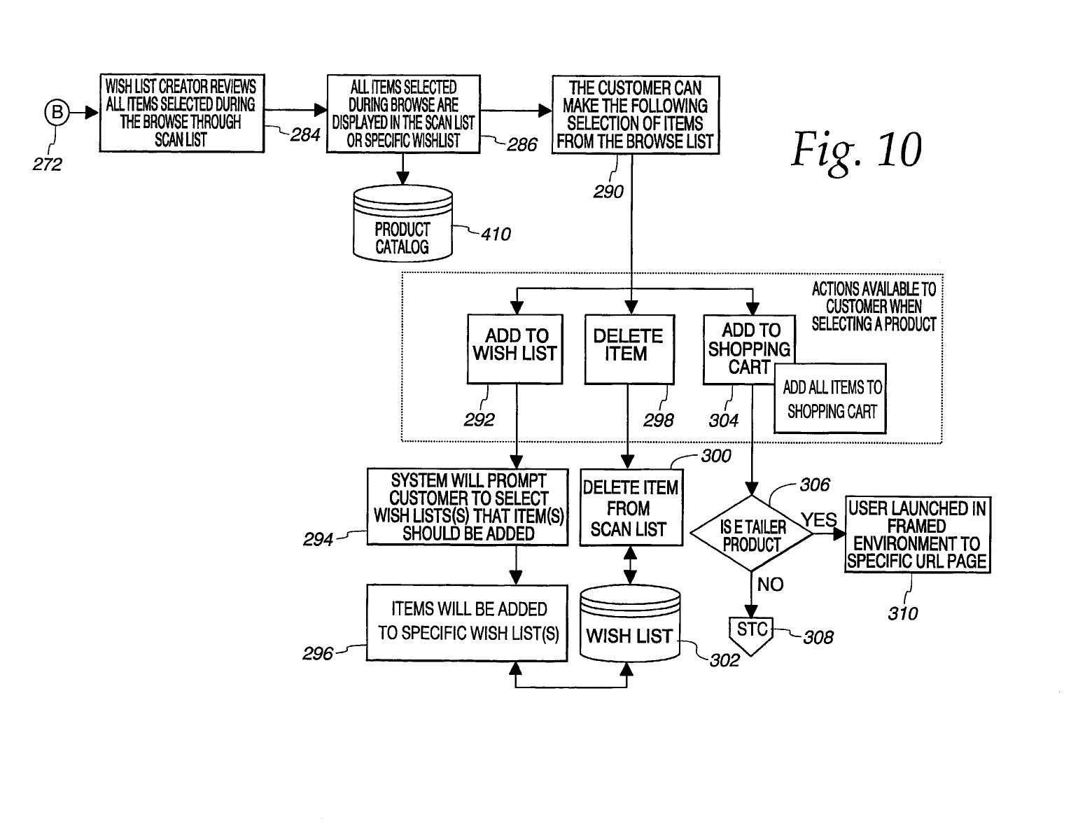

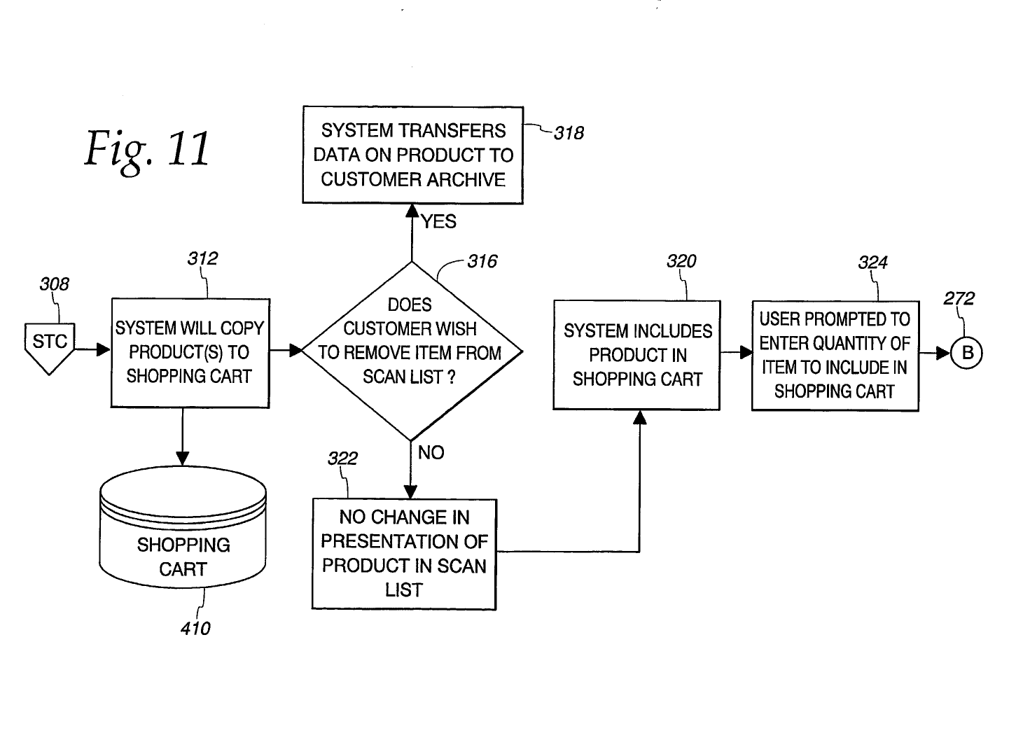

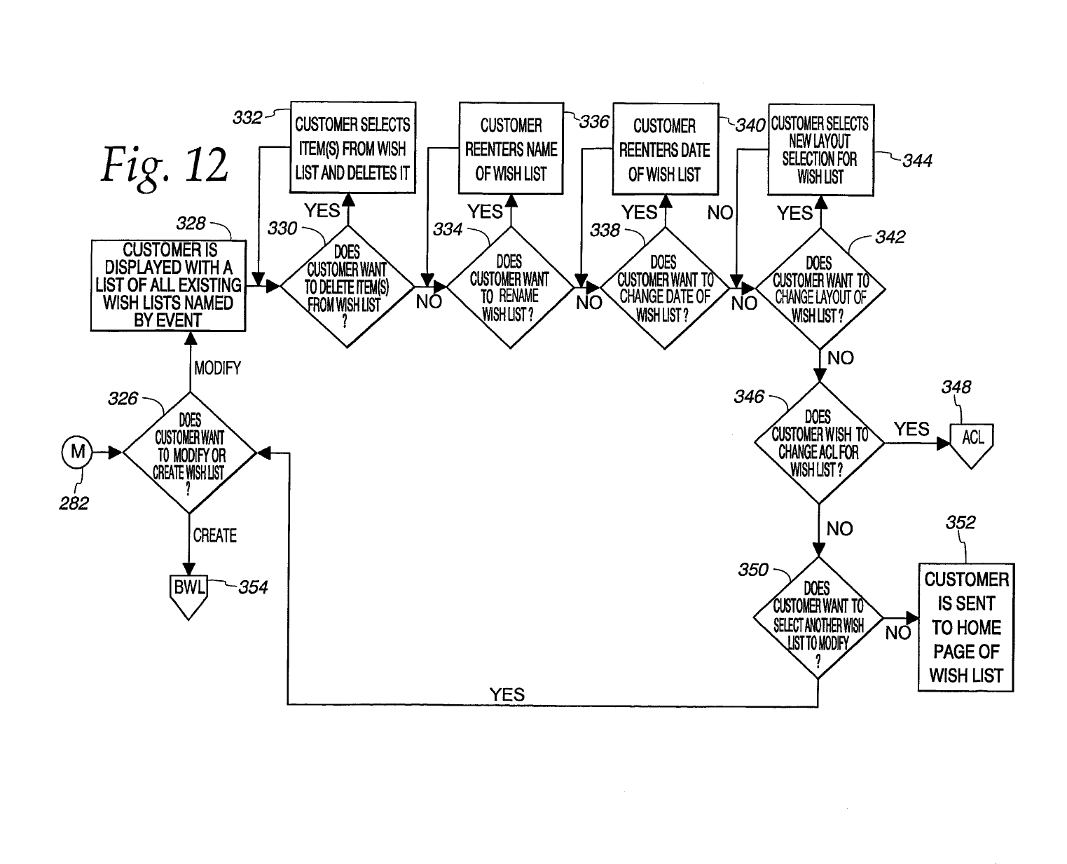

In block 258, the system allows the user to view the selected item(s) by displaying the attributes of the selected item(s) such as the store where the item(s) can be purchased, the name of the product, a description of the product, the size, if necessary, the price, a picture or illustration of the product, the available colors, if appropriate, etc. Next, the system determines whether the user selects one or more of the items being viewed (block 260) by, for example, clicking on the item(s). If no items are selected, the system proceeds to block 264. Otherwise, the system adds the selected item(s) to the user's wish list (block 262). Then, the system determines in block 266 (via, for example, a display prompt) whether the user desires to move the selected item from the user's general wish list (scan list) to a specific wish list (event list), such as the user's birthday or Christmas wish list (event list). If the user does not move the selected item to a specific wish list, the system proceeds to block 264. Otherwise, in block 268, the item is removed from the general wish list (scan list). Then, the user selects a pre-existing wish list (event list) and adds the selected item to that specific wish list (block 270). The system then determines whether the user selects the next item being viewed (block 260). In block 264, the system determines whether the user wants to add more items to his/her general wish list. If not, the system proceeds to block 272 (described below with reference to FIG. 10). Otherwise, the system returns to block 246.

In FIG. 10, the system proceeds from block 272 to block 284 where the user reviews his/her general wish list (scan list) which contains all the items selected while browsing the retailers and e-tailers on-line. All these items are displayed (block 286) whether the items are only on the general wish list (scan list) or whether one or more items were copied to a specific wish list (event list). The system retrieves these items from database 410 and displays product information for each item such as, for example, the product name, store name, product ID code, size, color, price, etc. In block 290, the system allows the user to make the following choices regarding the items on the scan list: add an item to a specific wish list (event list) (block 292), delete an item (block 298), or add an item to a shopping cart for purchase (block 304).

If the user decides to add an item to a specific wish list, the system will prompt the user, in block 294, to select the wish list(s) to which the item should be added. In block 296, the system adds the item to the specific wish list(s) indicated by the user, which are resident on the wish list database 302. If the user decides to delete an item, the system deletes the item from the scan list (general wish list), in block 300, which is resident on the wish list database 302. If the user decides to add one or more items (or all the items on the scan list) to the shopping cart, the system determines whether the item(s) were selected from an e-tailer (block 306). If not, the system proceeds to block 308. Otherwise, the system launches a window displaying the Web page of the e-tailer where the user can purchase the item(s) (block 310).

Referring to FIG. 11, the system proceeds from block 308 to block 312 where the system copies the selected items to database 410 which contains shopping cart data. The system then determines whether the user wishes to remove one or more of these items from the scan list (block 316). If so, the system transfers the data corresponding to those items to the user's personal archive (block 318). Otherwise, the system does not change the scan list (block 322). The system then proceeds to block 320, where the system includes the selected items in the user's shopping cart. In block 324, the user is prompted to enter the quantity of each item to be purchased. The system then proceeds to block 272 (described above with reference to FIG. 10).

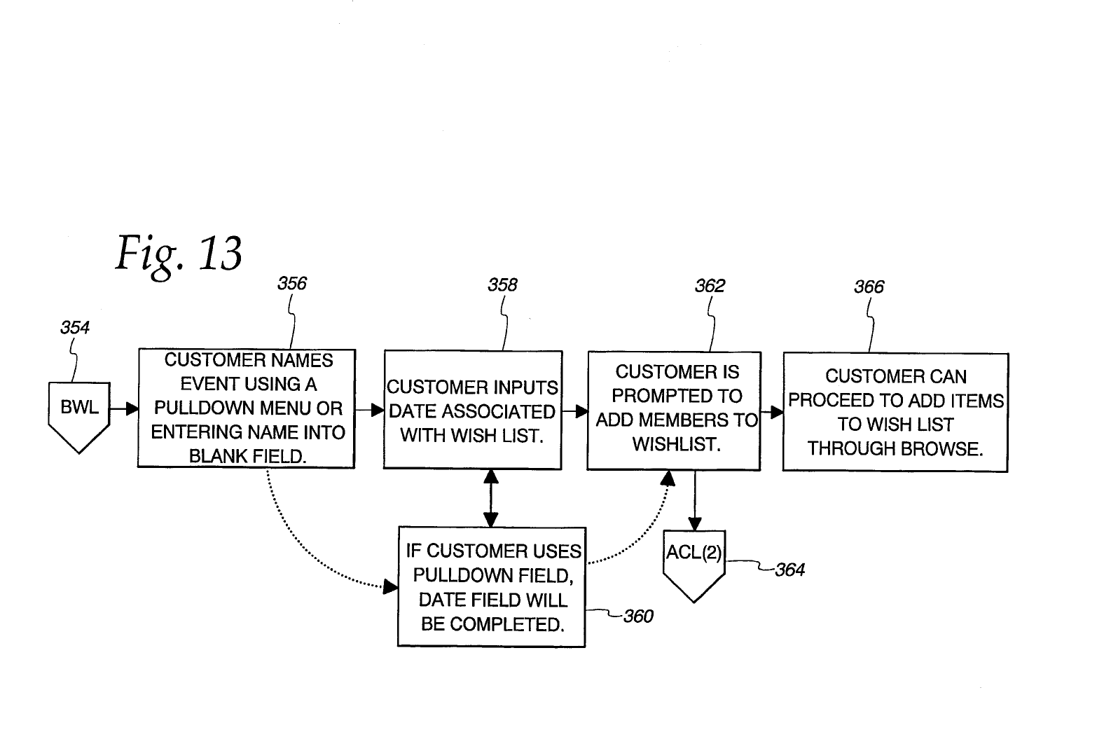

In FIG. 12, the system proceeds from block 282 to block 326 where the system prompts the user to determine whether the user wants to modify or create a specific wish list (event list). To create a wish list, the system proceeds to block 354 (described below with reference to FIG. 13). Otherwise, the system proceeds to block 328 where the system displays a list of all existing wish lists, named by event, e.g., birthday, Christmas, summer vacation. In block 330, the system determines whether the user wants to delete an item(s) from a wish list. If so, the user selects an item(s) from one of the wish lists and deletes it (block 332). Otherwise, the system determines whether the user wants to rename a wish list (block 334). If so, the user re-enters a name for a selected wish list (block 336). Otherwise, the system determines whether the user wants to change the date of a wish list (i.e., change the date of an event) (block 338). For example, the user could change the date of his/her summer vacation wish list if the date of the vacation changed.

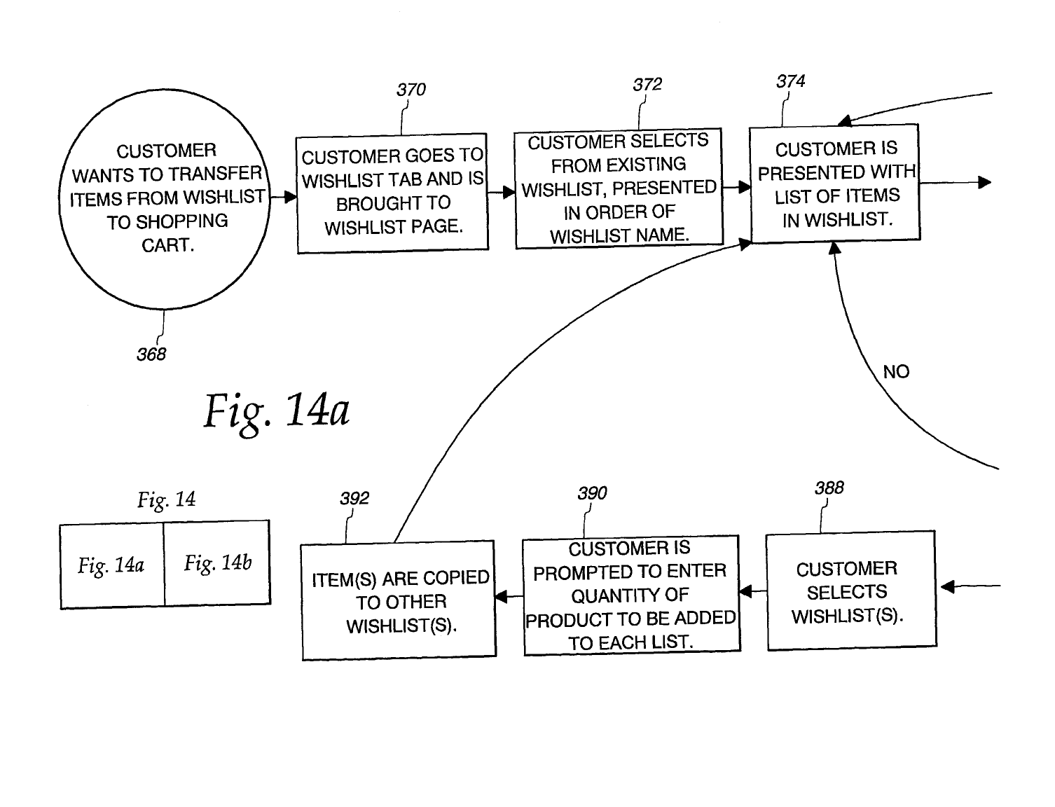

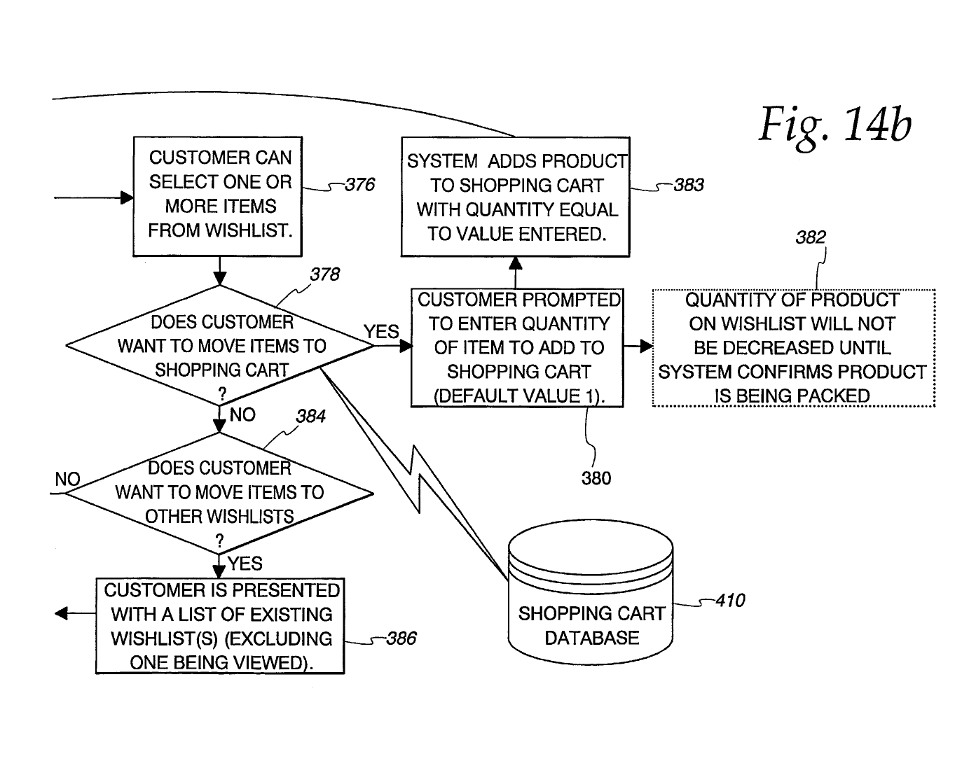

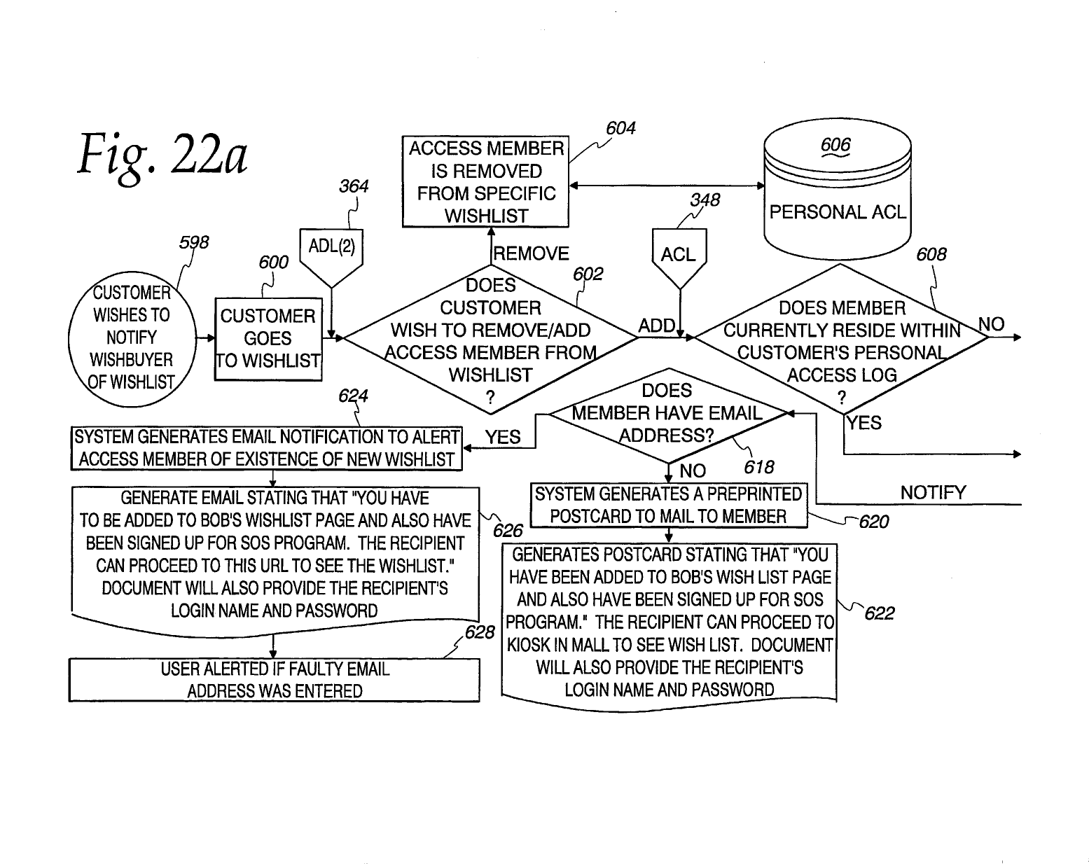

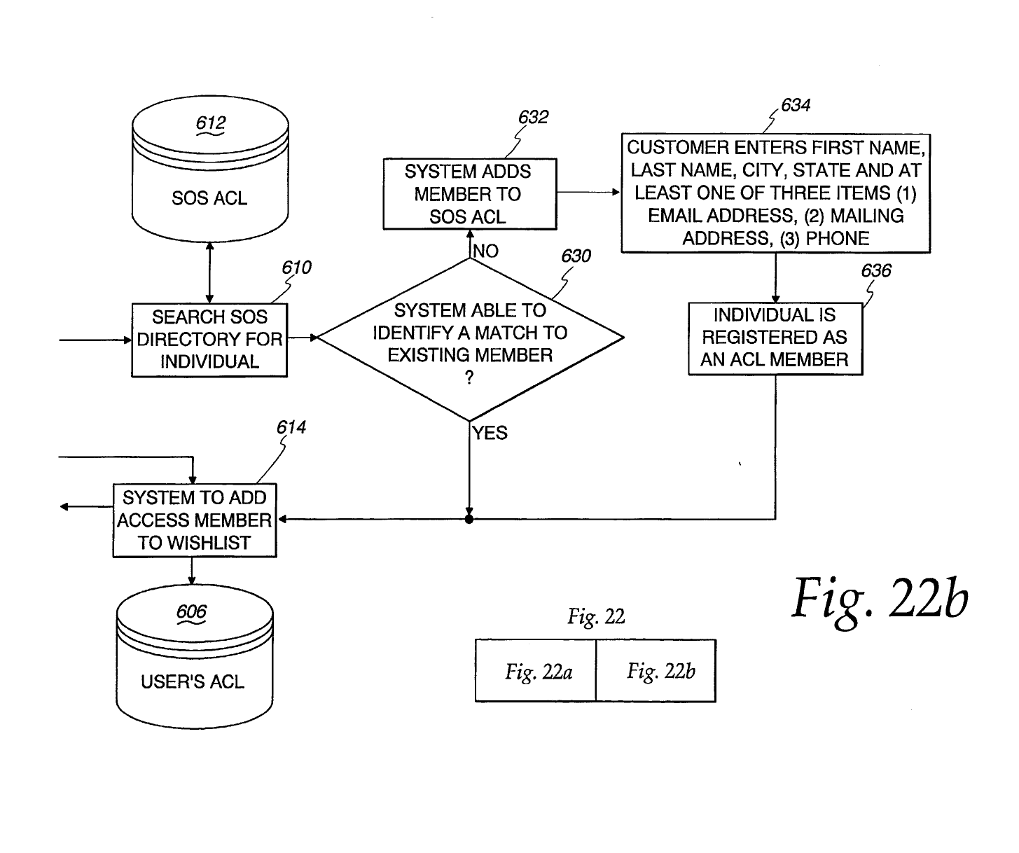

If the date needs to be changed, the system allows the user to re-enter the date of the wish list (block 340). Otherwise, in block 342, the system determines whether the user wants to change the layout of the wish list by, for example, placing more desired items on the top of a wish list. If such a change is desired, the system allows the user to select the new layout for the items in a particular wish list (block 344). Otherwise, the system determines, in block 346, whether the user wants to change the list of authorized buyers for a particular wish list. If so, the system proceeds to block 348 (described below with reference to FIG. 22a). Otherwise, the system determines, in block 350, whether the user wants to select another wish list to modify. If so, the system returns to bock 326. Otherwise, the system proceeds to block 352 where the system sends the user to the wish list home page (described below with reference to FIGS. 14a-b).

Referring to FIG. 13, if the user chose to create a specific wish list, the system proceeds from block 354 to block 356 where the system allows the user to name an event by, for example, using a pull-down menu or entering a name into a field. In block 358, the user inputs the date associated with the particular wish list. However, if pull-down menus are used, the date field will be completed (block 360) and the system proceeds to block 362. There, the user is prompted to add members to the list of authorized buyers for this wish list (block 362). If the user desires to add members to the list of authorized buyers, the system proceeds to block 364 (described below with reference to FIG. 22a). Otherwise, the user can proceed to add items to this wish list by browsing retailers and/or e-tailers (block 366).

In FIGS. 14a-b, the system allows the user to transfer items from a wish list to an electronic shopping cart for purchase (block 368). In one embodiment, the user selects a wish list tab which reveals the wish list home page (block 370). In block 372, the user selects one of his/her existing wish lists which may, for example, be presented in alphabetical order according to the names of the wish lists. In block 374, the system presents the user with a list of items in the selected wish list.

Next, the user can select one or more items listed in the wish list (block 376). The system then determines whether the customer wants to move an item(s) to a shopping cart (block 378) residing on database 410. If so, the user is prompted, in block 380, to enter the quantity of the desired item to add to the shopping cart. In one embodiment, the default quantity is set to one. As indicated in block 382, the system will not remove the item(s) from the wish list or decrease the number of items indicated on the wish list until a certain event has happened such as, for example, the system confirming that the item(s) have been packed. The system then adds the desired number of item(s) to the user's electronic shopping cart (block 383). The system then returns to block 374.

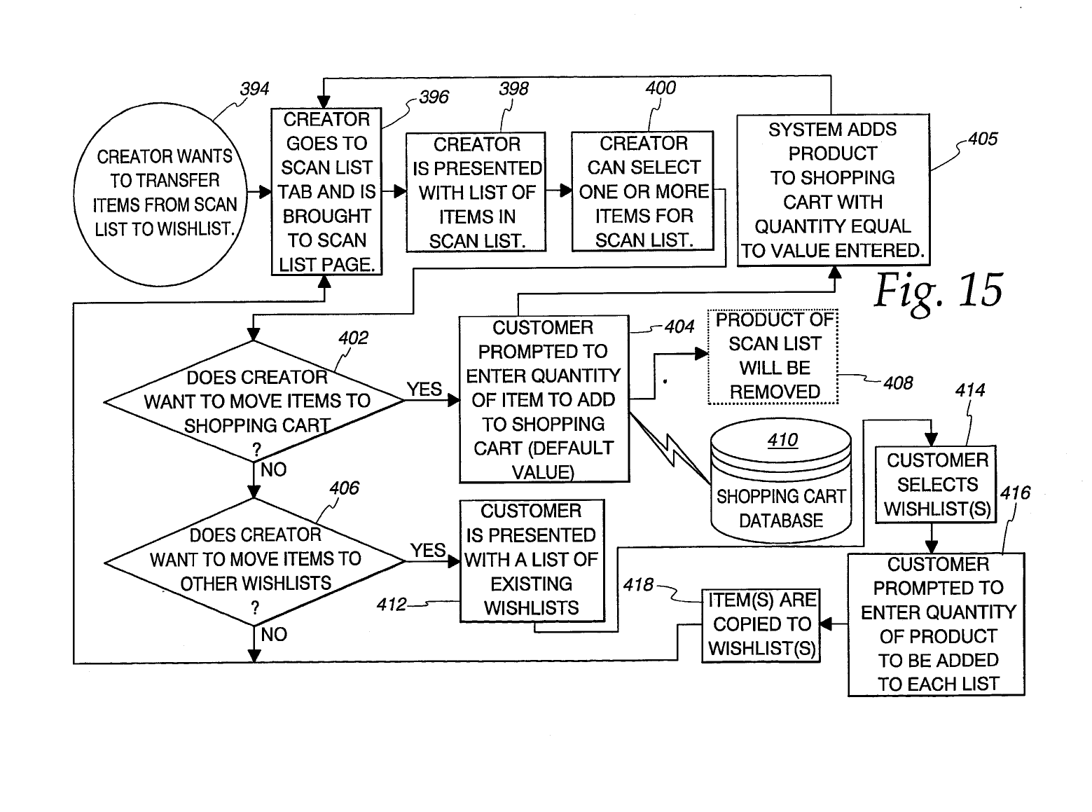

If the customer (in block 378) does not desire to move an item to a shopping cart, the system determines whether the user wants to move an item(s) to one or more different wish lists (block 384). If not, the system returns to block 374; otherwise, the system proceeds to block 386 where the user is presented with a list of existing wish list(s), excluding the current wish list. The system then allows the user to select one of these wish list(s) (block 388). Next, the user is prompted to enter the number of items to be added to each selected wish list (block 390). The item(s) are then copied, in block 392, to the other wish list(s). The system then returns to block 374. 112. In FIG. 15, the system allows the user to transfer items from a scan list (i.e., a general wish list) to a specific wish list (event list) (block 394). In one embodiment, the user goes on-line and selects the scan list option which brings the user to the scan list Web page (block 396). The user is then presented with a list of the items on the user's scan list (block 398). Next, the user selects one or more of the items from the scan list (block 400). The system, in block 402, determines whether the user wants to move the selected item(s) to a shopping cart. If so, the user is prompted, in block 404, to enter the quantity of each item to be added to the shopping cart. As indicated in block 408, the system then removes those item(s) from the scan list. Next, the system adds the desired number of item(s) to the user's shopping cart (i.e., to database 410) (block 405). The system then returns to block 396. If the user indicated, in block 402, that he/she did not want to move the selected item(s) to a shopping cart, the system determines whether the user wants to move one or more items to one or more different wish lists (block 406).

If not, the system returns to block 396. Otherwise, the system presents the user with a list of existing wish lists (block 412). Then, the user selects one or more of the existing wish lists (block 414). The user is then prompted to enter the number of products to be added to the selected wish list(s) (block 416). The item(s) are then copied, in block 418, from the user's scan list to the selected wish list(s). The system then returns to block 396.

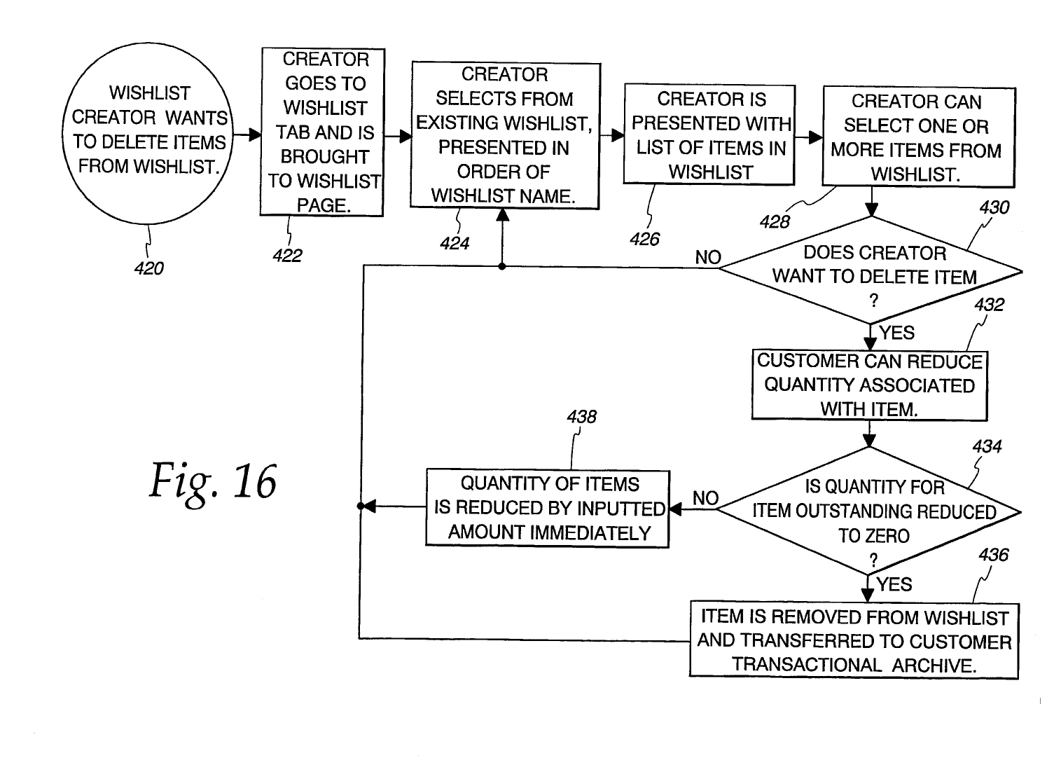

In FIG. 16, the system allows the wish list creator (user) to delete items from a wish list (block 420). In one embodiment, the user goes on-line and selects the wish list option (e.g., a tab) which brings the user to the wish list Web page (block 422). The user then selects an existing wish list (block 424). The wish lists may, for example, be presented in alphabetical order according to the names of the wish lists. The user is then presented with a list of one or more items from the selected wish list (block 426). In block 428, the user selects one or more of the items from the selected with list.

The system, in block 430, determines whether the user wants to delete the selected item(s) from the wish list. If not, the system returns to block 424. If so, the user is prompted, in block 432, to reduce the quantity associated with an item. In block 434, the system determines whether the user reduced the quantity to zero. If so, the item is removed from the wish list and transferred to the customer transactional archive (block 436). Otherwise, the quantity for the selected item is reduced to the amount indicated by the user (block 438). After either block, the system returns to block 424.

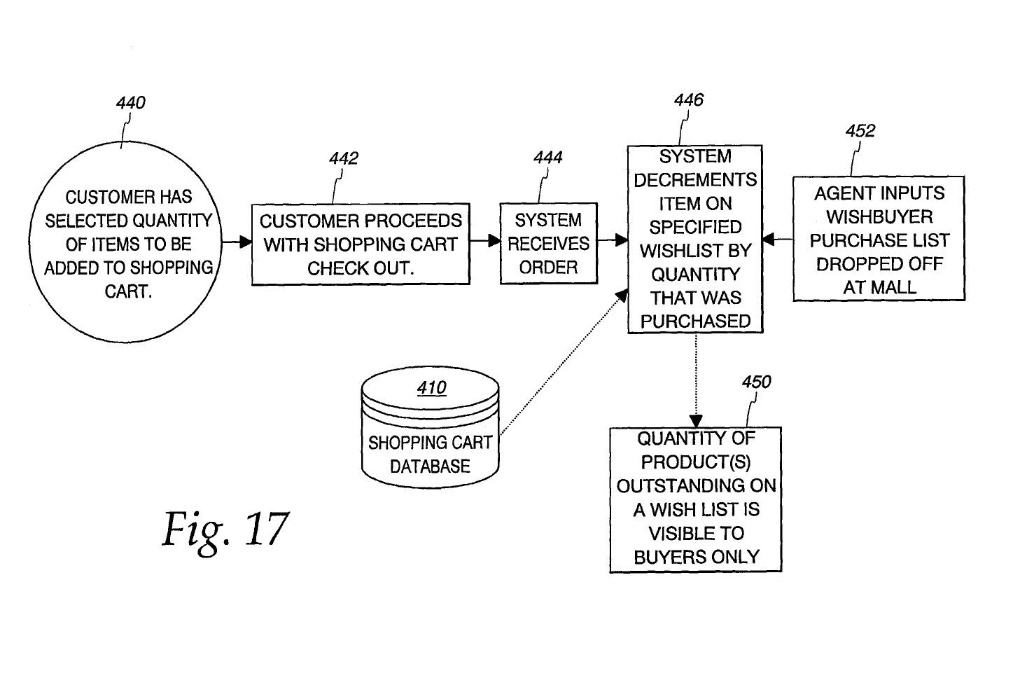

FIG. 17 describes what happens when a user selects a certain number of items from his/her wish list to be added to the user's shopping cart (block 440). In one embodiment, the user, in block 442, checks-out on-line (i.e., proceeds to purchase the items in the user's electronic shopping cart) by, for example, clicking an icon representing a shopping cart. The system then receives the order (block 444). In block 446, the system decrements the number of items from the selected wish list by the quantity purchased by the user and updates database 410. In one embodiment, the number of items outstanding on a wish list is visible only to the person buying the item (block 450). Therefore, in this embodiment, the number of outstanding items is only visible to the user). If the user printed out a particular wish list and dropped it off at a participating store or mall, a kiosk agent will input the number of items to be purchased from that wish list (block 452). The system then returns to block 446.

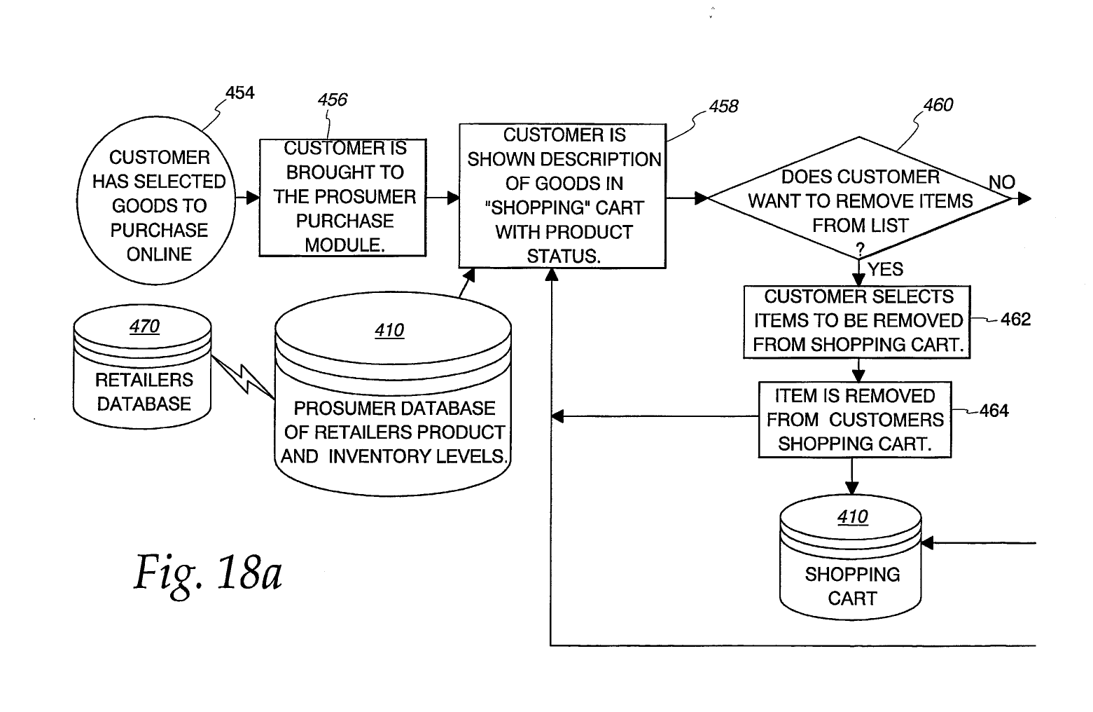

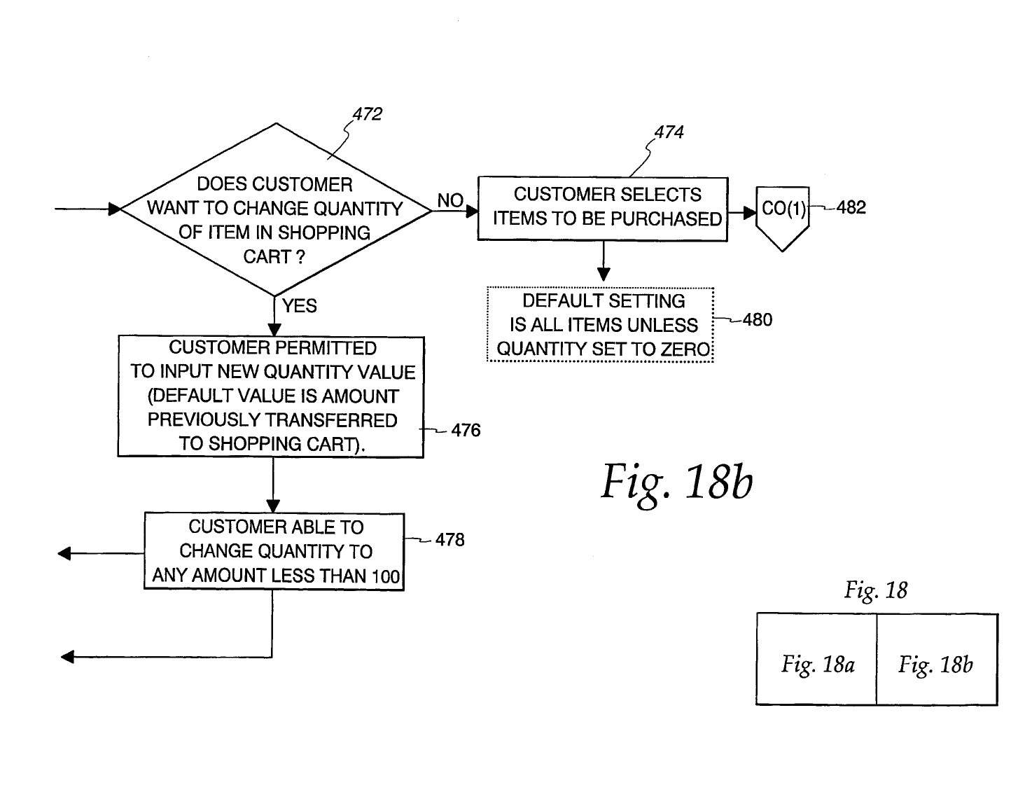

FIGS. 18a-b describe what happens when the user has selected items to purchase on-line and desires to review his/her shopping cart (block 454). In block 456, the system displays the prosumer purchase module. The system then displays for the user a description of the items in the user's electronic shopping cart along with the status of the items (e.g., available, sold out, backordered) (block 458). The status of the items is retrieved from database 410 which includes the inventory levels for each of the retail items available to the user. In one embodiment, the database 410 is linked to each retailer's database (represented by database 470) so that current inventory levels can be determined. The inventory levels can be updated in real-time, hourly, daily, etc. The system next determines whether the user wants to remove one or more items from the list of items in the shopping cart (block 460). If so, the system proceeds to block 462 where the customer selects the item(s) to be removed from the shopping cart. Then, the item(s) are removed from the shopping cart (block 464) and database 410 is updated. The system then returns to block 458.

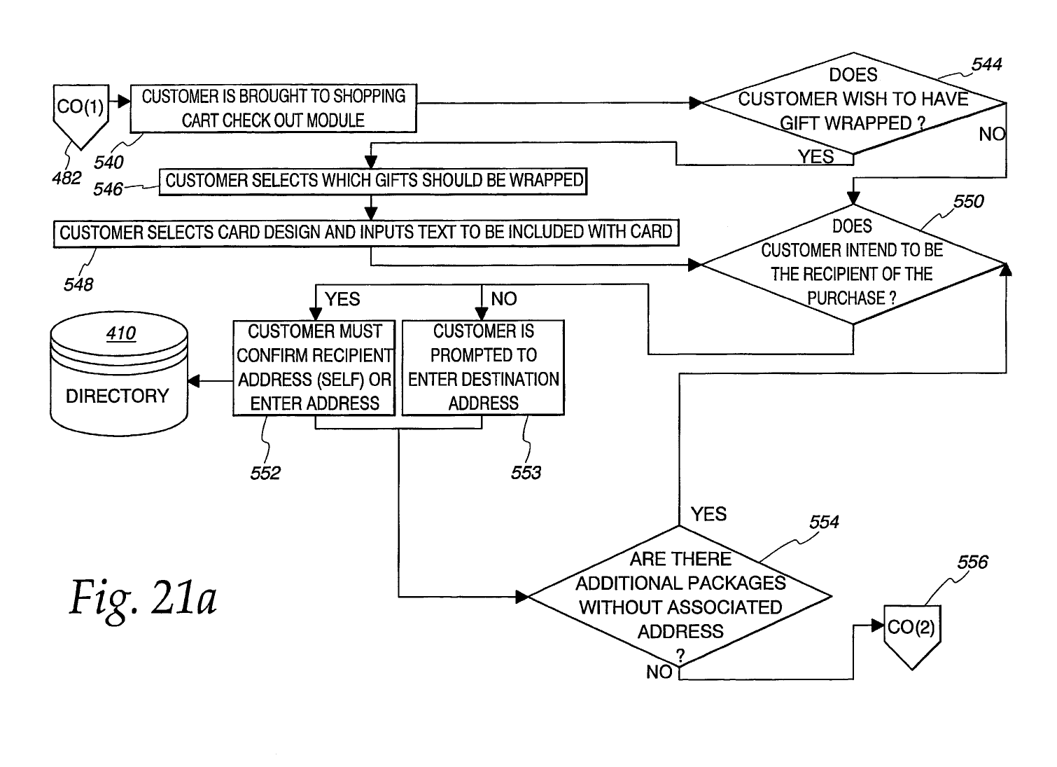

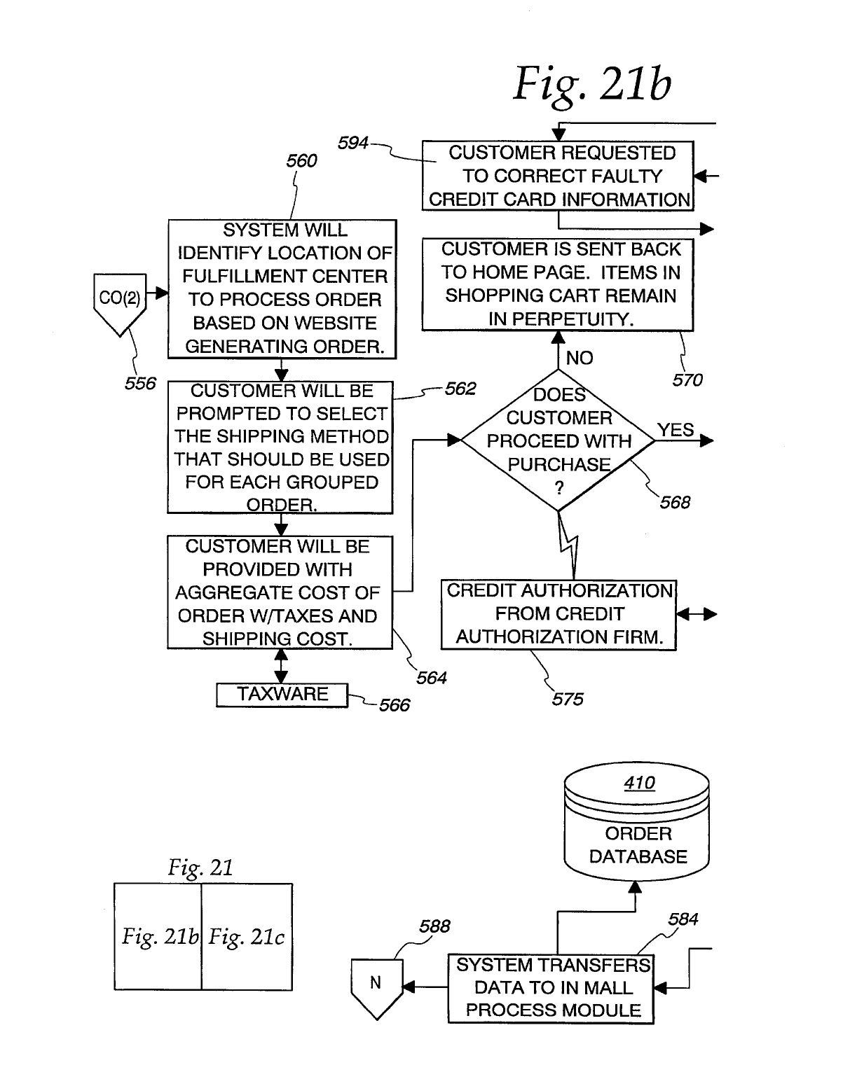

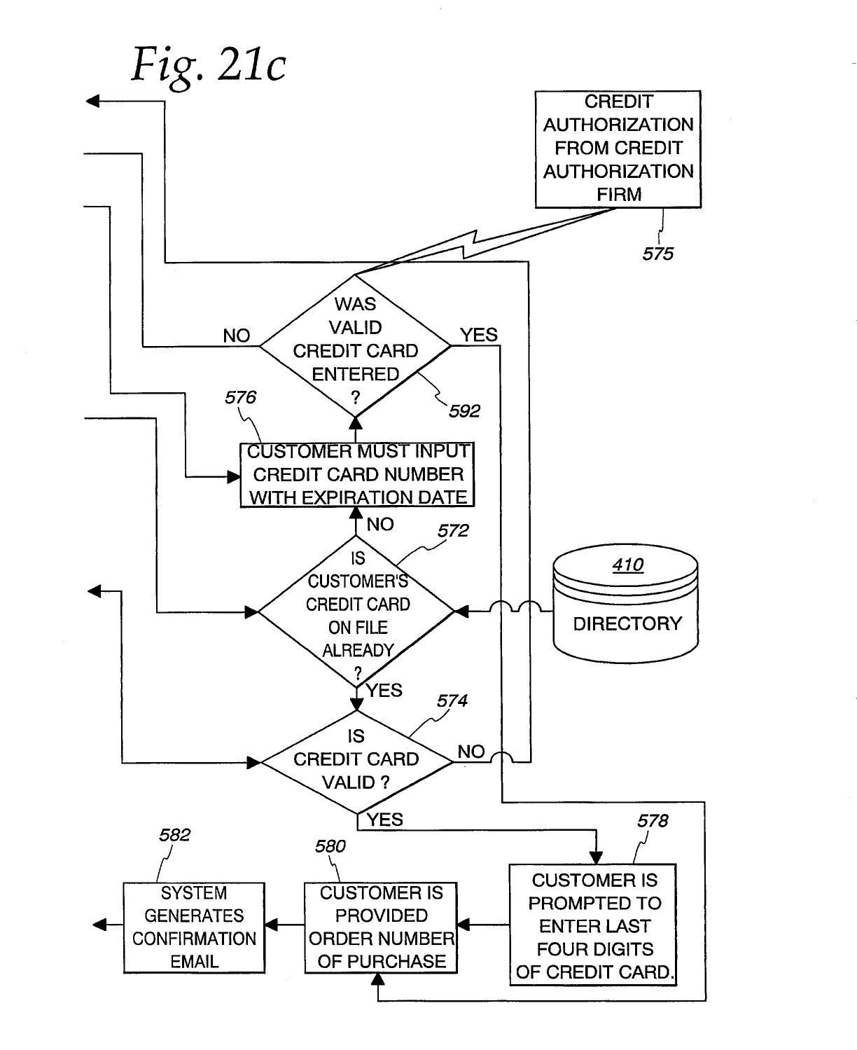

If in block 460 the user chose not to remove any items from the shopping cart, the system proceeds to block 472 where the system determines whether the user wants to change the quantity of any of the items in the shopping cart. If not, the customer selects the items to be purchased (block 474). In one embodiment, the system assumes the user wants to purchase all of the items in the shopping cart, unless the quantity of an item is zero (block 480). The system then proceeds to block 482 (described below with reference to FIG. 21a).

If the system determines, in block 472, that the user wants to change the quantity of any of the items in the shopping cart, the system proceeds to block 476 where the user is permitted to enter a new quantity for one or more of the selected items (in this embodiment, the system default is the quantity transferred to the shopping cart). The user is allowed to change the quantity to, for example, any value less than 100 (block 478), i.e., the quantity field allows only two digits to be entered. Changing the quantity updates database 410 and returns the system to bock 458.

FIGS. 19a-b describe what happens when the user adds an item to a wish list from an e-tailer Web site (block 256). The user, in block 486, selects an e-tailer icon by, for example, clicking on an appropriate icon. In one embodiment, this launches a second instance of the user's Web browser and points the browser to the URL of the selected e-tailer. The user then browses through an on-line catalog at the e-tailer's Web site (block 488). The user identifies the items to be added to a wish list (block 490) by, for example, selecting one or more of the items by clicking thereon or typing the name of one of the items in a text box provided by the first instance of the user's Web browser. In the latter embodiment, the user switches from the second browser window showing the e-tailer's Web site to the first browser window showing the system's Web site (e.g., fastfrog.com) (block 492). The system then proceeds to block 494 where the user inputs the name of the desired item into the text box and selects the e-tailer where the item can be purchased by, for example, using a pull down menu of e-tailers.

To allow the system to easily return to the e-tailer Web page where the selected item(s) are located, the system, in one embodiment, creates an addition to the user's selected wish list in HTML (block 496) by appending the name of the desired item to the URL of the e-tailer. For example, if the user added a beanie baby to his/her wish list from etoys.com, the HTML code would be modified to read:

<A HREF=HTTP://www.etoys.com>beanie_baby</A>

In block 498, the system determines whether the selected item(s) are the first item(s) from this e-tailer that are associated with the selected wish list. If these items are not the first item(s) from this e-tailer, the system proceeds to block 500 where the relationship between the e-tailer and the selected wish list is already established. This means that (1) user identification and the type of wish list event are already appended to the URL of the system's Web site (e.g., http://www.fastfrog.com/wishlist.ixw?user_id=1&wishlist=birthday) and (2) the street address of the user is already known to the system. From block 500, the system proceeds to block 506 where the relationship information (in the form of a URL) is saved as the unique name for this transaction for later use by the system (for example, the information can be used to easily return to this Web page, for reconciliation purposes at periodic intervals, etc.).

If the selected item(s) are the first item(s) selected from this e-tailer, the system proceeds from block 498 to block 502 where the system interfaces with the e-tailer and creates a relationship between the user, the wish list and the e-tailer. The system creates an e-tailer relationship for this wish list, in block 504, by appending user identification and the type of wish list event to the URL of the system (e.g., http://www.fastfrog.com/wishlist.ixw?user id=1&wishlist=birthday) and saving the street address of the user. The system then proceeds to block 506.

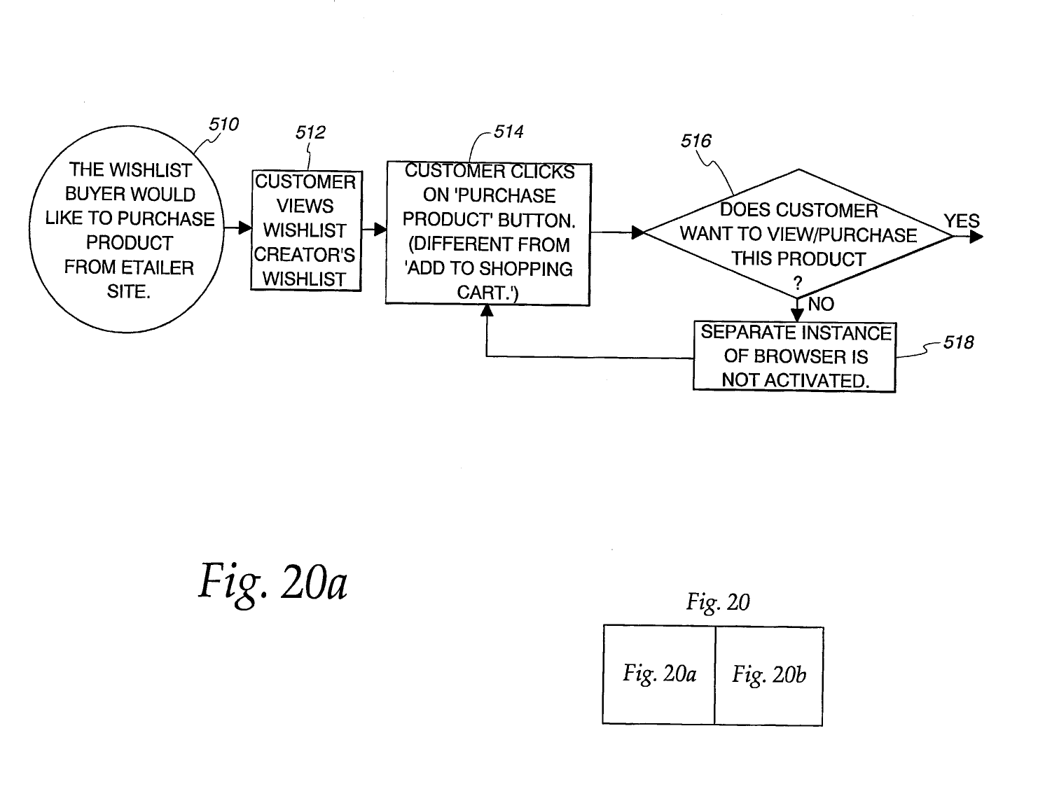

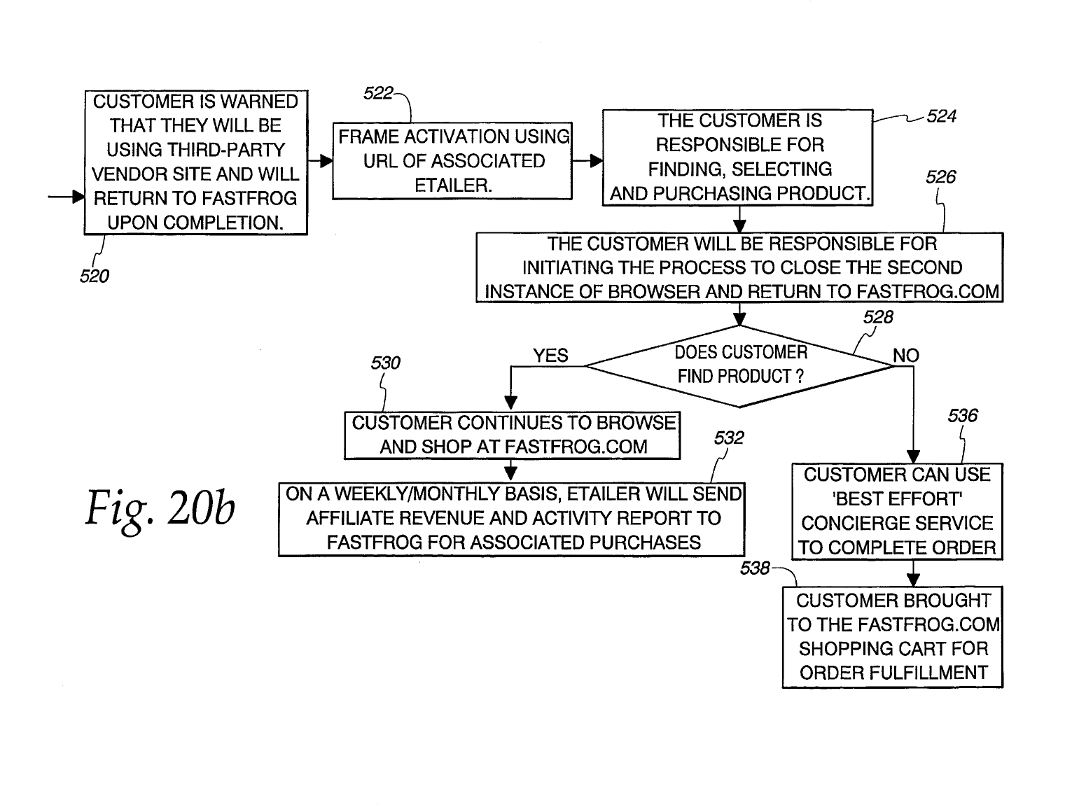

FIGS. 20a-b describe what happens when a buyer wishes to buy an item from an e-tailer Web site (block 510). The buyer, in block 512, views a wish list created by one of the users. The buyer then selects one or more of the item(s) on the wish list. In one embodiment, the buyer then selects a “purchase product” icon by, for example, clicking thereon (block 514). This is different than selecting the “shopping cart” icon discussed above with reference to FIG. 17. In block 516, the system determines whether the buyer wants to view and/or purchase the selected product(s). If not, a second instance of the buyer's browser is not launched (block 518) and the system returns to block 514. Otherwise, the buyer is warned that he/she will be using a third-party's Web site to purchase the selected item(s) and will return to the system's Web site (e.g., fastfrog.com) upon completion of the purchase (block 520). In block 522, the system launches a second instance of the buyer's Web browser thus producing a second window displaying the Web site associated with the URL of the e-tailer where the selected product(s) may be purchased. In one embodiment, the buyer is responsible for finding, selecting and purchasing the selected product(s) (block 524). In another embodiment, the system automatically links the buyer to a Web page containing the selected product. After the buyer purchases the selected product(s), the buyer is responsible for closing the second instance of the Web browser and returning to the system's Web site (e.g., fastfrog.com) (block 526).

In block 528, the system determines whether the buyer found the selected product(s). If so, the buyer continues to browse and shop at the system's Web site (block 530). In one embodiment, the e-tailer will periodically send affiliate revenue and activity reports to the originating Web site (e.g., fastfrog.com) so that, for example, the success of the affiliate program can be assessed (block 532).

If the buyer did not find one or more of the selected item(s), the buyer can use a concierge service to complete the e-tailer order (block 536) by, for example, clicking on an appropriate icon displayed on the system's Web site. The system then displays the user's shopping cart list which is sent to the concierge service so that the user's order can be fulfilled (block 538).

Referring to FIG. 21a, the system proceeds from block 482 (the buyer has selected items to purchase by including certain items in his/her shopping cart) to 540 where the system displays the shopping cart check-out module. The system determines whether the buyer wishes to gift wrap one or more of the items in the shopping cart (block 544). If not, the system proceeds to block 550. Otherwise, in block 546, the buyer selects which item(s) should be wrapped. Next, the buyer selects a card design and inputs the text to be included therein (block 548). In block 550, the system determines whether the buyer intends to be the recipient of the purchase. If so, the buyer must confirm his/her address or enter his/her address (block 552). If not, the buyer is prompted to enter the address of the recipient (block 553). The address information is stored to database 410. In block 554, the system determines whether there are any additional items in the shopping cart that do not have a shipping address associated with them. If there are items without a shipping address, the system returns to block 550. Otherwise, the system proceeds to block 556.

Referring to FIGS. 21b-c, the system proceeds from block 556 to 560 where the system will identify the location of the system's fulfillment center where the order will be processed based on the e-tailer Web site that generated the order. In block 562, the buyer will be prompted to select the shipping method to be used for each group of one or more items to be shipped. The system then provides the buyer with the total cost, including shipping and taxes (block 564). The tax information for the order is generated from a separate tax software program (block 566). In block 568, the system determines whether the buyer wants to proceed with the purchase. If not, in block 570, the buyer is sent back to the home page of the system's Web site (the items in the buyer's shopping cart remain there in perpetuity or until deleted by the system).

Otherwise, the system determines, in block 572 (FIG. 21c), whether the buyer's credit card is already on file by checking database 410 which contains directory data. If not, the system proceeds to block 576. If the credit card is on file, the system determines whether the credit card is valid (block 574) by, for example, obtaining a credit authorization from a credit authorization firm (block 575). If the card on file is valid, the system proceeds to block 578 where the buyer is prompted to enter the last four digits of the credit card.

If the card on file is not valid, the buyer is requested to re-enter his/her credit card information (block 594). In block 576, the buyer inputs his/her credit card number and expiration date. The system next determines whether the entered credit card number is valid (block 592) by, for example, obtaining a credit authorization from a credit authorization firm (block 575). If the number is not valid, the system returns to block 594; otherwise, the system proceeds to block 580. In block 580, the system provides the buyer with an order number for the purchase. The system generates an e-mail confirming the order in block 582. The system, in block 584, transfers data to the in-store/in-mall process module by downloading order data to database 410. The system then proceeds to block 588 and the system is finished.

FIGS. 22a-b describe what happens when a user wishes to create an access mechanism, such as an ACL, that allows specified buyers to be notify about, and have access to, one or more of the user's wish lists (block 598). The user, in block 600, views a previously created wish list. The system proceeds from block 600 (or block 364) to block 602, where the system determines whether the user wishes to remove or add a wish list buyer to, for example, the user's access control list (ACL). If the user wishes to remove a buyer, the system removes the selected buyer from the ACL corresponding to the wish list selected by the user so that the removed buyer cannot access the selected wish list (block 604). The system then updates the user's personal list of ACL members, which resides on the user's ACL database 606. If the user wishes to add a buyer, the system proceeds from block 602 (or block 348) to block 608 where the system determines whether the buyer entered by the user is a member residing within the user's ACL. If not, the system searches the shopping operating system (SOS) member directory, residing on the SOS ACL database 612, for the entered buyer (block 610).

In block 630, the system determines whether there was a match to an existing SOS member. If not, the system must add the buyer to the SOS ACL (block 632). In one embodiment, the user enters the buyer's fill name, city and state, and either (1) the buyer's e-mail address, (2) street address, or (3) telephone number (block 634). The entered buyer is then registered as an SOS ACL member (block 636).

If there was a match to an existing member in block 630 or once the new buyer is registered in block 636, the system, in block 614, adds the registered member to the user's ACL for the selected wish list, which resides on database 606. The system next determines whether the buyer has an e-mail address registered with the system (block 618). If not, the system, for example, generates a preprinted post card to mail to the buyer (block 620). The generated post card notifies the recipient that he/she has been granted access to the user's on-line wish list and has been signed up as a registered member of the SOS program (block 622). The post card further includes the buyer's user name and password. The buyer can then proceed to a participating store or mall to view the wish list at an in-store/in-mall kiosk or logon to the SOS Web site and view the wish list on-line.

If, in block 618, the system determines that the buyer has an e-mail address registered with the system, the system generates an e-mail notification to alert the buyer that he/she has been granted access to the user's on-line wish list and has been signed up as a registered member of the SOS program (block 624). The e-mail further includes, for example, the buyer's user name and password, wish list password (if appropriate), and a hyperlink to the SOS Web page where the buyer can view the wish list on-line (block 626). In block 628, the system alters the user if the buyer's entered e-mail address is invalid.

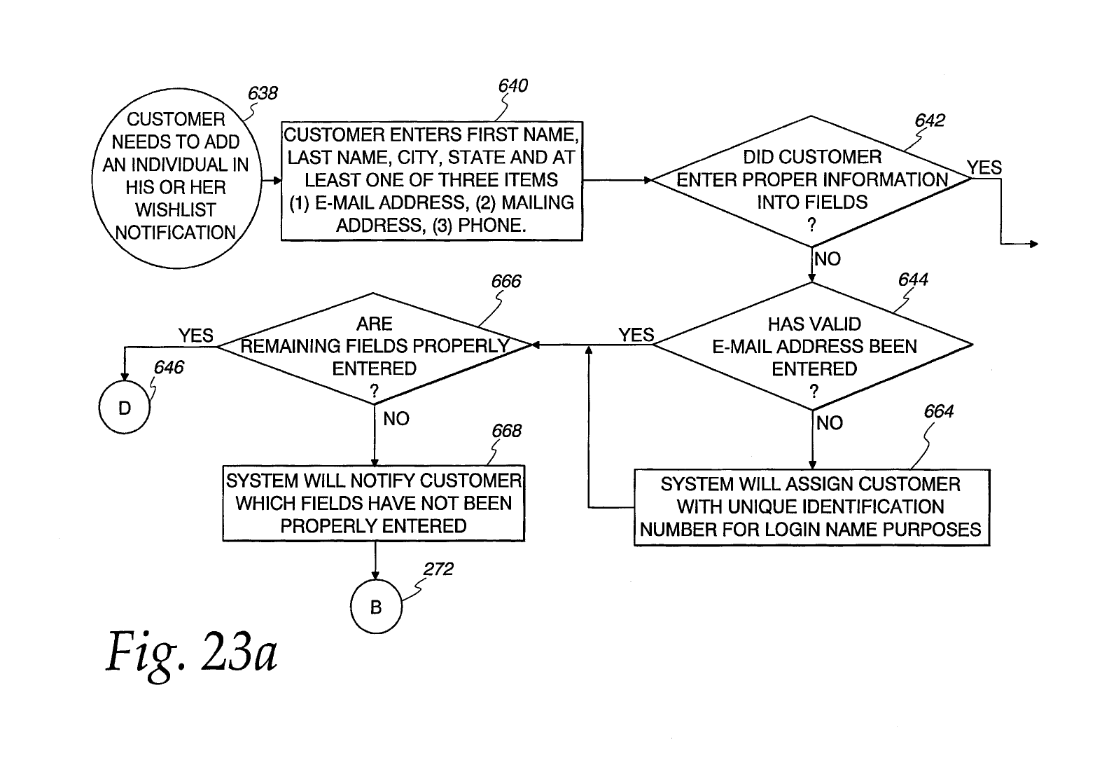

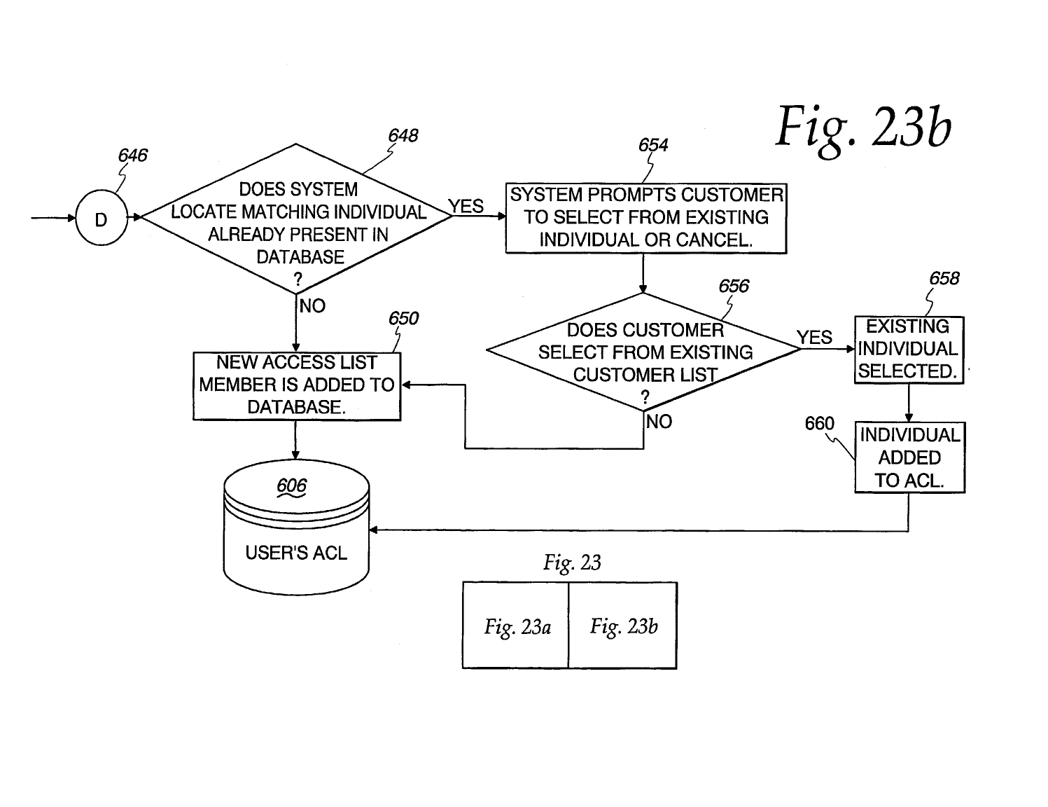

FIGS. 23a-b describe what happens when a user wishes to add a buyer to his/her access mechanism (e.g., an ACL) (block 638). The user, in block 640, enters, for example, the buyer's full name, city and state, and either (1) the buyer's e-mail address, (2) street address, or (3) telephone number. The system then determines whether the user entered the proper information into the supplied fields (block 642). If not, the system determines whether a valid e-mail address has been entered (block 644). Otherwise, the system proceeds to point D (block 646, described below with reference to FIG. 23b).

If a valid e-mail address was not entered, the system will assign the buyer a unique identification number which can be used as the buyer's user name for login purposes (block 664). The system then proceeds to block 666. If a valid e-mail address was entered in block 644 or after block 664, the system proceeds to block 666 where the system determines whether the remaining fields contain valid information. If not, the system notifies the user which fields were improperly entered (block 668) and the system proceeds to block 272 (described above with reference to FIG. 10). Otherwise, the system proceeds to point D (block 646).

From block 646, the system proceeds to block 648 where the system determines whether the entered buyer information matches a buyer already present in the SOS ACL database 612. If not, the new buyer information is added, in block 650, to database 606 which contains the user's ACL. Otherwise, the system prompts the user to select from a list of existing buyers on the SOS ACL or cancel and return to the home page of the SOS (block 654).

In block 656, the system determines whether the user selected a buyer from the SOS ACL. If not, the system proceeds to block 650; otherwise, if an existing buyer is selected (block 658), that buyer is added to the user's individual ACL (block 660). In one embodiment, the user's individual ACL is linked via an index or table to the SOS ACL.

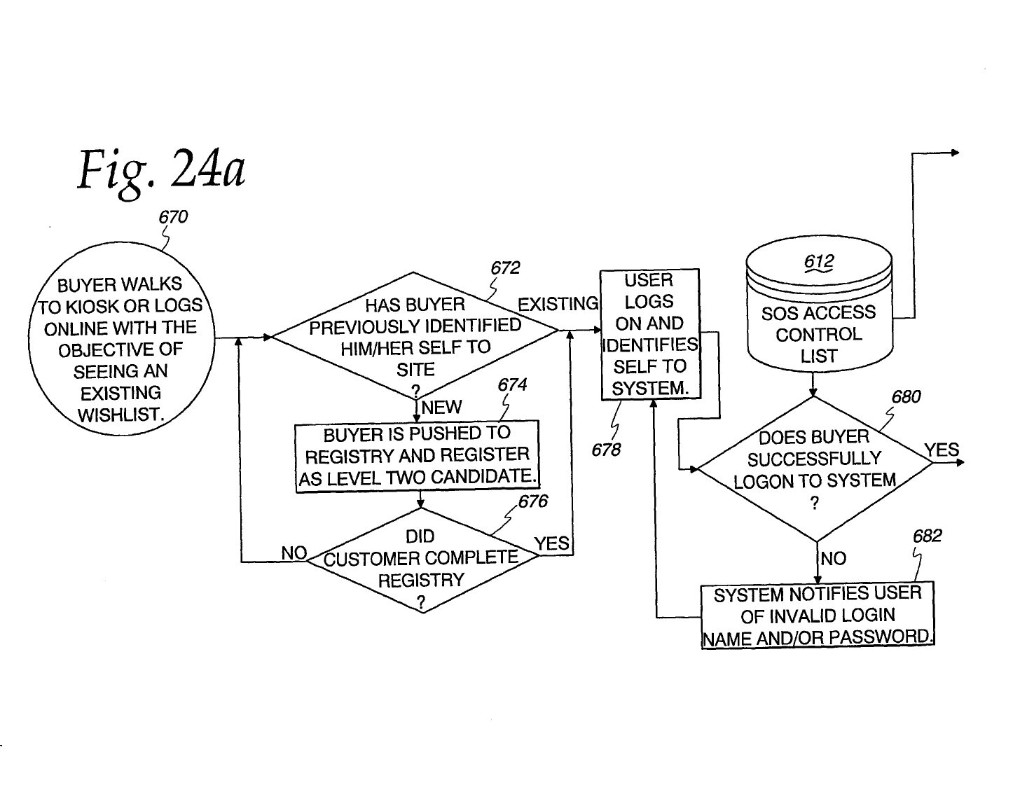

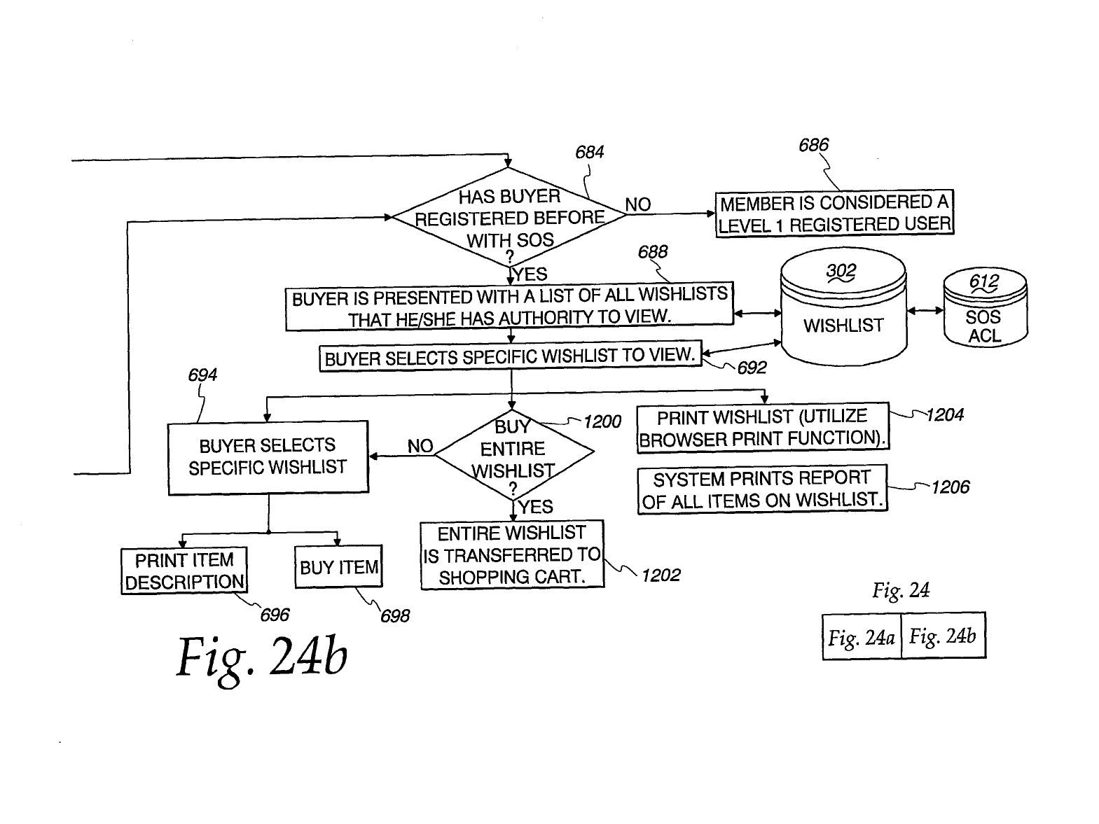

FIG. 24 describes what happens when a buyer wishes to view a wish list at a store/mall or on-line (block 670). The system, in block 672, determines whether the buyer is an existing or new buyer. If the buyer is new, the system prompts the buyer to register with the system as a Level 2 user (block 674). Then, the system determines whether the buyer completed the registration information (block 676). If so, the system proceeds to block 678. Otherwise, the system returns to block 672. In block 678, the buyer logs into the system by entering a user name and password (block 678). The buyer may have previously registered with the SOS or a user may have added the name of this buyer to the user's list of buyers who are authorized to access a particular wish list. The system then determines whether the buyer successfully logged into the system (block 680) by comparing the entered user name to the SOS ACL which resides in database 612. If the login was unsuccessful, the system notifies the buyer that he/she entered an invalid user name and/or password (block 682). Otherwise, the system determines whether the buyer has already registered with the SOS (block 684). If not, the buyer is considered a Level 1 registered user (block 686). Otherwise, the buyer is presented with a list of all wish lists that he/she is authorized to view (block 688). The list of authorized buyers and the corresponding wish lists reside in the SOS ACL database 612 and the wish list database 302, respectively. The buyer then selects a specific wish list to view (block 692).

At this point the buyer has various options. As a first alternative, the buyer may select a specific item in the selected wish list (block 694). Then, the buyer can print a description of the item (block 696) and/or buy the selected item (block 698). As a second alternative, the buyer can choose to buy all the items on the selected wish list (block 1200). If the buyer decides to do this, the entire wish list is added to the buyer's shopping cart (block 1202). Otherwise, the system proceeds to block 694. As a third alternative, the buyer can print the wish list via the print option on the user's Web browser (block 1204). In block 1206, the system prints a report including all the items on the wish list.

With respect to the in-store/in-mall PDA shopping component of the system 10, FIGS. 25-32 show detailed flow charts illustrating one embodiment of how a shopper uses a PDA scanner in a physical store or mall 12. FIG. 25 shows one embodiment illustrating how a wish list creator (user) 120, an aggregated shopper 160 and/or a wish list buyer 140 interact with the illustrated in-store/in-mall experience 896 in order to, for example, shop with a PDA scanner (block 898); buy items through an aggregated shopper (block 900); and buy items from a wish list (block 902). Similarly, the user 120, aggregated shopper 160 and/or buyer 140 interact with the illustrated kiosk 888 to pick-up a PDA scanner (block 894); and return the PDA scanner (block 892).

Likewise, the user 120, aggregated shopper 160 and/or buyer 140 interact with the illustrated PDA workstation 882 to upload data from the PDA scanner (block 884); and download data to the PDA scanner (block 886). In addition, the user 120, aggregated shopper 160 and/or buyer 140 interact with the illustrated prosumer 152 (a platform where common functionalities, such as the wish list, and buyer and user profiles, reside) to enter user information to generate a scan list (block 878); and enter buyer information to obtain a wish list (block 880). The PDA agent 890 interacts with the prosumer, PDA workstation and kiosk to help users and buyers register with the system, create and obtain wish lists, and shop using PDA scanners.

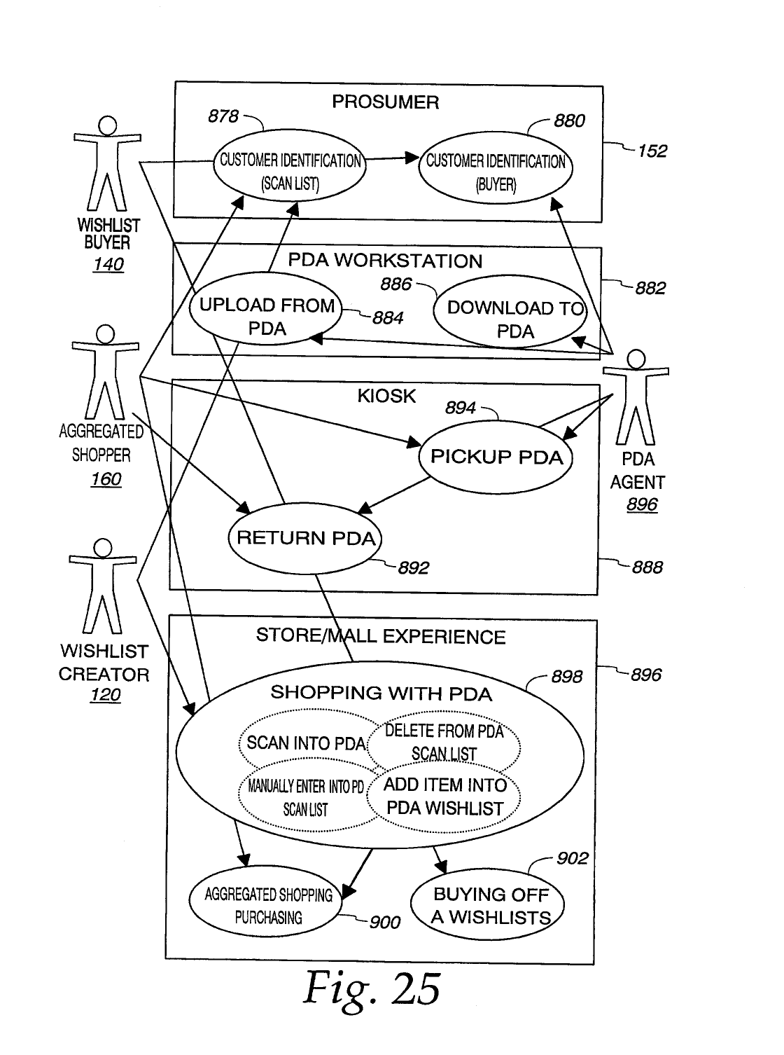

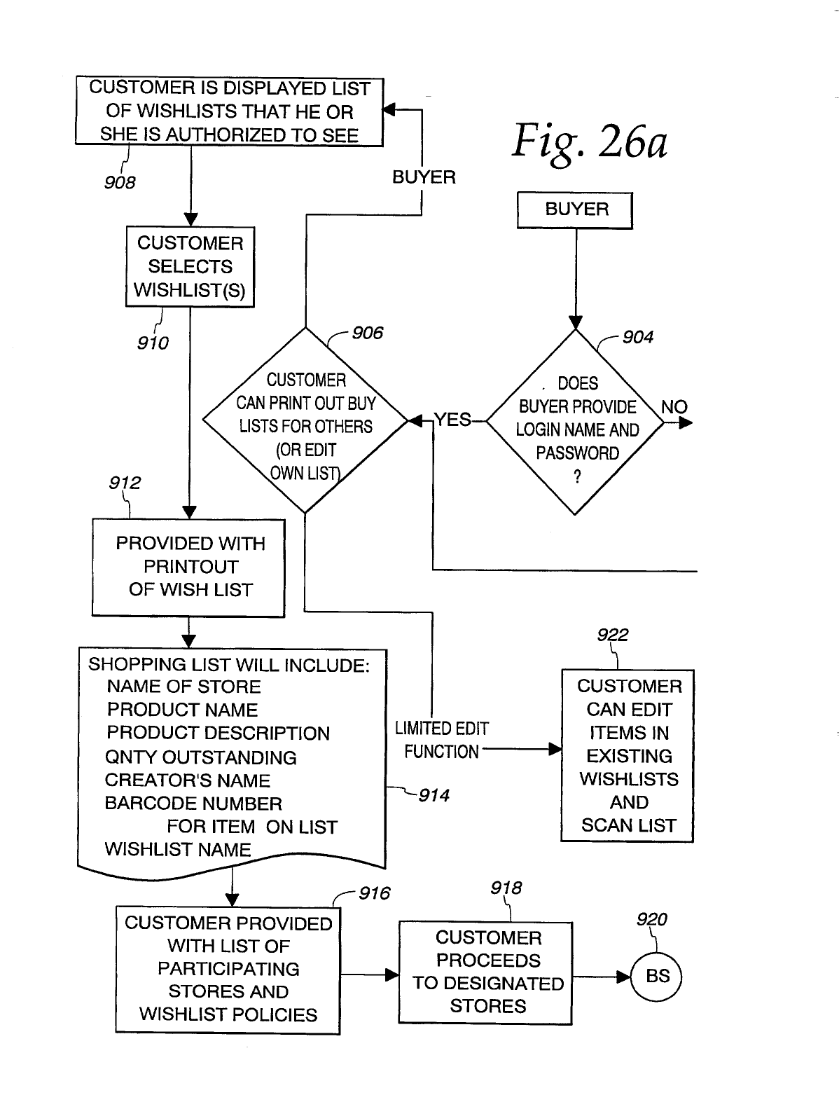

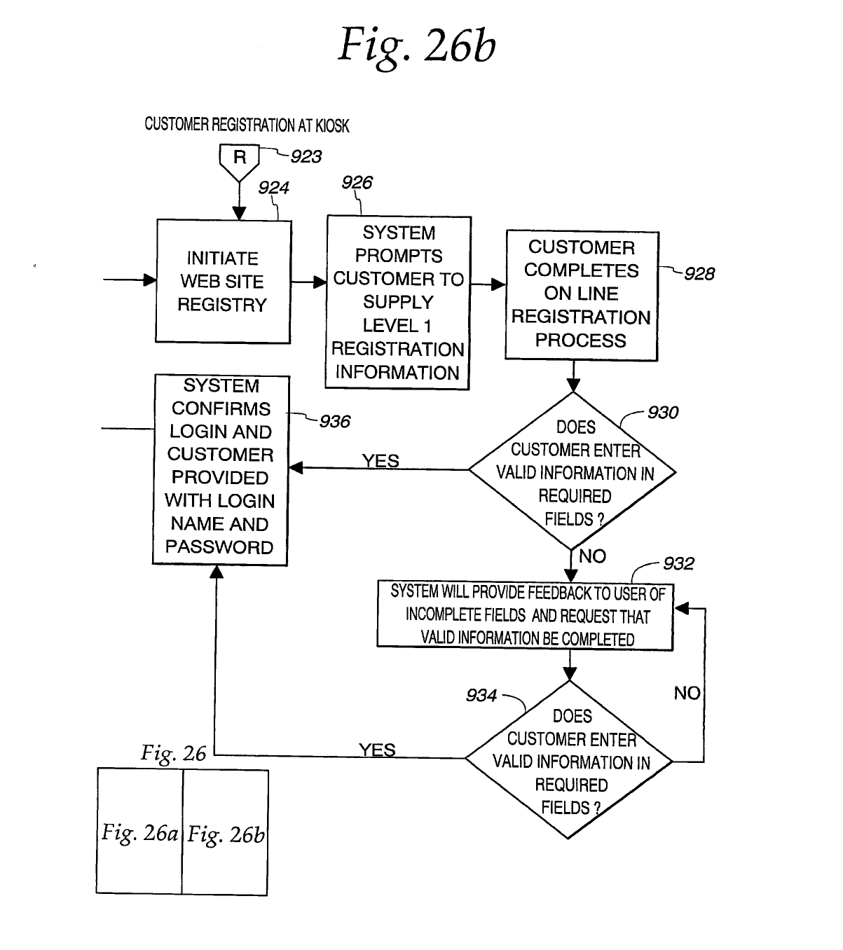

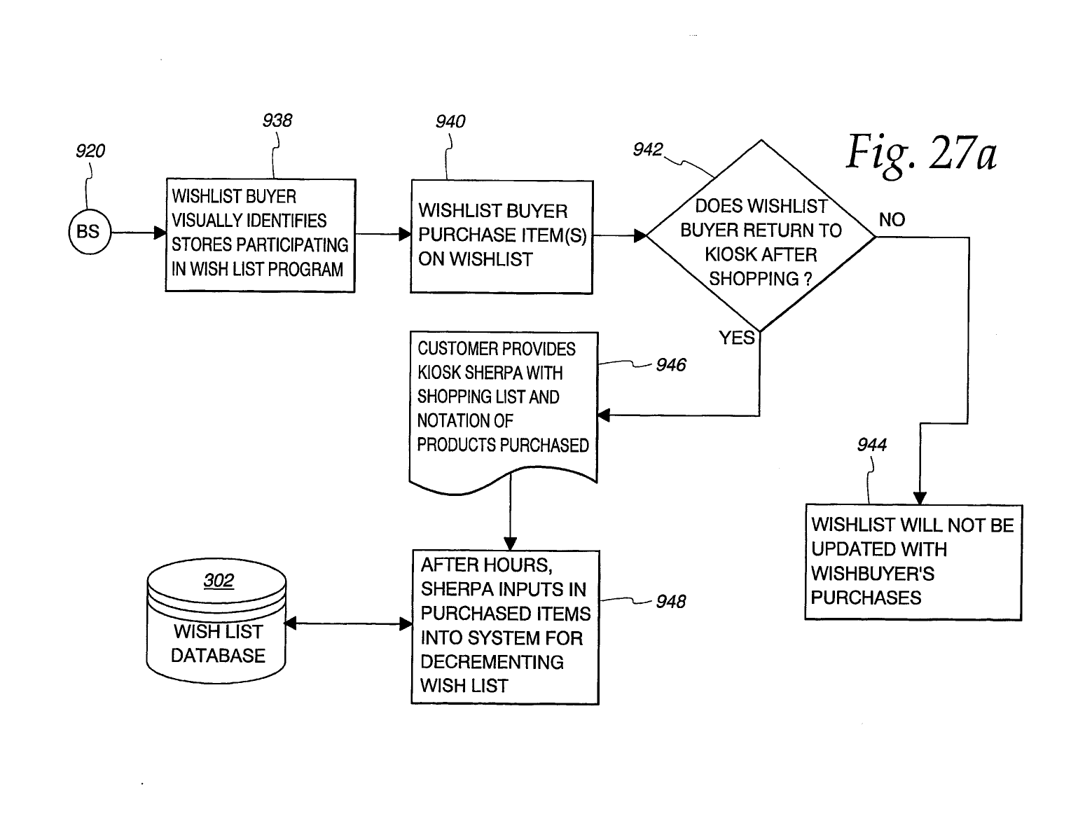

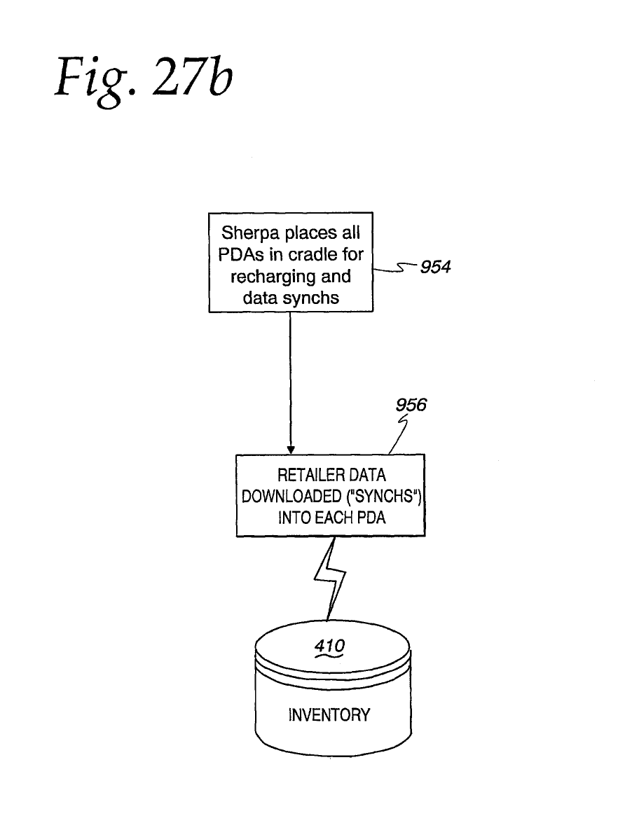

In FIGS. 26a-b, a buyer is at a kiosk at a participating store or mall where the buyer can interact with a computer. The system, which is connected to the computer, first determines whether the buyer provided a user name and password (block 904). If so, the system allows the buyer to print out one or more buy lists (or, if the buyer is the creator-user, his/her wish list(s) can be edited) (block 906). If the buyer is the creator-user, the system proceeds to block 922 where the user can edit items in an existing wish list(s) and/or an existing scan list(s). Otherwise, the third-party buyer proceeds to block 908 where the system displays for the buyer a list of buy lists (wish lists) that the buyer is authorized to access. The buyer then selects one or more of the displayed wish lists (block 910). In block 912, the system provides the buyer with a print-out of the items on the wish list(s). The system, in block 914, prints out the selected wish list(s) in a “shopping list” format that includes, for example, the name of the store where each item can be purchased, the name of the products on the wish list(s), a description of each item, the number of items remaining that the user desires, the wish list creator's (user's) name, a barcode number for each product, if applicable, and the name of the wish list(s). The system then displays, for example, a list of participating stores and policies relating to buying items on the wish list(s) (block 916). In block 918, the buyer proceeds to the designated stores. The system then proceeds to block 920 (described below with reference to FIG. 27a).

If the buyer did not enter a user name and password in block 904 or if the buyer is registering at an in-store/in-mall kiosk (block 923), the system initiates the SOS Web site which allows the buyer to register with the system (block 924). The system prompts the buyer to enter Level 1 registration information (block 926). This information includes, for example, the buyer's full name, e-mail address, login name, password, and telephone number. In block 928, the buyer completes the on-line registration process. The system then determines whether the buyer entered valid information in all the required fields (block 930). If so, the system proceeds to block

Otherwise, the system will provide feedback to the buyer indicating, for example, incomplete fields, and will request that the buyer enter valid information into the indicated fields (block 932). In block 934, the system again determines whether the buyer entered valid information in all the required fields. If not, the system returns to block 932. Otherwise, the system proceeds to block 936 where the system confirms the login and provides the buyer with his/her user name and password. The system then proceeds to block 906.

Referring to FIG. 27a, the system proceeds from block 920 to block 938 where the buyer visually identifies, from a printed wish list “shopping list,” the stores participating in the wish list program. In block 940, the buyer purchases one or more items on the wish list from a physical store. The buyer then has the option of returning to the kiosk where he/she began (block 942). If the buyer does not return to the kiosk, the wish list will not be updated to indicate which items the buyer purchased (block 944), unless the buyer thereafter updates this information on-line by logging into the system's Web site. Otherwise, the buyer provides the kiosk agent (sherpa) with the shopping list and an indication of which items were purchased (block 946). The agent then decrements the requested number of items on the wish list to reflect the number of items purchased by the buyer (block 948), which updates the wish list database 302. The agent can do this anytime after the buyer returns the shopping list, but will likely do this after hours.

In FIG. 27b, the kiosk agent places each PDA into its respective interface cradle for recharging and data synchronization (block 954), where retailer data is downloaded into each PDA (block 956) from database 410. This downloading procedure is only required for PDA's that are not wireless (i.e., PDA's that connect to the system via an interface cradle—batch processing PDA's). Wireless PDA's can download information periodically or continuously without having to be physically connected to an interface device.

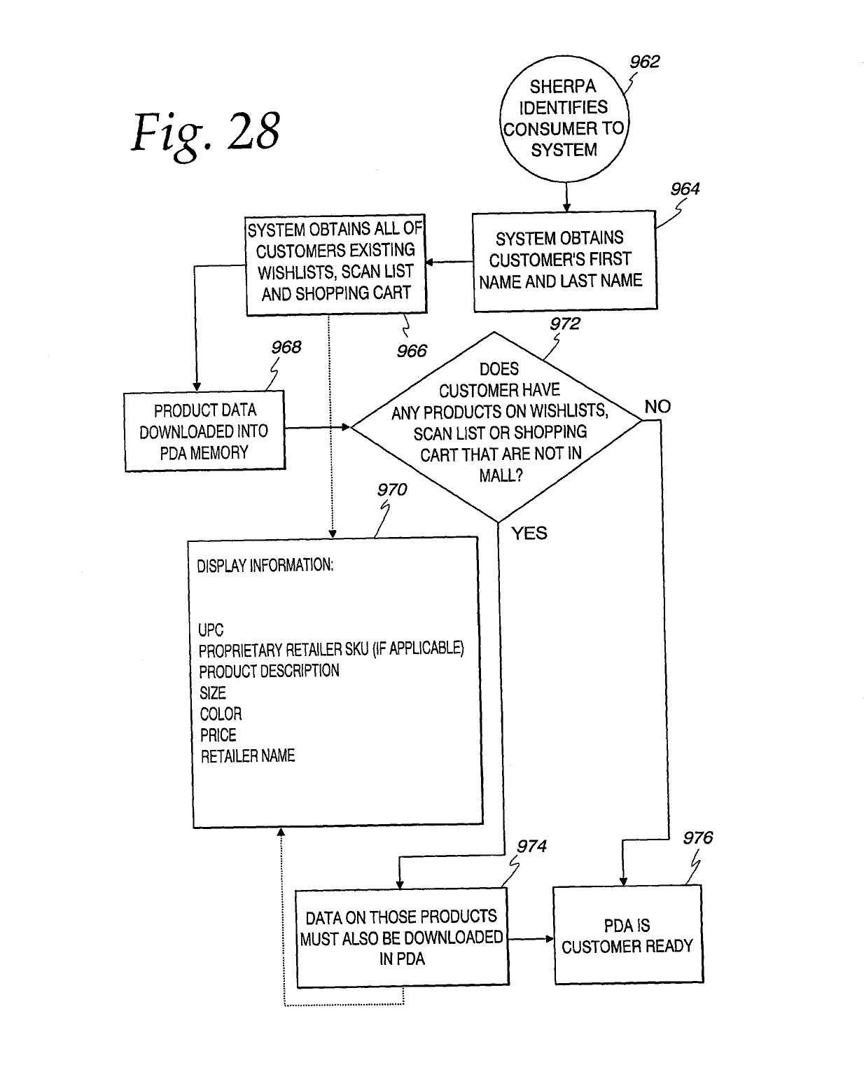

FIGS. 28a-b describes how the kiosk agent (sherpa) identifies the user to the system (block 962). The system first prompts the user for his/her full name (block 964). In one embodiment, the system then downloads all of the user's existing wish lists, scan lists and shopping cart lists from an external database to the internal memory of the PDA (block 966) by via a wireless data connection, an interface cradle, etc. In another embodiment, the system downloads information to display all of the user's existing wish lists, scan lists and shopping cart lists from an external database to the PDA via an interface cradle, a wire connection, an Infra-Red connection, etc. The display information includes, for example, all the products sold by each participating retailer in that specific mall and the UPC, product description, size, color, price, and retailer name (block 970). In block 968, product data, such as product name data, retailer Stock Keeping Unit (SKU) data, etc., is downloaded into the PDA memory for subsequent shopping and scanning. In block 972, the system determines whether any of the products on the user's wish list(s), scan list(s) or shopping cart list(s) are not available in that store or mall. If any of the products are not available, then data on those products must also be downloaded into the user's PDA (block 974). Otherwise, the PDA is ready for use by the user (block 976).

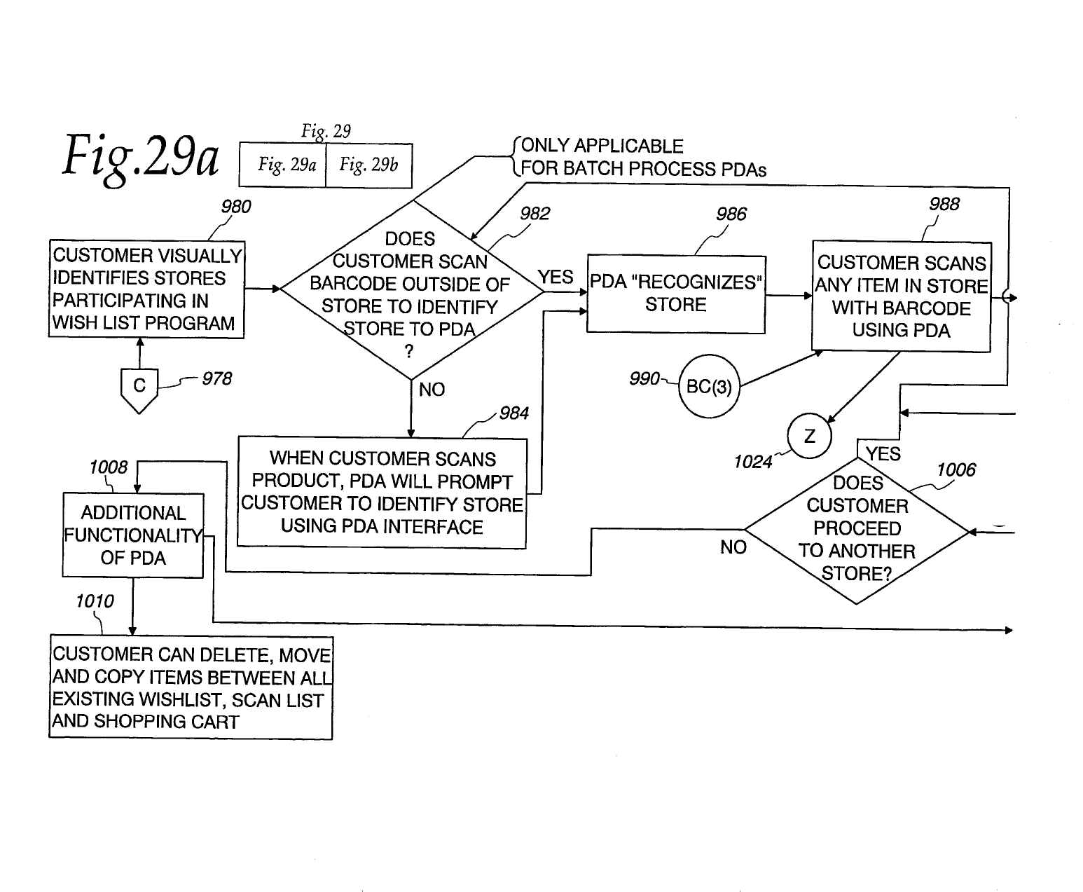

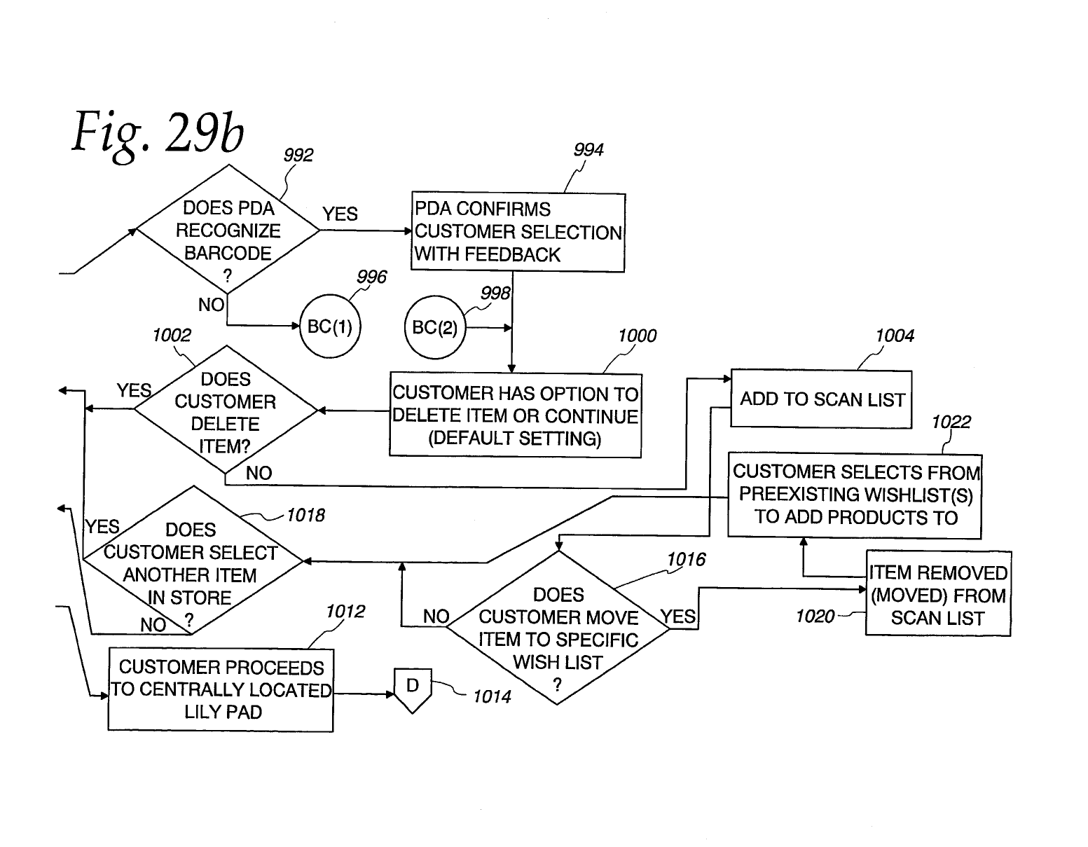

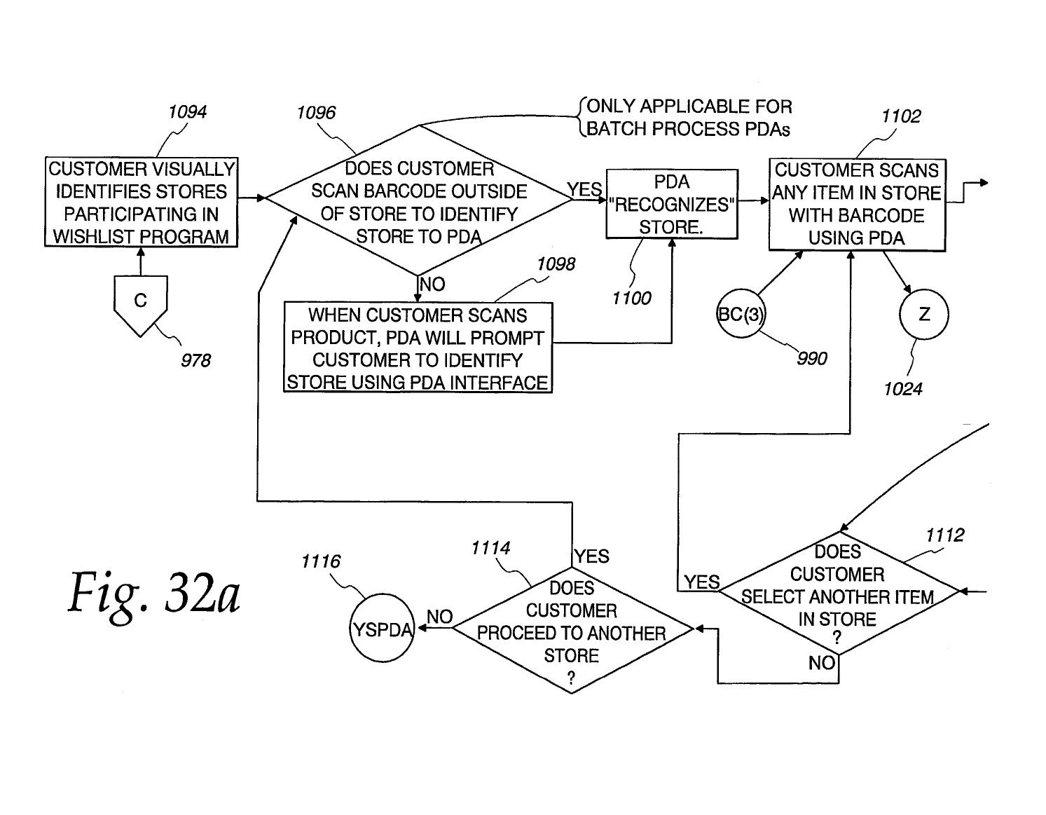

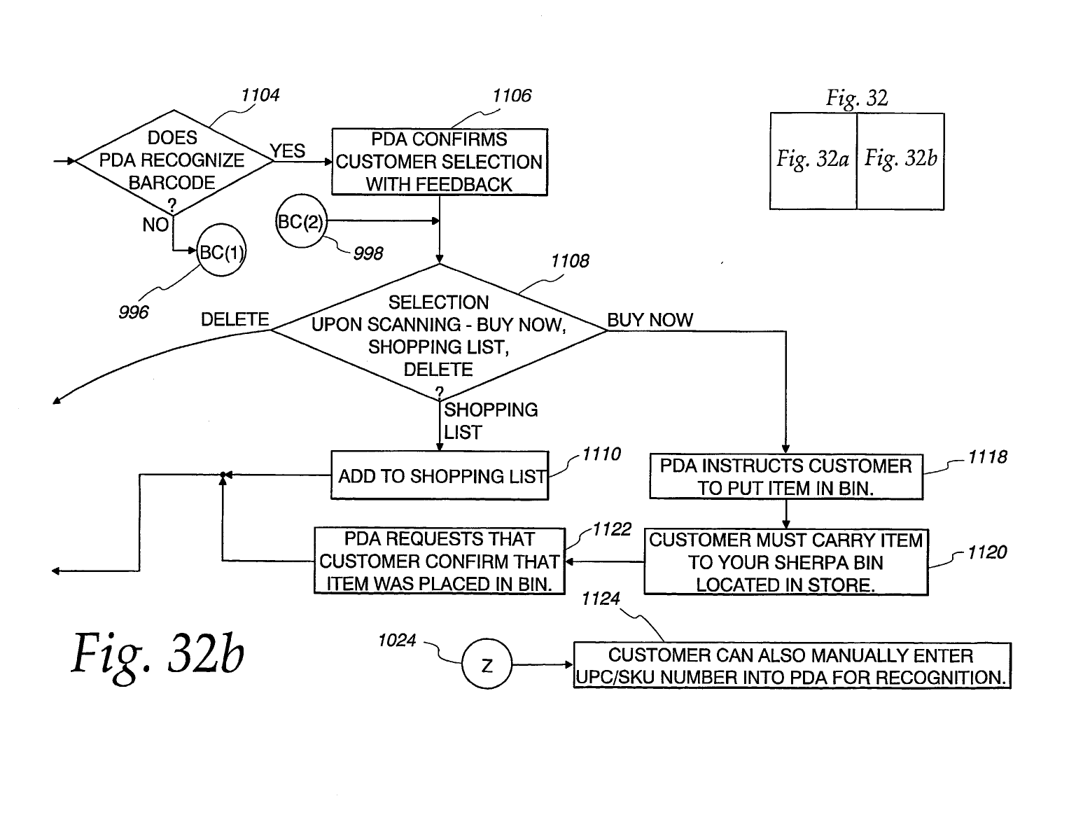

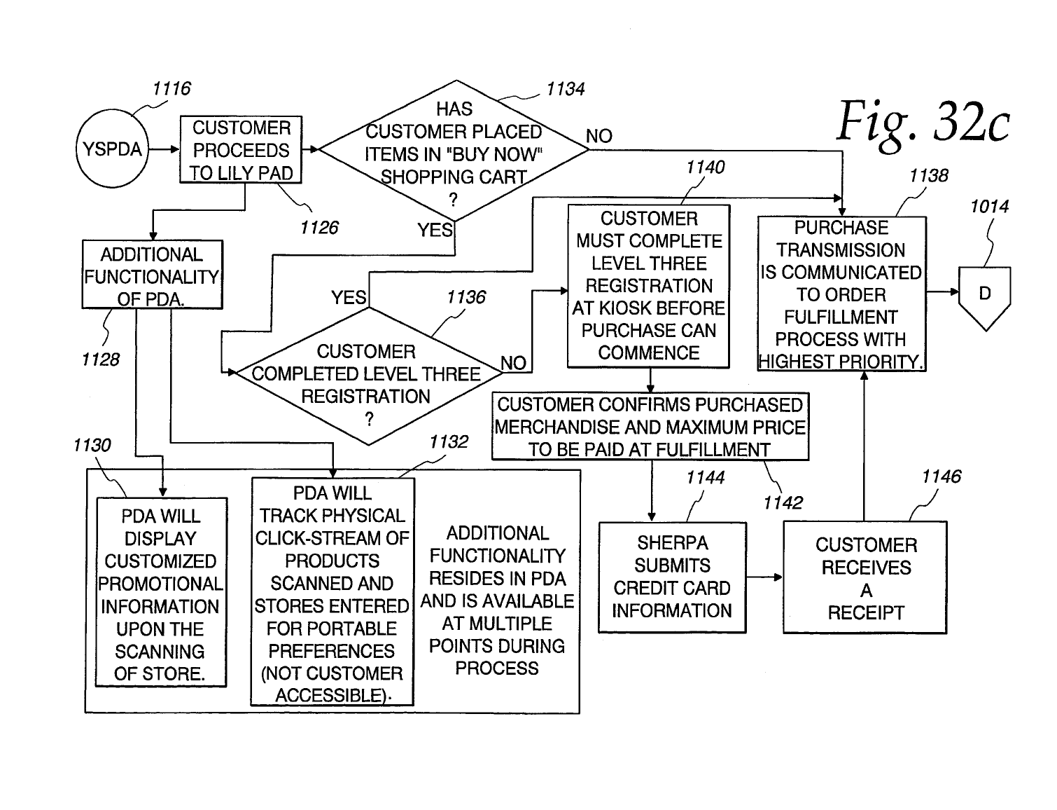

Referring to FIGS. 29a-b, the user can either proceed from block 978 to block 980 to add items to his/her scan list by scanning items at a store or mall, or to block 1034 (FIG. 32a) to modify a scan list and/or buy one or more items at a store or mall. If the user chooses the first option, the system proceeds from block 978 to block 980 (FIG. 29a) where the user visually identifies stores participating in the wish list program. In block 982, the user has the option of scanning a barcode outside a participating store to identify the store to the PDA. If the user does not scan a barcode, when the user scans a product in that store, the PDA will prompt the user to identify the store using the PDA interface (block 984). If the user does scan a barcode or after he/she enters the identity of the store, the PDA will recognize the store (block 986). From blocks 986 or 990, the user scans the barcode of any item in the store using the PDA (block 988). The system then either proceeds to block 1024 (which is described below in relation to FIG. 32b) or block 992.

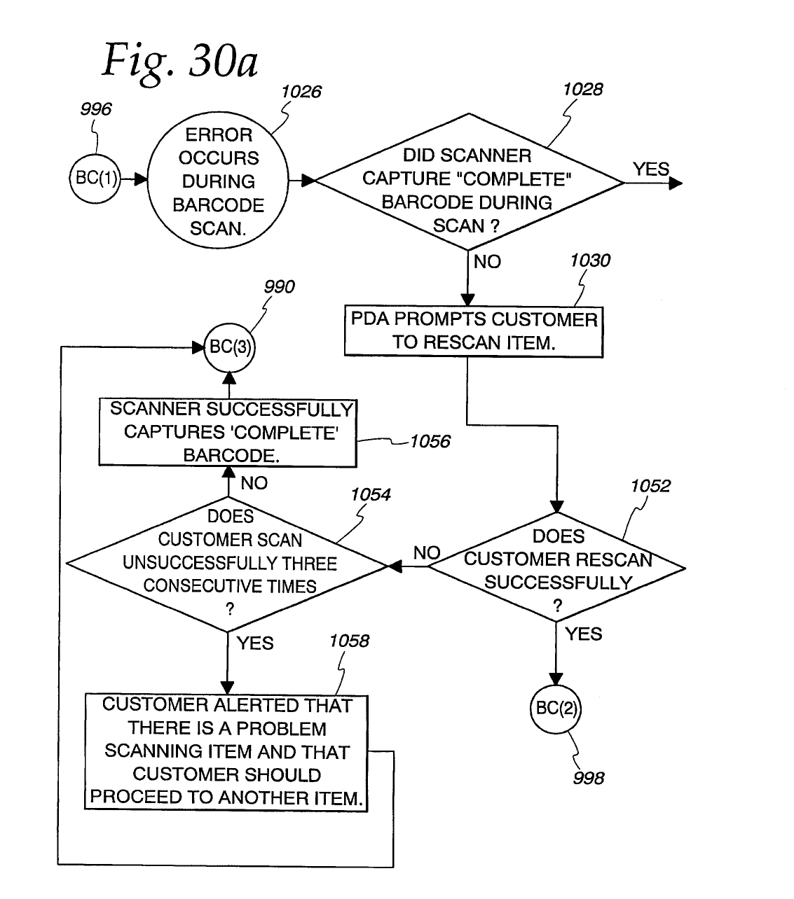

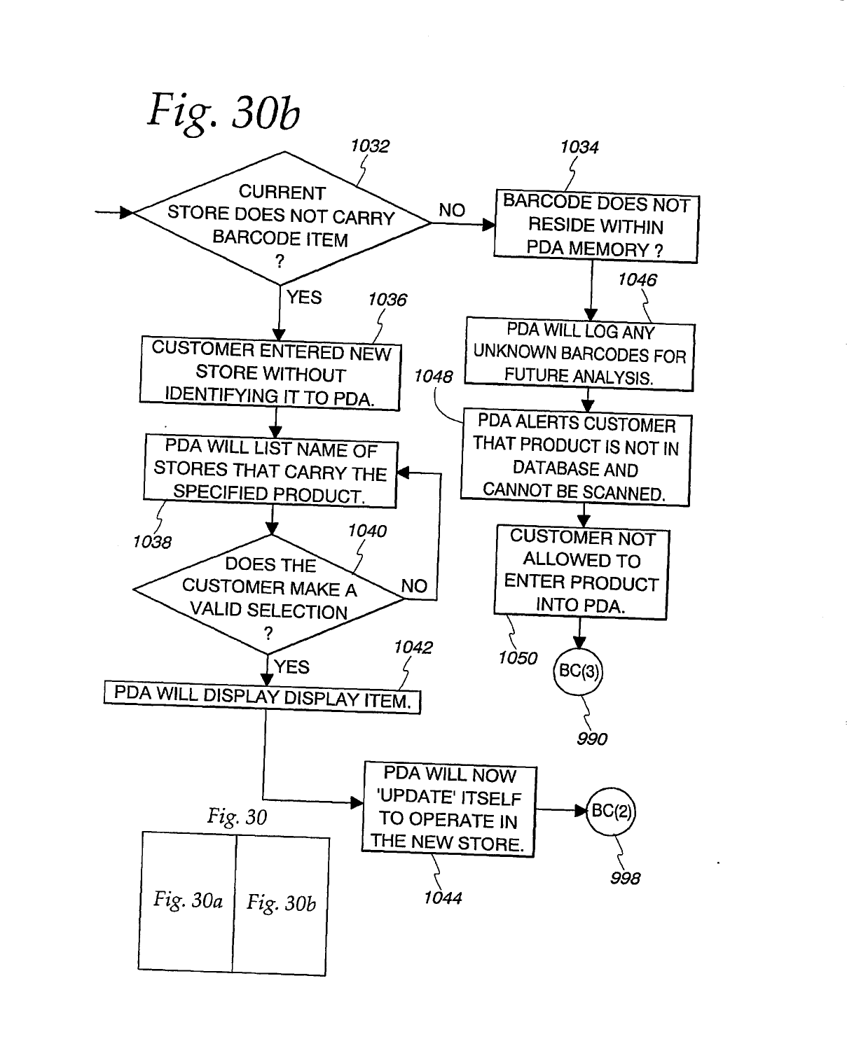

Referring to FIG. 29b, in block 992, the PDA determines whether it recognizes the scanned barcode. If not, the system proceeds to block 996 (which is described below in relation to FIG. 30a). Otherwise, the system proceeds to block 994 where the PDA confirms the user's selection by, for example, beeping, displaying a confirmation message, or displaying the store name, item number, product name, color, size, etc. The system proceeds from block 994 or block 998 to block 1000 where the user then has the option of deleting the scanned item or continuing to shop (which, for example, could be the default setting). If the user does not indicate that he/she wants to delete the scanned item (block 1002), the scanned item is added to the scan list (block 1004). Otherwise, the system returns to block 988.

From block 1004, the system proceeds to block 1016 where the user has the option of moving a scanned item from the scan list to a specific wish list. In one embodiment, if the user wants to move an item, the item is first removed from the scan list (block 1020). Alternatively, the item may be copied to the wish list while remaining on the scan list. In block 1022, the user selects from one or more preexisting wish lists and adds the scanned item to the selected wish list(s). Next, the system determines whether the user selected another item in the store by scanning a barcode (block 1018). If so, the system proceeds to block 988. Otherwise, if the user has proceeded to another retailer in the mall (block 1006), the system proceeds to block 982. If not, the user can use additional functionality provided by the PDA (block 1008) such as, for example, deleting, moving and copying items between all existing wish lists, scan lists and shopping cart lists (block 1010). Then, the user proceeds to the kiosk where the PDA cradle or lily pad resides (block 1012). From there, the system proceeds to block 1014 and the system is finished.

Referring to FIGS. 30a-b, the system proceeds from block 996 to block 1026 where the system produces an error code after an item is scanned. In block 1028, the system determines whether the scanner captured the complete barcode. If not, the PDA prompts the user to rescan the item (block 1030). Then, the system determines whether the user successfully rescanned the item (block 1052). If so, the system proceeds to block 998 (described above with reference to FIG. 29b). Otherwise, the system determines whether the user unsuccessfully scanned the item three consecutive times (block 1054). If not, the scanner successfully captures the complete barcode (block 1056) and proceeds to block 990 (which is described below in relation to FIG. 32a). Otherwise, the user is alerted that there is a problem scanning the item and that the user should select another item to scan (block 1058) or enter the barcode number manually. The system then proceeds to block 990.

If the scanner, in block 1028, did capture a complete barcode, the system determines whether the store carries an item corresponding to the scanned barcode (block 1032). If not, the barcode does not reside in the memory of the PDA (block 1034). In block 1046, the system will log the unknown barcode for future analysis. The PDA then alerts the user that the product does not reside in its memory and that the item cannot be scanned (block 1048). Thereafter, the user is not allowed to enter that product into the PDA (block 1050). The system then proceeds to block 990 (described below with reference to FIG. 32a).

If the current store does not carry an item corresponding to the scanned barcode, the user most likely entered a new store without identifying that store to the PDA (block 1036). The PDA will then list stores that carry the scanned product (block 1038). Then, the system determines whether the user makes a valid store selection (block 1040). If not, the system returns to block 1038. Otherwise, the PDA will, for example, display the scanned item to indicate that the scan was successful (block 1042). In one embodiment, the PDA then updates itself to operate in the new store (block 1044). The system then proceeds to block 998 (which is described above in relation to FIG. 29b).

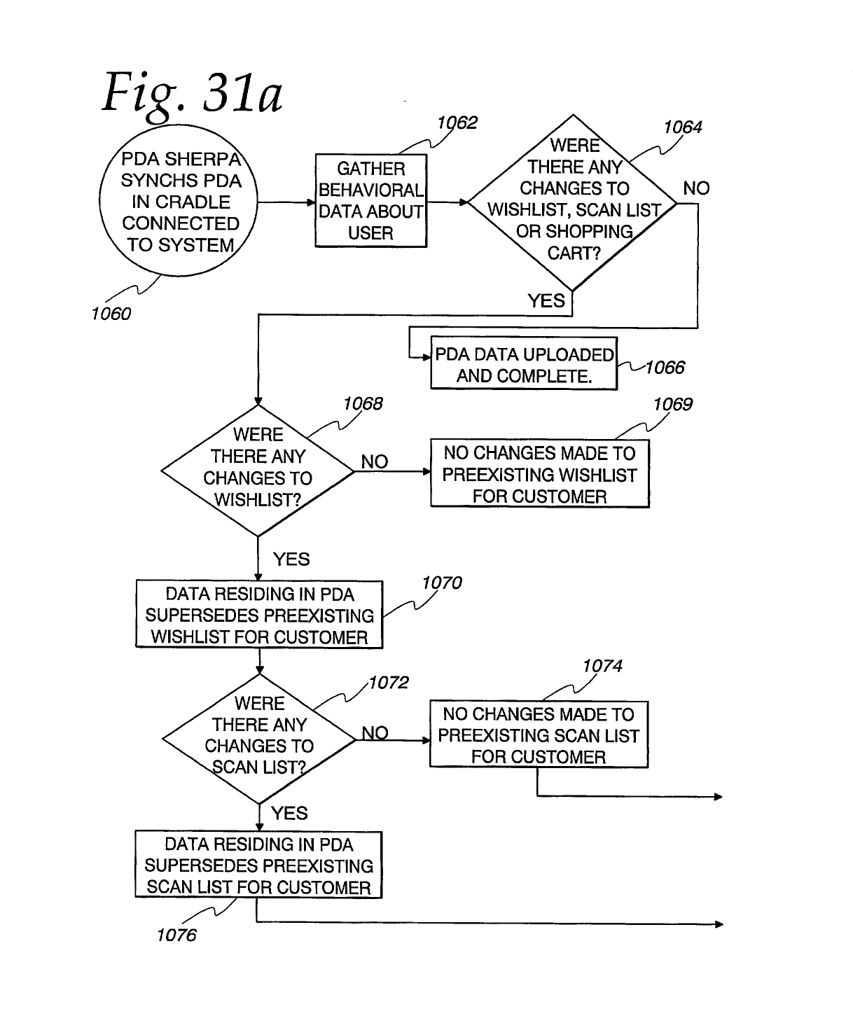

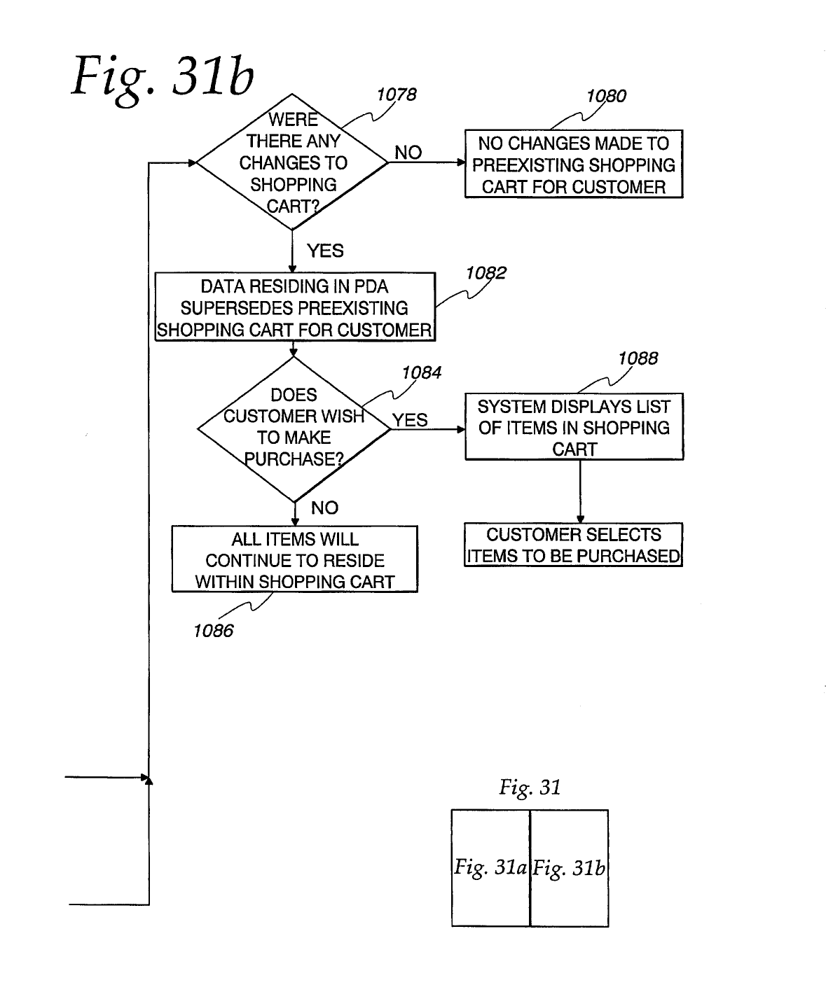

FIGS. 31a-b describe how the kiosk agent synchronizes batch processing PDA's by placing them into cradles connected to the system (block 1060). In one embodiment, the system gathers behavioral data about the users (block 1062) such as which items were scanned, which items were added to a wish list, which items were deleted from a wish list, etc. The system then determines whether there are any changes to the wish lists, scan lists or shopping cart lists stored in the memory of the PDA (block 1064). If not, PDA data (such as behavioral data) is uploaded and the synchronization is complete (block 1066). Otherwise, the system determines whether there was a change to any of the wish lists (block 1068). If not, no changes are made to the pre-existing wish list data for this user which resides on an external database (block 1069). Otherwise, in block 1070, the data residing in the PDA will replace the preexisting wish list data for this user which resides on the external database. After block 1069 or 1070, the system determines whether there are any changes to the scan list (block 1072). If not, no changes are made to the pre-existing scan list data for this user which resides on an external database (block 1074). Otherwise, in block 1076, the data residing in the PDA will replace the preexisting scan list data for this user which resides on the external database.

After block 1074 or 1076, the system determines whether there are any changes to the shopping cart list data (block 1078). If not, no changes are made to the pre-existing shopping cart list data for this user which resides on an external database (block 1080) and the system proceeds to block 1088. Otherwise, in block 1082, the data residing in the PDA will replace the preexisting shopping cart list data for this user which resides on the external database. In block 1084, the system determines whether the user wants to purchase one or more items in the user's shopping cart. If so, the system proceeds with order fulfillment by displaying a list of items in the user's shopping cart (block 1088). The user then selects one or more of these items to purchase (block 1090). Otherwise, if the user does not want to make a purchase, all the items will continue to reside in the user's shopping cart (block 1086). The user can thereafter add one or more of these items to a wish list and/or purchase one or more of these items at a later time.

Referring to FIGS. 32a-b, if the user chose the option of modifying a scan list and/or buying one or more items at a store or mall, the system proceeds from block 978 to block 1094 where the user visually identifies stores participating in the wish list program. In block 1096, the user has the option of scanning a barcode outside a participating store to identify the store to the PDA. If the user does not scan a barcode, when the user scans a product in that store, the PDA will prompt the user to identify the store using the PDA interface (block 1098). If the user does scan a barcode or after he/she enters the identity of the store, the PDA will recognize the store (block 1100). After block 1100 or block 990, the user scans the barcode of any item in the store using the PDA (block 1102). The system then proceeds to either block 1104 or block 1024 (which is described below in relation to FIG. 32b). In block 1104, the PDA determines whether it recognizes the scanned barcode. If not, the system proceeds to block 996 (which is described above in relation to FIG. 30a). Otherwise, the system proceeds to block 1106 where the PDA confirms the user's selection by, for example, beeping, displaying a confirmation message, or displaying the store name, item number, product name, color, size, etc.

The system proceeds from block 1106 or block 998 to block 1108 where the user is presented with three options: delete item, add item to shopping list, or buy item now. If the user chooses to delete the selected item, the system determines if the user selects another item in that store (block 1112). If so, the system returns to block 1102. Otherwise, if the user has proceeded to another store (block 1114), the system returns to block 1096. If not, the system proceeds to block 1116 (which is described below in relation to FIG. 32c).

If, in block 1108, the user chooses the second option, the system adds the selected item to the user's shopping list (block 1110). The system then proceeds to block 1112. If the user chooses the buy now option, the PDA instructs the user, for example, to place the scanned item into the YourSherpa bin at that store (block 1118). Then, the user carries the item to the YourSherpa bin located in that store (block 1120). The system proceeds to block 1122 where the PDA requests the user to confirm that the item was placed in the YourSherpa bin. The system then returns to block 1112.

If an error occurred while scanning an item, the system proceeds from block 1024 to block 1124 where the user can manually enter the UPC/SKU number into the PDA so the system will recognize the item the user attempted to scan.

Referring to FIG. 32c, the system proceeds from block 1116 to block 1126 where the user proceeds to the kiosk where the PDA cradle or lily pad resides. In block 1128, additional functionality is provided by the PDA for the user such as, for example, displaying store promotions for the store just scanned by the user. The system, in block 1134, determines whether the user has placed any items in the “buy now” shopping cart. If so, the system determines whether the user has completed registration Level 3 (block 1136). If the user has not completed that registration level, the system proceeds to block 1140 where the user must complete a Level 3 registration at the store/mall kiosk before the user makes a purchase. Then, the user confirms the items to be purchased and the price to be paid (block 1142). The kiosk agent then submits the user's credit card information and the amount of the purchase for credit authorization (block 1144). Next, the user receives a receipt to confirm purchase of the items (block 1146).

From block 1146 or from block 1134 (if the user did not place an item in the “buy now” shopping cart), the system proceeds to block 1138 where the system communicates the purchase request to an order fulfillment module that fulfills the order. This communication may occur, for example, immediately via wireless communication or when the PDA is placed in its interface cradle. Then, the system proceeds to block 1014 and is finished.

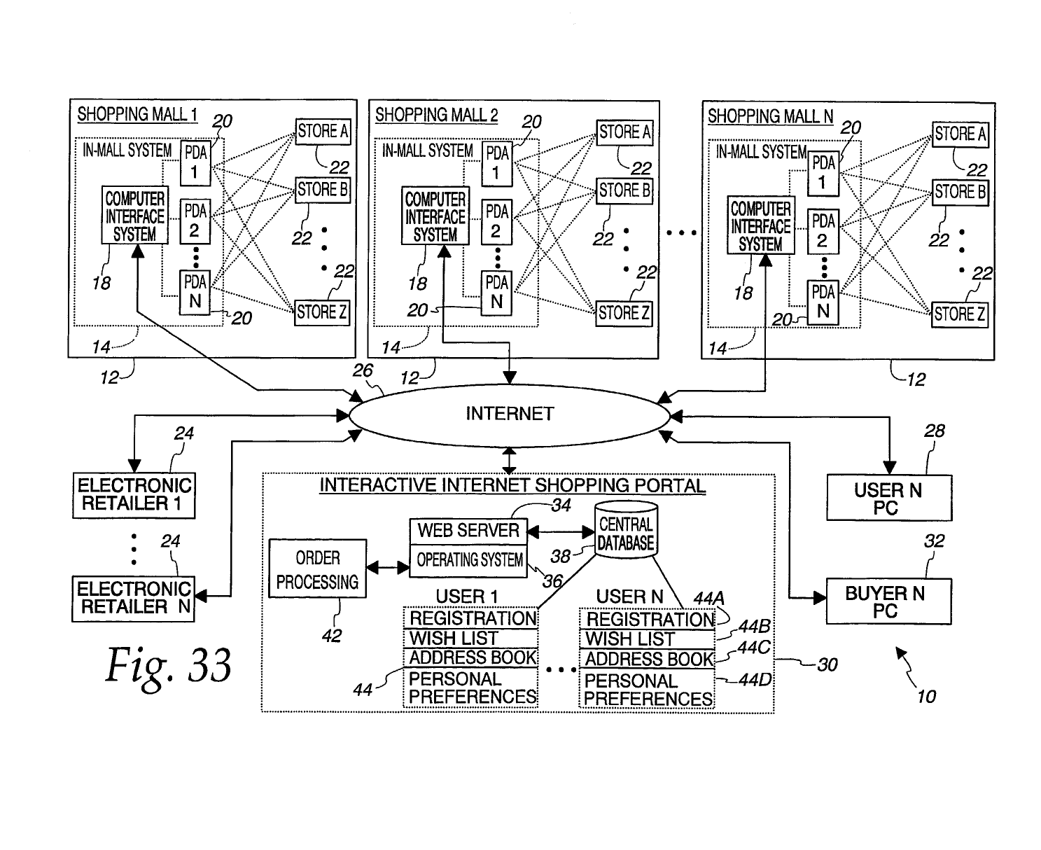

Referring to FIG. 33, another embodiment of the invention is shown. The system 10 includes in-store/in-mall systems 14 located within a plurality of malls 12. Located within each mall are a plurality of physical stores 22 (Store A-Store Z). Each in-store/in-mall system 14 includes a computer interface system 18 (having a memory), such as a PC, a workstation, or any other type of computer system having a memory. The computer interface system 18 is coupled to a plurality of scanners 20, which communicate with the computer interface system 18, for example, through an interface cradle that holds the scanner 20 and provides an electrical data connection between the scanner 20 and the computer interface system 18 so that data from the scanner 20 can be uploaded to the computer interface system 18. As used herein, the scanner 20 may comprise a barcode scanner, a personal digital assistant (PDA), or a wireless telephone (cellular, PCS, GSM).

The system further includes an Interactive Internet Shopping Web Site Portal 30, a plurality of Electronic Retailer Web Sites 24, and a plurality of user and buyer personal computers (PCs) 28, 32. The systems 14, 30, 24, 28 and 32 are coupled together via a wide-area communications network 26, such as the Internet. Note, however, that network 26 could also be a cable TV network, a satellite network, a wireless data network, or any other type of communications network.

In one embodiment, the Interactive Internet Shopping Web Site Portal 30 includes a Web server 34 (which hosts the system Web site 30), an operating system 36, an order processing system 42, and a central database 38, as shown in FIG. 33. The Web site 30 provides a user interface for enabling users to create and edit wish lists 44B. In one embodiment, the Web site 30 is referred to and accessed using the domain name “clixlist.com.” The Web site 30 may also include many features such as registration 44A, an address book 44C, personal preferences 44D, etc. Items for each wish list may be selected either through the in-store/in-mall systems 14 and/or from the Electronic Retailers 24.

In one embodiment, the in-store/in-mall system 14 is located in a physical retailer. The user scans products in the retailer and then uploads the product data through the in-store system 14 to the central database 38. This embodiment can be used as stand alone wish list system for a particular retailer (e.g., the Gap™). This system operates the same as the multi-retailer (mall) embodiment described herein, except that the user and/or buyer can only shop at one specific retailer.

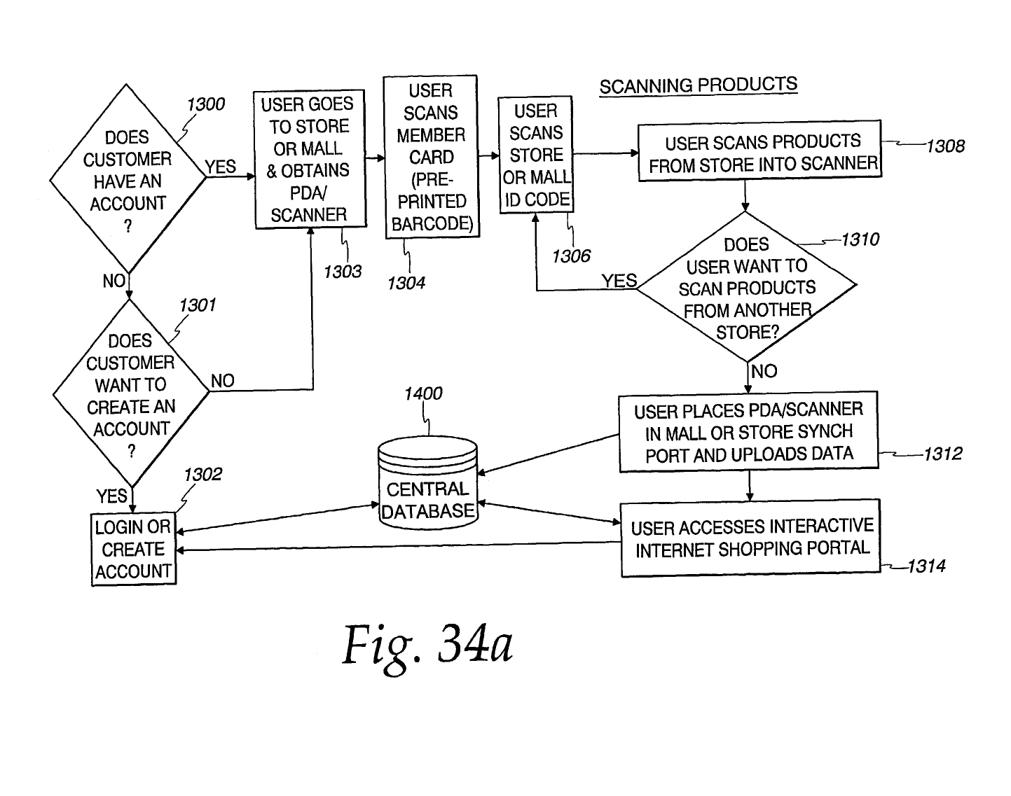

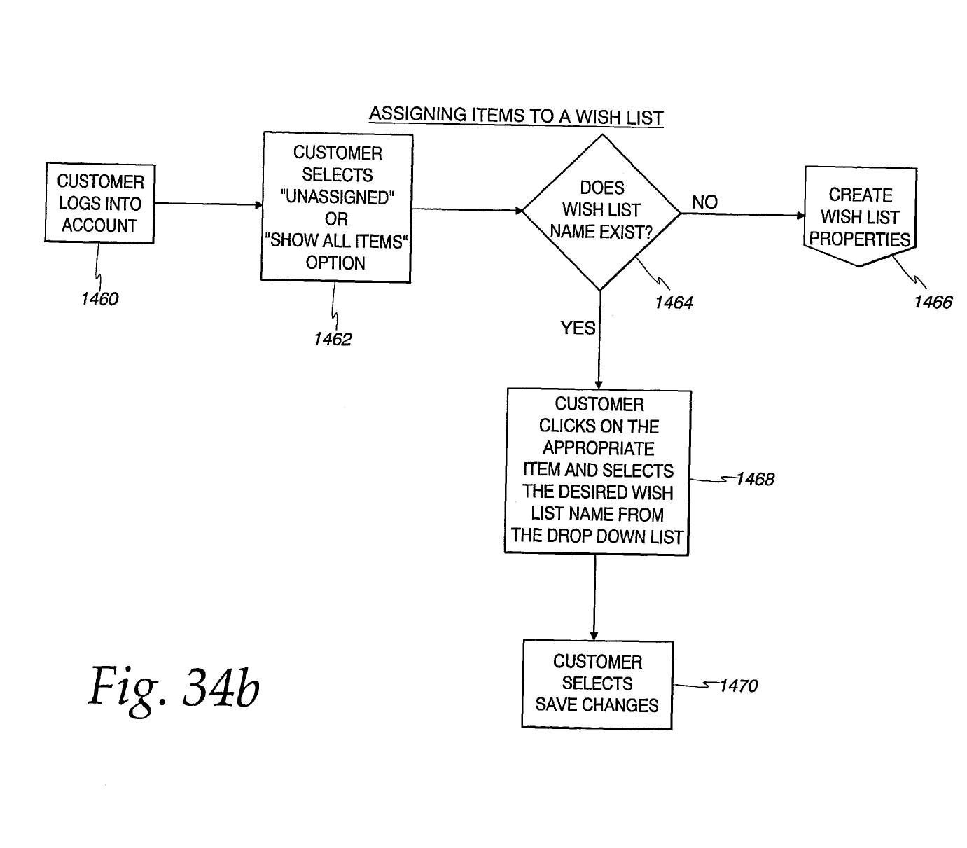

In one embodiment, a user can scan products for a wish list at participating physical retailers before or after creating an account with the system, as shown in FIG. 34a. If the user already has an account (block 1300), then the user proceeds to block 1303. Otherwise, if the user wants to create an account (block 1301), he/she goes to the system Web site and selects the Create option to create an account (block 1302). Otherwise, even if the user does not have an account with the system, he/she can obtain a scanner 20 from the store or mall kiosk agent (block 1303), if the user does not have his/her own scanner. Typically, the user must leave some sort of collateral, such as a driver's license, identification card, etc. In another embodiment, the user will have his/her own scanner (e.g., a PDA scanner, a key chain scanner, a cellular telephone scanner, etc.). Alternatively, scanners may be given away at the mall or store, or through other promotional methods. The user then obtains a member card, which includes a barcode that corresponds to a member identification number. Typically, the user obtains the card from the store or kiosk agent, or through some other promotional method (e.g., direct marketing). The user scans the barcode on the member card to store the member ID number in the scanner (block 1304). Alternatively, the scanner may be pre-coded with a member ID number. Next, the user proceeds to a participating store and scans a store identification code associated with the store before scanning products (block 1306). The store barcode is used by the system to determine which items were scanned in which stores. Alternatively, the user can scan a mall ID code, and then scan items at one or more stores in that mall (e.g., by using SKU data that identifies each store, as described below).

Using the scanner 20, the user selects certain products to add to his/her wish list, for example, by scanning a SKU barcode located on a particular product (block 1308). Alternatively, the user (or a store clerk) may enter information about a desired product manually into the scanner 20. The scanner confirms the user's product selection, for example, by beeping, displaying a confirmation message, or displaying the store name, item number, product name, color, size, etc.

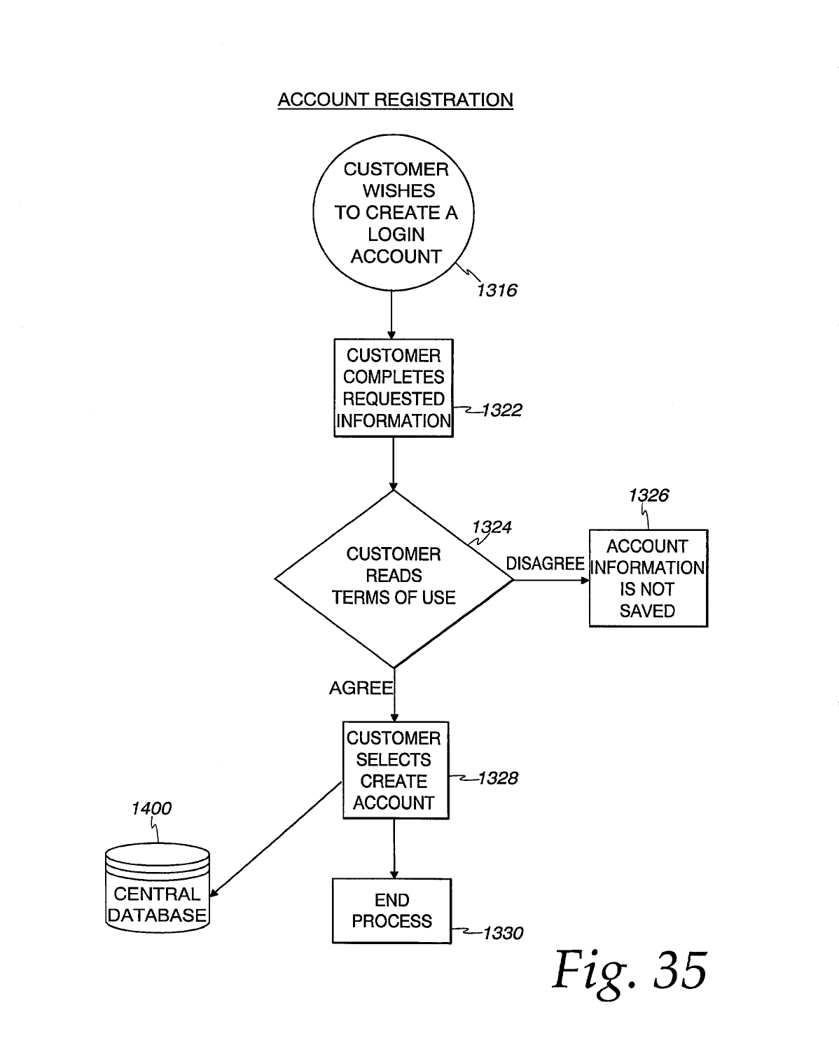

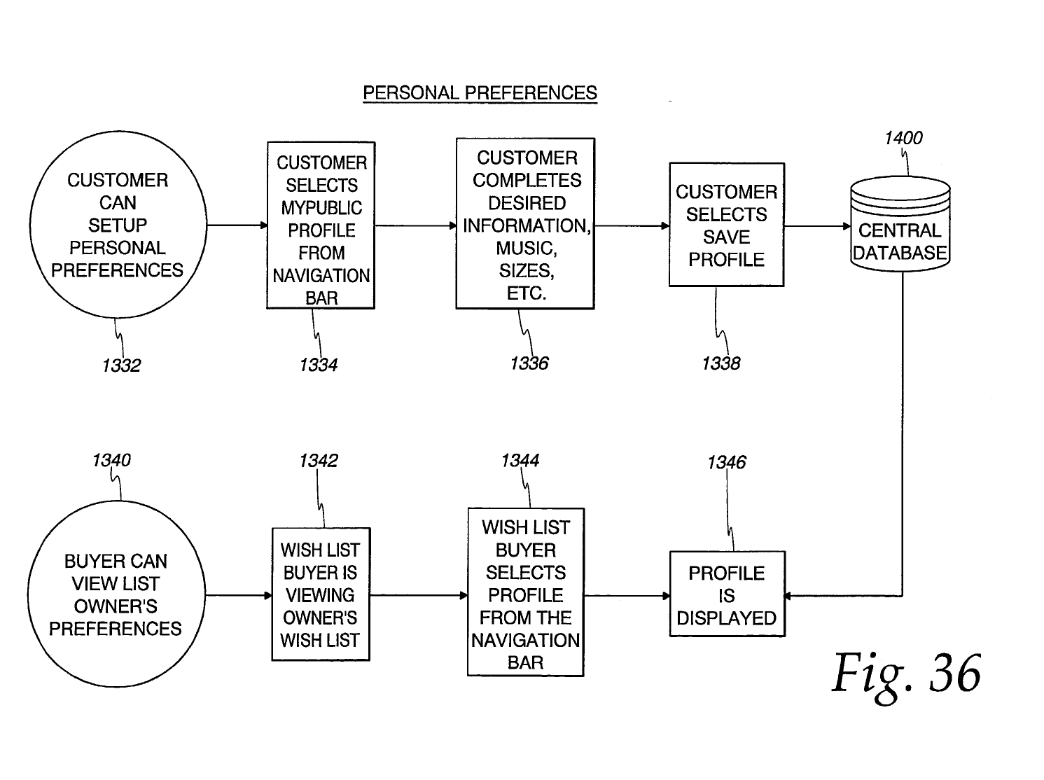

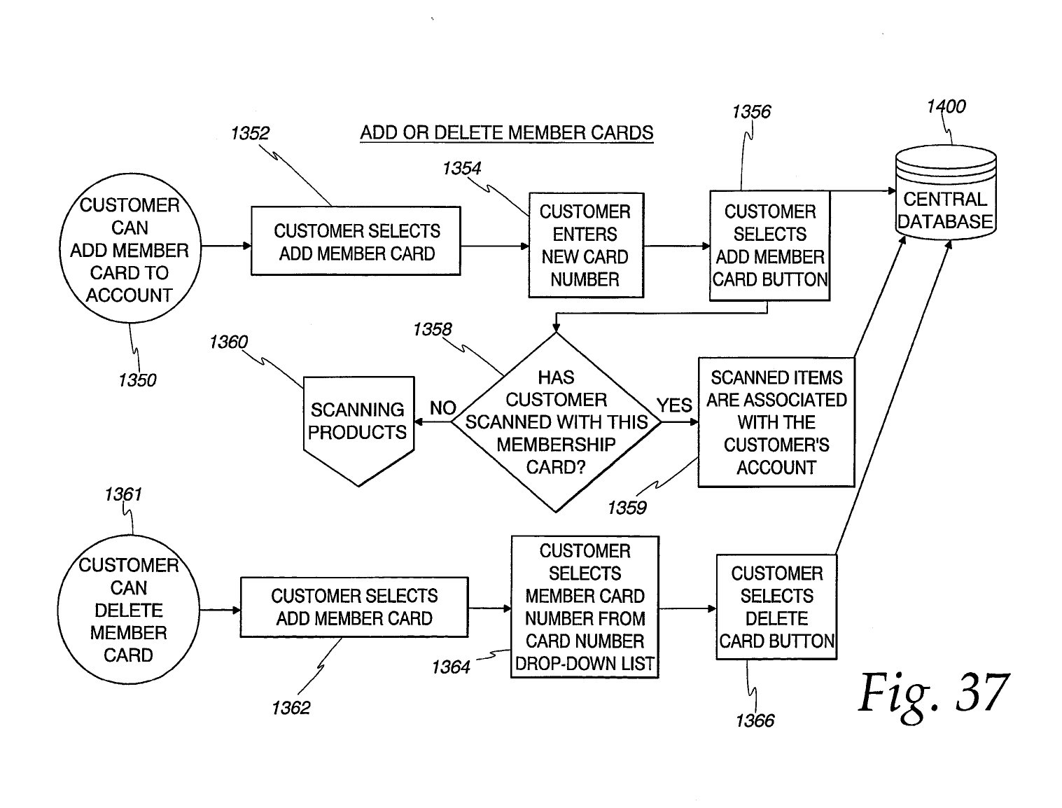

In one embodiment, if the user wants to scan products in another store (block 1310), then the user repeats blocks 1306-1310. Otherwise, if the user is finished scanning, he/she returns the scanner to the store or mall kiosk agent (unless the user is using his/her own scanner). In block 1312, the agent (or user) synchronizes the scanner 20 by placing it into an interface device (e.g., a cradle) connected to the computer terminal (scan station) 18. The scan station runs software for communicating with the central database 1400 via the Internet. The scanned product data is then uploaded to the central database 1400. Alternatively, a wireless scanner can be used that is in continuous (or periodic) communication with the central database 1400 through a wireless connection. A wireless scanner can upload product data without having to be physically connected to an interface device. The uploaded product data is saved as an unassigned list of items associated with the member identification number. As a result, the member ID number on the member card must, at some point, be associated with the user via the assignment process (i.e., the user must log into the system Web site and assign items from the unassigned list to specific wish lists, as described with reference to FIG. 34b). If the user is not registered, he/she must first log into the system Web site and register (as described with reference to FIG. 35), associate the member card with his/her account (as described with reference to FIG. 37), and then assign items to a specific wish list (as described with reference to FIG. 34b).

In block 1314, the user accesses the system Web site. The system Web site interfaces with the central database 1400. The user can then create an account, if one does not exist, or login to the system to perform account functions, such as create and edit wish lists, set user preferences, enter address book entries, add or delete member cards, and create a share list (block 1302).

In another embodiment, a different method is used to determine which items were scanned in which stores. In this embodiment, the SKU data obtained from each product is used to determine the store where each product was scanned. Specifically, when the scanned data is uploaded, the SKU data for each product is correlated with a specific retailer. For example, the first two positions of the SKU code could be used to identify the retailer (e.g., GA25128568 for Gap™). The system then determines the identity of the mall, for example, by determining the location of the computer terminal 18 connected to the synch cradle (e.g., by determining the IP address of the terminal). Therefore, the system can identify the specific retail store where each product was scanned (e.g., the Gap™ at Circle Centre). In another embodiment, the scanner can prompt the user to identify the store at which a product was scanned using the scanner interface. In either of these embodiments, the user does not need to scan the store code before scanning items in that store. Rather, the system can determine the particular mall where the items were scanned from the IP address of the terminal 18, or the user can scan a mall code, or enter the mall and store information manually.

Once the scanner 20 is synchronized with the central database 1400, the user can select the “Read Scanner” option. The computer terminal 18 will then display the unassigned list of all the items scanned. Alternatively, the unassigned list will be automatically displayed after the scanner is inserted into the interface device (e.g., a synch cradle). For each item, product information will be displayed such as, for example, the product name, store name, product ID code, size, color, price, etc. Also, if any invalid barcodes were scanned, the item will appear on the unassigned list with a message indicating that the barcode could not be associated with an item in the store. The user can then log into the system Web site and copy and/or move an item to a specific wish list name, delete an item, add an item to a shopping cart for purchase, edit the quantity of a desired item, etc.

In one embodiment, the user can add items to a wish list by scanning items at a physical retailer, selecting items from an on-line retailer, or selecting items from a catalog or magazine. For example, to select on-line items, the user can click on the desired item, check a box, or type the name of the item and where it can be purchased into the unassigned list or a specific wish list. To select catalog items, the user can scan a product barcode from the magazine or catalog, or manually type the name of the item and where it can be purchased into the unassigned list or a specific wish list.

To assign an item to a specific wish list name, the user first logs into the system Web site (block 1460), as shown in FIG. 34b. Next, the user selects the Unassigned List option or the Show All Items option (block 1462). The user can either assign each item to an existing wish list name or create a new wish list name. If the wish list name does not exist (block 1464), the user creates a wish list (block 1466). Otherwise, the user selects the appropriate item(s) and then selects the wish list name to which the item(s) should be assigned (block 1468). In one embodiment, the wish list name is selected from a pull-down menu or typed into a field. In block 1470, the user selects Save Changes. The system then moves and/or copies the item(s) to the specific wish list name indicated by the user and updates the central database 1400. The user can also delete one or more items from the unassigned list or a specific wish list name. In addition, the user can assign (e.g., move or copy) one or more items to his/her shopping cart to purchase the item(s). After the edits are completed, the user selects the Submit button to save the information to the central database 1400.

The user may register with the system before or after scanning wish list items. Moreover, if the user scans items before registering, the scanned items associated with the user's member identification number can later be associated with the user's account via the registration process. Referring to FIG. 35, if a user wants to register with the system, the user goes to the system Web site (e.g., clixlist.com) and selects the Create option to create an account (block 1316). The user then enters the requested information, such as name, user name, password, password hint, birthday, e-mail address, etc. (block 1322). Next, the user must read the terms of use (block 1324). If the user does not agree to these terms, the account information is not saved (block 1326). Otherwise, the user selects Agree and then selects Create Account (block 1328). The system saves the account information to the central database 1400 and the process is finished (block 1330).

Upon completion of the registration and association processes, all previously scanned items will appear on the user's unassigned list. Thereafter, items scanned with the same member card number will automatically appear on the user's unassigned list. Generally, the user will, at some point, move the scanned items to a particular wish list name by selecting one or more products, specifying a quantity for each, and copying and/or moving the selected products to a specific wish list name. The products are then copied or moved from the user's unassigned list to the selected wish list name. A registered user can perform various options, such as: move each scanned item from the unassigned list to a specific wish list name, associate another member card with his/her account, add products to a wish list by shopping on-line, scan wish list items at a physical store, create a wish list, view/edit a wish list, view/edit the event categories associated with each wish list name, edit an address book entry, edit personal preferences, associate member ID numbers with his/her account, create a share list, etc.

Personal preferences are explained with reference to FIG. 36. In block 1332, a user can set-up his/her personal preferences (a user profile). To do this, the user logs into the system Web site and selects My Public Profile (block 1334). The user then enters information, including his/her favorite color, hobbies, favorite music, favorite artist, favorite movie, size information, likes, dislikes, etc. (block 1336). The user then selects Save Profile (block 1338) to save this information to the central database 1400. This information allows buyers to know exactly what types of things the user likes and dislikes, and what sizes the user wears. This information is helpful for buyers who, for example, want to buy something for a user that is not listed on any of the user's wish lists. In one embodiment, these personal preferences are accessible to the public.

In block 1340, a buyer can view a user's personal preferences. To do so, the buyer logs into the system Web site and searches for a user's wish list. While viewing a wish list (block 1342), the buyer selects Profile (block 1344). The user's profile is then displayed for the buyer (block 1346). In one embodiment, the buyer can only access the personal preferences associated with a Public wish list. Otherwise, a password is required to access to the personal preferences associated with a Private wish list. While viewing a wish list, the buyer can select Profile to view a user's personal preferences. In another embodiment, the user can designate his/her personal preferences as Public or Private, where Private preferences require a password for access by a buyer. That way, for example, even if the user had five Private wish lists and one Public wish list, the user could designate his/her personal preferences as Private so that the general public could not access this information.

During the synchronization process, all the scanned items stored in the scanner 20 are transferred to the central database 1400. These items will be stored as an unassigned list associated with the member identification number (member card) scanned by the user prior to scanning items. These items can later be associated with the user's account via the association process.

Referring to FIG. 37, if a user has already created an account with the system (registered) and forgets his/her member card, the user can pick-up a new member card at a participating retailer and/or mall and still be able to scan products and upload the scanned products to the central database 1400, as described above. In addition, even if a user has not registered, he/she can scan items using one or more different member cards and associate those cards with an account at a later time. To perform the association process, the user goes to the system Web site and adds the new member identification number from the new member card to his/her account (block 1350). The user logs in and chooses Add Member Card from the list of options (block 1352). The user then enters the new member ID number (block 1354). Next, the user selects the Add Member Card button (block 1356). The system then determines if the member identification number has been previously associated with an account stored in the central database 1400. If so, the user is told the member card number is invalid (e.g., the card may have been lost by the first user). Otherwise, the system determines whether the user has previously scanned items using this particular member identification number (block 1358). If so, the scanned items are associated with the user's account (block 1359). If not, the user can scan products (block 1360) as described with reference to the Scanning Products process of FIG. 34a. The association process is repeated for each new member card not previously associated with the user's account.

In block 1361, the user can delete one or more member identification numbers from his/her account. The user first selects Add Member Card from the list of options (block 1362). The user then selects the member ID number to be deleted, for example, from a pull-down list (block 1364). Next, the user selects the Delete Card button (block 1366).

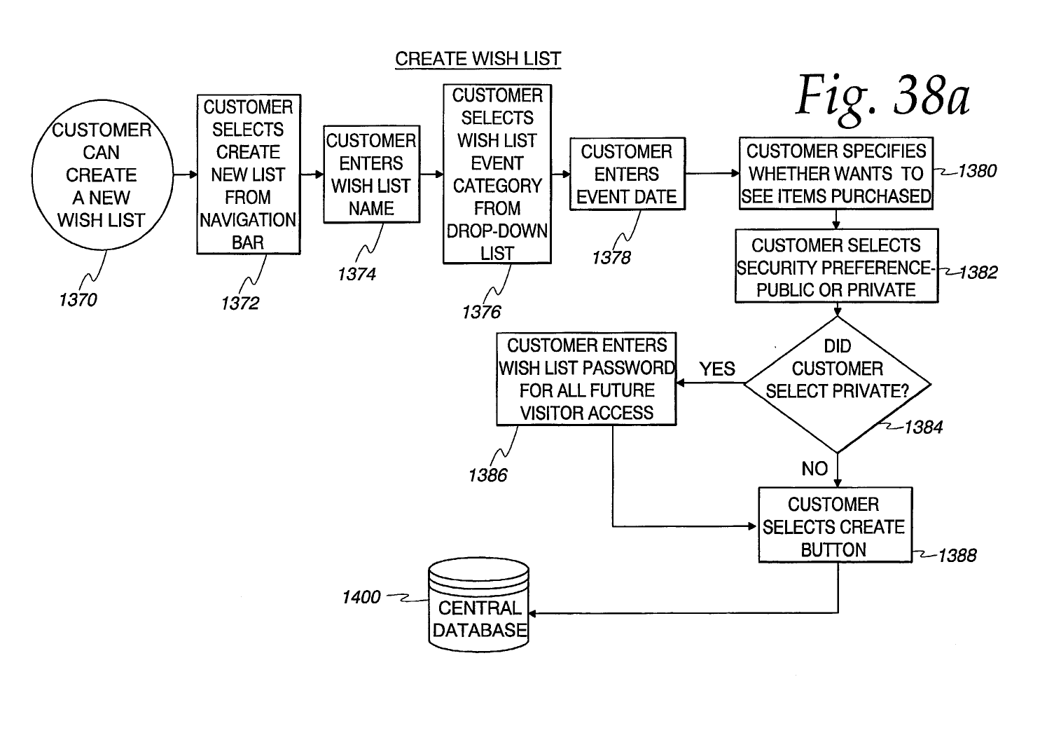

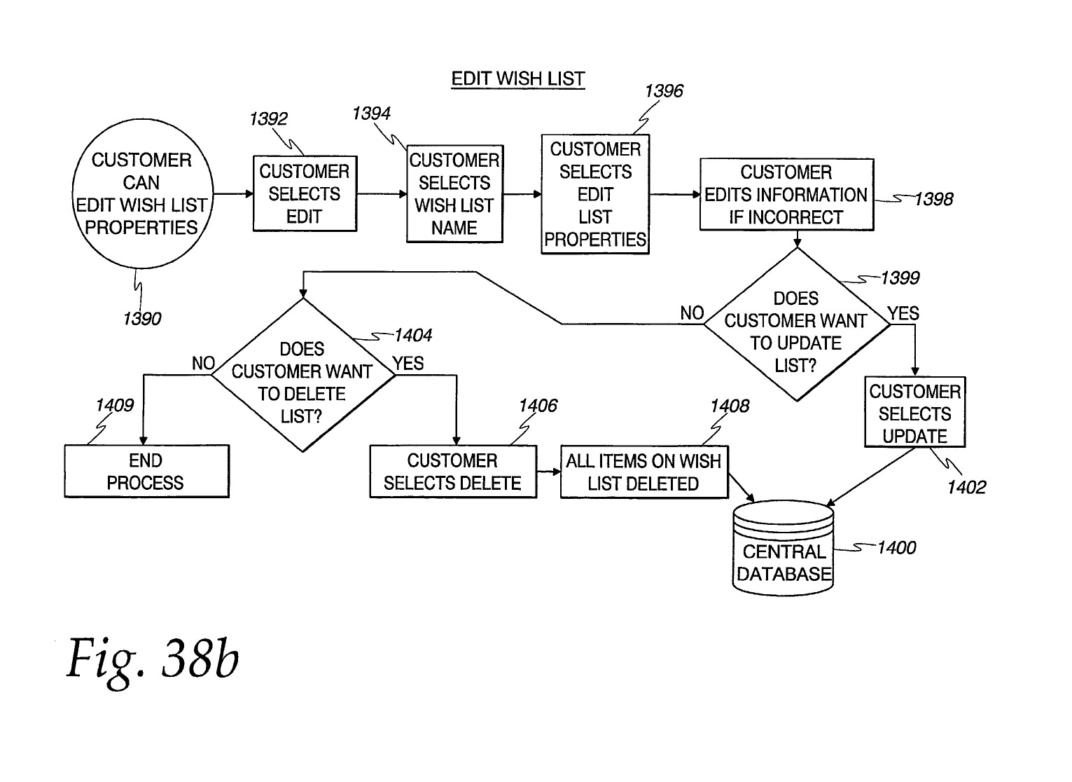

Referring to FIG. 38a, a user can create a new wish list (block 1370). To do so, the user logs into the system Web site and selects Create New List (block 1372). The user then enters a wish list name (block 1374) and selects an event category, for example, from a pull-down menu (block 1376). Event categories include occasions such as a Birthday, an Anniversary, Christmas, etc. The user can associate an event category with each wish list name. Next, the user enters an event date (block 1378).

The system allows the user to keep track of which wish list items have been purchased. However, the user may want to be surprised. Therefore, the user can specify whether purchased items will be indicated to the user by selecting the See Items Purchased option (block 1380).

Next, the user selects whether the wish list name will be Public or Private (block 1382). If the user selected Private (block 1384), then the user enters a password for the wish list name (block 1386). This password will be required by all buyers to gain access to the wish list in the future. In block 1388, the user selects the Create button to create the wish list and save it to the central database 1400.

Referring to FIG. 38b, a user can edit a wish list (block 1390). To do so, the user logs into the system Web site and selects Edit Wish List (block 1392). The user then selects a wish list name (block 1394) and selects Edit List properties (block 1396). Next, the user can edit items on the wish list, delete items, change quantities, etc. (block 1398). A user can edit the quantity associated with a selected item by typing the new quantity in the quantity field. To delete an item from a wish list, the user can reduce the quantity to zero. Alternatively, the user can use a pull-down menu to delete a selected item from a specific wish list. In either case, the deleted item is removed from the specified wish list. Once finished, if the user wants to update the wish list (block 1399), he/she selects Update (block 1402). Otherwise, if the user wants to delete the wish list (block 1404), he/she selects Delete (block 1406). The system then deletes all the items associated with that wish list (block 1408) and the central database 1400 is updated accordingly. If the user does not want to delete the wish list, the wish list editing process is finished (block 1409).

A user and/or buyer may view a wish list via one or more display options. In one embodiment, a wireless PDA or wireless telephone having Internet access can be used to view a wish list. Alternatively, a PC having Internet access can be used. The displayed wish list can be organized by wish list name (including all items associated with that wish list name, regardless of where the items can be purchased). In another embodiment, each wish list can be organized by specific retailers. For example, if the Christmas wish list is chosen, a user and/or buyer can view that wish list name by retailer, which displays all the wish list items that can be purchased from a specific retailer. The user and/or buyer can then select another wish list name or another retailer to view additional wish list items. In one embodiment, each wish list name includes tabs, including a View All tab (to view all wish list items) and tabs corresponding to retailers where specific wish list items can be purchased.

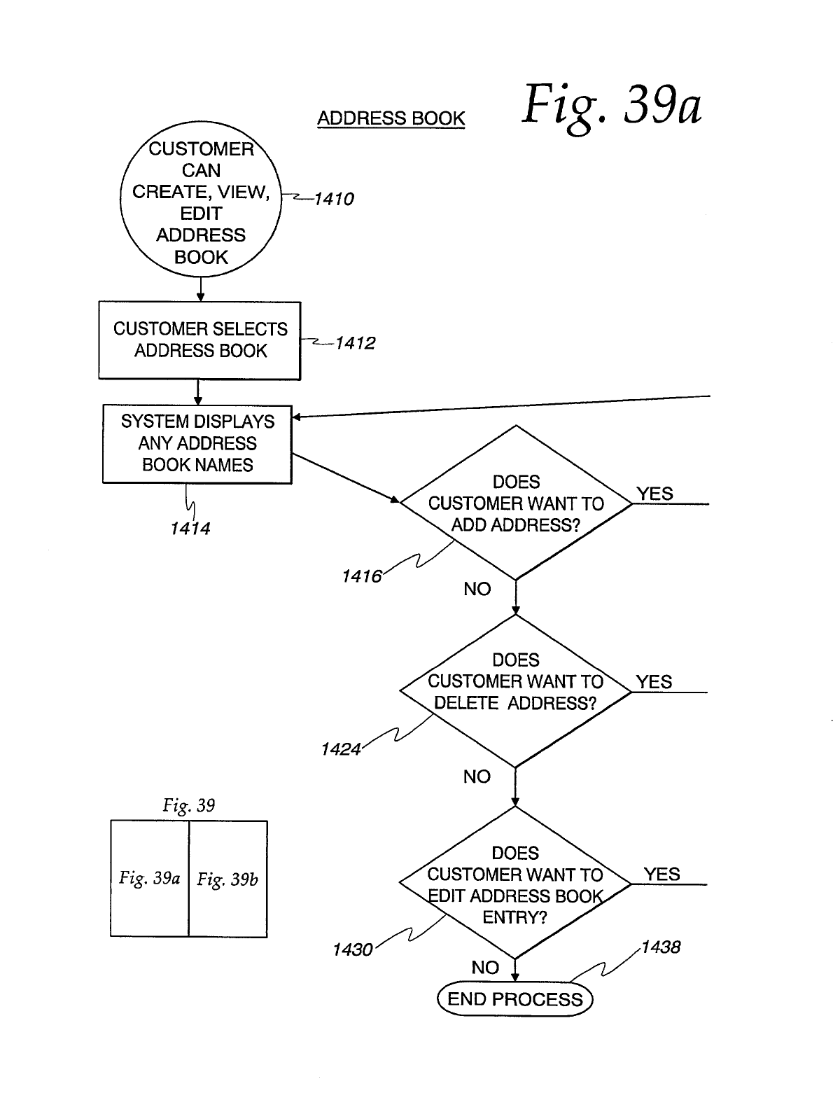

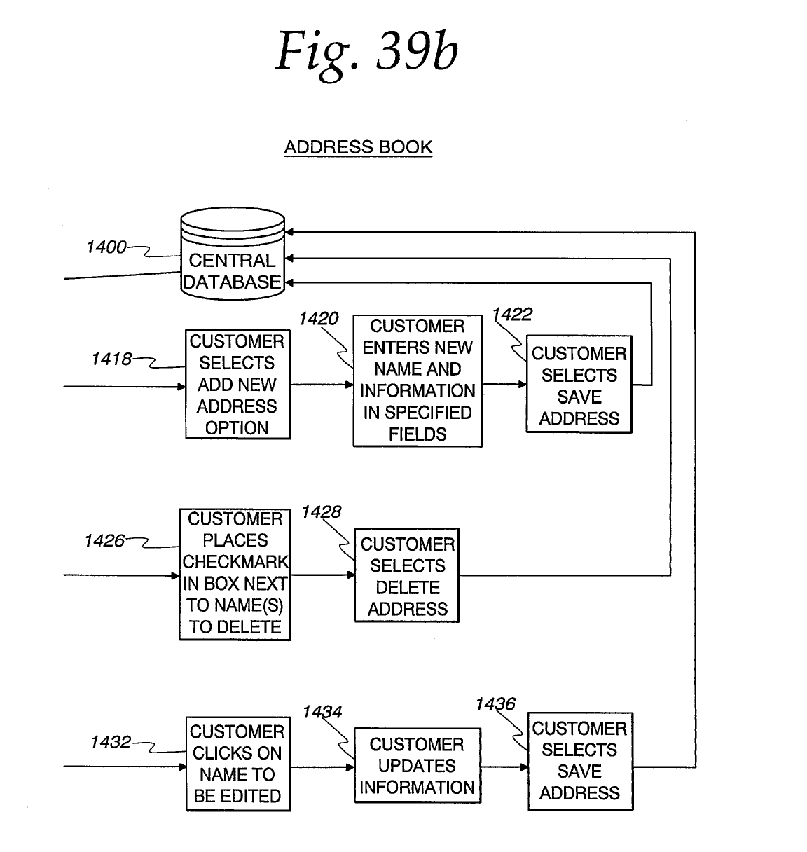

Referring to FIGS. 39a-b, a user can create, view or edit his/her address book (block 1410). The user first selects the Address Book option (block 1412). The system then displays a list of the names in the address book, if any (block 1414). If the user wants to add an entry (block 1416), the user selects the Add New Address option (block 1418). The user can then enter the new name, address and other information in the specified fields (block 1420). Next, the user selects Save Address (block 1422), which saves the new entry to the central database 1400.

If the user wants to delete an address (block 1424), the user selects the name to be deleted, for example, by clicking in a box next to the name (block 1426), which places a checkmark next to the name. The user then selects Delete Address (block 1428), which deletes the entry from the central database 1400.

If the user wants to edit an address book entry (block 1430), the user clicks on the name to be edited (block 1432). The user can then update the entry (block 1434). Next, the user selects Save Address (block 1436), which saves the revised entry to the central database 1400. If the user does not want to perform any of the options in blocks 1416, 1424 or 1430, the address book process is finished (block 1438).

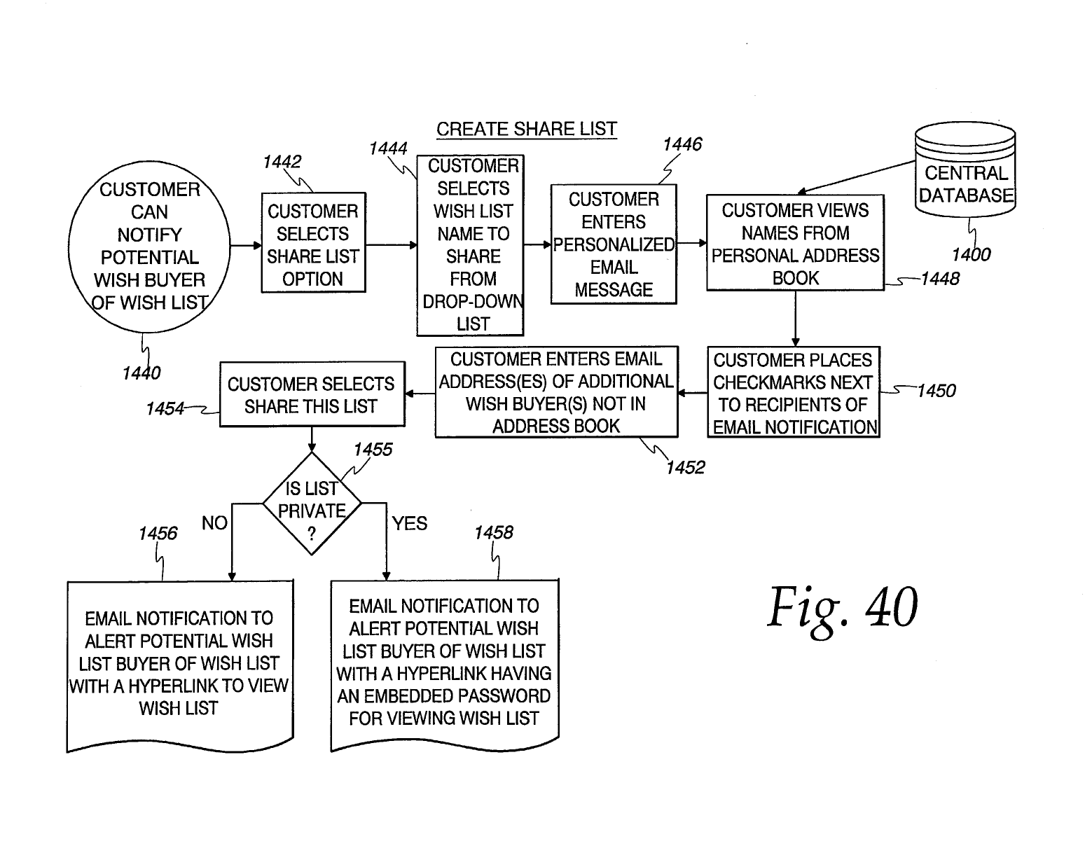

Referring to FIG. 40, a user can notify potential buyers of a wish list (block 1440). First, the user selects the Share List option (block 1442). The user then selects a particular wish list name, for example, from a pull-down menu (block 1444). The user can then type a personal e-mail message to the buyer (block 1446). Next, the user views the names in the personal address book (block 1448). The user selects who will receive the e-mail notification, for example, by placing checkmarks in boxes next to the corresponding names in the address book (block 1450). The user then has the option of entering e-mail addresses for buyers not listed in the address book (1452). Next, the user selects Share This List (block 1454). The system determines whether the user designated the wish list as Private in block 1455. If not, an e-mail notification is sent to the selected recipients alerting them of the wish list, for example, by displaying the user's message and providing a hyperlink to the wish list (block 1456). If the wish list is Private, an e-mail notification is sent to the selected recipients alerting them of the wish list, for example, by displaying the user's message and providing a hyperlink to the wish list that includes an embedded password for accessing the wish list (block 1458). In one embodiment, the e-mail also contains the password in written form for accessing the Private wish list in the future. When selected by the buyer, the hyperlink will navigate the buyer's Web browser directly to the system Web site.

In summary, users select an access mechanism, such as a Share List. However, any access mechanism that allows one or more buyers access to a wish list or unassigned list of products is within the scope of the claimed invention. The user can share one or more wish list names with designated persons listed in the user's address book, or entered manually. Public wish lists allow access to any interested buyer. If, however, the user designates a wish list as Private, then password protection is provided. Persons on a Share List are notified of a specific wish list name via an e-mail notification that includes a hyperlink to the wish list. If the wish list is Private, the password may be embedded in the hyperlink so the user is able to view the wish list without having to manually enter the password. Thus, the system will either link the buyer to a Public wish list, request a password for a Private wish list, or automatically link the buyer to a Private wish list using an embedding password. In one embodiment, wish lists can be designated Strictly Private, wherein only the creator-user can access such wish lists.

Buyers visiting the system Web site have the option of viewing all Public wish lists, viewing any Private wish lists for which they have a password (or hyperlink with embedded password), viewing a user's personal preferences, printing a wish list, or selecting a shopping cart summary (containing a list of the items in the buyer's shopping cart). If a buyer wishes to view a wish list at a store/mall or on-line, the buyer does not need to register. Rather, the buyer can search for registered users and/or specific wish list names. In addition, the buyer can access a user's personal preferences in order to select items that a user may want, but that are not included on a wish list. In one embodiment, the buyer can only access the personal preferences associated with a Public wish list. Otherwise, a password is required to access to the personal preferences associated with a Private wish list.

To search for a registered user (e.g., to view his/her wish list and/or personal preferences), the buyer logs into the system Web site, selects the Search option, and enters search criteria, such as a first and last name, in the appropriate search fields. The system will then display a list of user names, user locations (city, state), and wish list names that match the search criteria entered. The buyer can only access Public wish lists and Private wish lists for which the buyer has the required password. While viewing a wish list, the buyer can select Profile to view a user's personal preferences.

A buyer may view a wish list and then decide to go to a physical store or mall to purchase one of the wish list items. Each wish list includes, for example, the name of the wish list, the name of the retailer and/or specific store where each item can be purchased, the name of the products on the wish list(s), a description of each item, the number of items remaining that the user desires, the wish list creator's (user's) name, and/or a barcode and a barcode number for each product. The buyer can print out the wish list and purchase one or more items at a physical store, mall, or on-line.

In one embodiment, if a user or buyer chooses to order wish list items on-line, then the user or buyer must select a participating e-tailer. The system then links the user or buyer to the on-line retailer's Web site. In one embodiment, the system launches a second instance of the buyer's Web browser thus producing a second window displaying the Web site associated with the URL of the on-line retailer where the selected product(s) may be purchased. In one embodiment, the buyer is responsible for finding, selecting and purchasing the selected product(s) on the retailer's Web site. Generally, the selected items are added to an electronic shopping cart. The buyer is prompted to enter the quantity of each item to be purchased. After the buyer purchases the selected item(s), the buyer is responsible for closing the second instance of the Web browser and returning to the system's Web site (e.g., clixlist.com).

In another embodiment, if a user or buyer chooses to order wish list items online, then the user or buyer can select items using the system Web site (e.g., clixlist.com). Once the items are selected for purchase, an order processor sends the order information to an on-line retailer, a physical retailer, or a fulfillment warehouse. The order information may be sent to the appropriate retailer or warehouse via, for example, e-mail. The order is fulfilled by sending the item to the buyer, or making the item available for pick-up.

In one embodiment, the system will automatically decrement and/or delete purchased items from the user's wish list and update the central database 1400. In another embodiment, the buyer, a kiosk agent, or store clerk would update a wish list to indicate that one or more items has been purchased off of a specific wish list. The system Web site can be used for this purpose. Generally, a wish list must be updated manually if the buyer purchased an item at a physical store.

In one embodiment, the number of items outstanding on a wish list is visible to the user and the buyer at the system Web site. This quantity is only displayed if the list owner chose the See Items Purchased option when creating or editing the wish list.

To checkout on-line, the user clicks the Cart Summary option, which initiates the checkout process. The buyer is then prompted to select the “Delivery Address” of the recipient from a pull-down list (containing addresses from the user's address book) or to select “Add New Address” if the recipient is not listed. The buyer then enters payment information (e.g., a credit card number). In one embodiment, the system does not retain credit card information; thus, the buyer is prompted to enter credit card information during each checkout process. The system does check the format of the entered credit card information to ensure the proper number of digits and card type. If the credit card information is in the proper format, the system forwards the information to an on-line retailer, a physical retailer, or a fulfillment warehouse for credit authorization (i.e., to determine whether the buyer is authorized to charge the total purchase price). Once the checkout process is complete, the system transfers the order information to an order processor, or sends the order information directly to the proper retailer. In one embodiment, the order information is transferred from the central database 1400 to the retailer or order processor via e-mail, a data exchange (using a dedicated line or the Internet), or a wireless connection. Alternatively, the order information is transferred from the central database 1400 to a database associated with the on-line retailer, a physical retailer, or a fulfillment warehouse. In another embodiment, the retailer has a computer terminal for manually accessing the system Web site to display the order information.

If purchasing on-line, the buyer must select a fulfillment option (e.g., delivery or pick-up). If buyer selects pick-up, the buyer is then prompted to enter his/her zip code. The system then displays, for example, up to five store locations near the entered zip code. The buyer then receives an order number and a confirmation of the total purchase price (including any applicable taxes and shipping charges).

If the buyer selects a certain store location for pick-up, then the order is forwarded to the selected store location. If the buyer selects the delivery option, the order is forwarded to a fulfillment warehouse. The store or warehouse clerk then checks the inventory level and sends an e-mail back to the buyer regarding the availability of the item(s) selected. Alternatively, the status of the item(s) may be retrieved from the central database 1400 or from an order processor that keeps track of the inventory levels for each of the retail items available through the system.

In one embodiment, the system provides order tracking information so the status of an order can be checked subsequent to purchase. Buyers have the option of registering with the system at the time a purchase is made. For registered buyers, login information, such as name, address, and/or credit card information, and order tracking information is maintained by the system.

To register as a buyer, the buyer must enter, for example, the buyer's full name, street address, city and state, e-mail address, and/or telephone number. The system then determines whether the user entered the requested information. If not, the system will prompt the buyer for any missing information. The login information is then stored in the central database 1400.

Therefore, an interactive system and method for shopping has been disclosed, wherein a user can scan items for a wish list at participating stores before or after creating an account with the system. The system separates the shopping process from the buying process. The system allows users to easily shop, generate a wish list, edit the wish list, and assemble an address book of buyers. The system also allows buyers to easily shop for others by searching for a user's wish list and personal preferences at the system Web site. In addition, the system allows multiple member identification numbers to be associated with a single user.

While particular embodiments of the invention have been shown and described in detail, it will be obvious to those skilled in the art that changes and modifications of the present invention, in its various embodiments, may be made without departing from the spirit and scope of the invention. Other elements, steps, methods and techniques that are insubstantially different from those described herein are also within the scope of the invention. Thus, the scope of the invention should not be limited by the particular embodiments described herein but should be defined by the appended claims and equivalents thereof.

What is claimed is:

1. A method of shopping, comprising:
providing a wireless data network comprising transmitting and receiving components and a database, said database having data pertaining to goods offered for sale at a plurality of physical stores;
providing at least one handheld data unit programmed to scan items at the physical stores and capable of wirelessly communicating with the data network;
scanning one or more items at one or more physical stores using a handheld data unit;
receiving from a handheld data unit item information from scanned items;
generating a wish list using the transmitted information;
transmitting the wish list to a handheld data unit;
selecting one or more items for purchase from the wish list using a handheld data unit; and
receiving a purchase request from a handheld data unit for at least one item from the wish list, the request including delivery and payment method particulars.

2. The method of claim 1, wherein the scanning step and the selecting step are performed by different handheld data units.

3. The method of claim 1, wherein the at least one handheld data unit is one or more devices selected from the group consisting of a barcode scanner, a personal digital assistant (PDA), and a wireless telephone.

4. A method of shopping, comprising:
providing at least one handheld electronic data unit;
visiting a physical retail location having a dedicated wireless electronic shopping network;
scanning items at the physical retail location with the handheld electronic data unit;
transmitting information corresponding to the scanned items wirelessly from the handheld electronic data unit to the dedicated wireless electronic shopping network;
generating a wish list of goods to be purchased;
receiving the wish list with a handheld electronic data unit;
selecting an item for purchase from the wish list; and
transmitting a purchase request from a handheld electronic data unit to the dedicated wireless electronic shopping network.

5. The method of claim 4 wherein scanned items include items sold by more than one physical retail entity.

6. The method of claim 4, wherein said scanning step and said selecting step are performed by different handheld electronic data units.

7. The method of claim 4, wherein the at least one handheld electronic data unit is one or more devices selected from the group consisting of a barcode scanner, a personal digital assistant (PDA), and a wireless telephone.

8. A method of shopping comprising:
providing a wireless database;
providing a first handheld data unit including an internal memory and capable of wireless communication with the database;
storing item information corresponding to items scanned in a physical retailer in the internal memory of the a first handheld data unit;
wirelessly uploading the item information from the internal memory of the first handheld data unit to the database;
creating a wish list comprising specific products identified using the item information collected using the first handheld data unit;
storing the wish list on the database;
providing a second handheld data unit;
transmitting the wish list to the second handheld data unit;
selecting an item for purchase from said wish list using the second handheld data unit;
transmitting information corresponding to item selected for purchase to the wireless database; and
transmitting information corresponding to item selected for purchase to a physical retailer for purchase.

9. The method of claim 8, further including allowing a buyer to search for and view the wish list via a Web site operably connected to the wireless database.

10. The method of claim 9, further including restricting access to the wish list to purchasers who enter a password.

11. The method of claim 8, further including using SKU data to identify the physical retailer where an item was scanned.

12. The method of claim 8, further including restricting access to the wish list to purchasers who enter a password.

13. A computer system for interactive shopping comprising:
a processor;
a database coupled to the processor; and
at least one handheld data unit including an internal memory and capable of wirelessly communicating with the database;
the handheld data unit being programmed to: scan physical items; store item information corresponding to the scanned items in the internal memory; wirelessly upload the item information from the internal memory of the handheld data unit to the database; and
the processor being programmed to: create an unassigned list of items corresponding to the item information uploaded to the database; generate one or more wish lists, each wish list including one or more of the items from the unassigned list;
wherein the handheld data unit is further programmed to: wirelessly download the wish lists generated by the processor; allow a buyer to browse the wish lists and select one or more items for purchase; and transmit information on items selected for purchase to physical retailers to complete the transaction.

14. The system of claim 13, wherein the processor is further programmed to create an access mechanism that notifies selected buyers of the existence of the wish list.

15. The system of claim 13, wherein the processor is further programmed to publish the generated wish lists to a Web site allowing a buyer to search for and view the wish lists.

16. The system of claim 13, wherein the processor is further programmed to notify selected buyers of the existence of the wish list by sending an e-mail to the selected buyers.

17. The system of claim 13, wherein the handheld data unit is selected from the group consisting of a barcode scanner, a personal digital assistant (PDA), and a wireless telephone.

18. The system of claim 13, wherein the handheld data unit is further programmed to scan a barcode associated with an item in a catalog.

19. The system of claim 13, wherein the handheld data unit is further programmed to scan a barcode associated with an item in a magazine.
